(19) United States
(12) Patent Application Publication
(10) Pub. No.: US 2007/0201710 A1
(43) Pub. Date: Aug. 30, 2007

(54) CONDENSER MICROPHONE

(75) Inventors: Yukitoshi Suzuki, Hamamatsu-Shi (JP); Toshihisa Suzuki, Hamamatsu-shi (JP)

Correspondence Address: DICKSTEIN SHAPIRO LLP, 1177 AVENUE OF THE AMERICAS (6TH AVENUE), NEW YORK, NY, 10036-2714, US

(73) Assignee: YAMAHA CORPORATION, Hamamatsu-Shi (JP)

(21) Appl. No.: 11/677,647

(22) Filed: Feb. 22, 2007

(30) Foreign Application Priority Data
Feb. 24, 2006 (JP) P2006-048252
Mar. 10, 2006 (JP) P2006-065263
Mar. 10, 2006 (JP) P2006-065402
Mar. 29, 2006 (JP) P2006-089679
Mar. 31, 2006 (JP) P2006-097305

(51) Int. Cl. H04R 25/00

(52) U.S. Cl. 381/174

(57) ABSTRACT

A condenser microphone includes a support, a plate having a fixed electrode bridged across the supports, a diaphragm, which has a moving electrode at a center portion thereof and which vibrates due to sound waves applied thereto, and a spacer, in which a first end is fixed to the plate, and a second end is fixed to the near-end portion of the diaphragm so as to surround the center portion of the diaphragm, wherein an air gap is formed between the plate and the diaphragm. This reduces the tensile stress of the diaphragm so as to increase the amplitude of vibration of the diaphragm. Hence, it is possible to increase the sensitivity of the condenser microphone. A structure constituted of the plate, the diaphragm, and the spacer is bridged across the support by means of the bridges, which absorb the residual stress of the diaphragm due to the deformation thereof.

### TECHNICAL FIELD

The present invention relates to condenser microphones (or capacitor microphones) having diaphragms and plates, which are manufactured using semiconductor films and which are adapted to MEMS (Micro Electro Mechanical System).

This application claims priority on Japanese Patent Application No. 2006-48252 (filed Feb. 24, 2006), Japanese Patent Application No. 2006-65402 (filed Mar. 10, 2006), Japanese Patent Application No. 2006-65263 (filed Mar. 10, 2006), Japanese Patent Application No. 2006-97305 (filed Mar. 31, 2006), and Japanese Patent Application No. 2006-89679 (filed Mar. 29, 2006), the contents of which are incorporated herein by reference.

### BACKGROUND ART

Conventionally, various types of condenser microphones (or capacitor microphones), which can be manufactured in accordance with manufacturing processes of semiconductor devices, are known, wherein they are constituted using plates and diaphragms both having electrodes such that plates and diaphragms, which vibrate due to sound waves applied thereto, are slightly distanced from each other and are supported by way of supports. Condenser microphones convert variations of capacities (or variations of capacitances) due to displacements of diaphragms into electric signals. In order to improve the sensitivity of condenser microphones, it is necessary to appropriately control residual stresses of diaphragms. By reducing residual stresses of diaphragms, it is possible to increase amplitudes of diaphragms, which vibrate due to sound waves applied thereto, thus improving the sensitivity of condenser microphones.

When diaphragms are formed by way of LPCVD (Low Pressure Chemical Vapor Deposition), for example, residual stresses are controlled by appropriately setting annealing conditions after deposition. In general, the precision for controlling residual stresses of diaphragms based on conditions for the formation of films of diaphragms is not high. Hence, there is still a problem in that relatively large residual stresses remain in the diaphragms. In the case of a condenser microphone, which is taught in the paper “MS S-01-34” entitled “Mechanical Properties of Capacitive Silicon Microphone” and published by the Institute of Electrical Engineers in Japan on Nov. 21, 2001, when tensile stress remains in a diaphragm, the amplitude of the diaphragm decreases so as to reduce the sensitivity of the condenser microphone.

The sensitivity of the condenser microphone can be improved by increasing the ratio of the displacement of the diaphragm to the distance between the electrodes by decreasing parasitic capacitance.

The aforementioned paper teaches a condenser microphone having a plate, a diaphragm, and a spacer, in which both of the plate and diaphragm are composed of thin films having conductivity. Due to the uniformly distributed rigidity of the diaphragm, when sound waves are transmitted to the diaphragm, the displacement of the diaphragm due to vibration becomes smaller in a direction from the center portion thereof to the periphery fixed to the spacer. This may cause a reduction of the sensitivity of the condenser microphone. When the ratio of the maximum displacement of the diaphragm to the distance between the plate and diaphragm is increased in order to increase the sensitivity of the condenser microphone, a pull-in phenomenon may occur such that the diaphragm is absorbed by the plate due to electrostatic absorption, which occurs when the diaphragm is moved close to the plate.

In the above, it is possible to increase the dynamic range of the condenser microphone by increasing the distance between the diaphragm and plate and thereby increasing bias voltage. The distance between the diaphragm and plate depends on the thickness of a film lying therebetween. When the thickness of the film lying between the diaphragm and plate is increased, cracks and film separation may likely occur. Hence, the aforementioned paper teaches a solution in which the distance between the diaphragm and plate is increased by combining two wafers. However, combining two wafers results in complicated manufacturing process and thus increases the manufacturing cost. In addition, the condenser microphone disclosed in the aforementioned paper suffers from high tensile stress remaining in the diaphragm. This reduces the amplitude of vibration of the diaphragm due to sound pressure applied thereto and thus reduces the sensitivity of the condenser microphone.

Japanese Patent No. 2530305 teaches an example of an integrated electroacoustic transducer, i.e., a condenser microphone whose diaphragm is formed using a monocrystal epitaxial layer, by which the residual stress of the diaphragm decreases so as to increase the sensitivity. However, in the manufacturing of a condenser microphone using the conventionally-known semiconductor device manufacturing process, a silicon film forming a diaphragm is formed on a silicon oxide film. After the formation of the diaphragm, the silicon oxide film is partially removed so as to form a back cavity and an air gap between electrodes. That is, it is very difficult to realize the epitaxial growth of silicon on the silicon oxide film. This makes it very difficult to actually produce the aforementioned condenser microphone.

Japanese Patent Application Publication No. 2004-506394 (corresponding to International Publication No. WO2002/015636) teaches a miniature broadband transducer, i.e., a condenser microphone in which a back plate having a plurality of holes is arranged in parallel with a diaphragm with a prescribed distance therebetween and is supported by a substrate. The sensitivity of the condenser microphone is improved by maintaining the prescribed distance between the diaphragm and the back plate. However, this condenser microphone suffers from a problem, in which residual stress is varied in the thickness direction of the diaphragm (whose film configuration is formed at a high temperature) so that the diaphragm is deformed or curled unexpectedly after the diaphragm is isolated from other parts during the manufacturing process. This causes variations of the distance between the diaphragm and the back plate. That is, unwanted deformation or curl occurs in the diaphragm and is unexpectedly varied due to errors of the manufacturing process, whereby the sensitivity of the condenser microphone is unexpectedly varied due to the manufacturing process.

### DISCLOSURE OF INVENTION

It is an object of the present invention to provide a condenser microphone that realizes a high sensitivity by reducing tensile stress of a diaphragm.

It is another object of the present invention to provide a condenser microphone, which can be produced by way of a simple manufacturing process and in which dynamic range and sensitivity are improved.

It is a further object of the present invention to provide a condenser microphone in which a prescribed distance is maintained during the manufacturing process so as to stabilize the sensitivity thereof.

In a first aspect of the present invention, a condenser microphone includes a plurality of supports, a plate having a fixed electrode, which is bridged across the supports, a diaphragm, which has a moving electrode at a center portion thereof and which vibrates due to sound waves applied thereto, and a spacer, in which a first end is fixed to the plate, and a second end is fixed to a near-end portion of the diaphragm so as to surround the center portion of the diaphragm, thus forming an air gap between the plate and the diaphragm. Due to the tensile stress remaining in the diaphragm, the second end of the spacer is moved close to the center portion of the diaphragm in comparison with the first end of the spacer. This reduces the tensile stress of the diaphragm. Hence, it is possible to increase the amplitude of vibration of the diaphragm due to sound waves. Thus, it is possible to increase the sensitivity of the condenser microphone. Herein, a single spacer can be arranged and formed in a ring shape or a C-shape so as to surround the center portion of the diaphragm. Alternatively, a plurality of spacers can be arranged along the periphery of the center portion of the diaphragm in a circumferential direction of the diaphragm with the equal spacing therebetween.

Alternatively, a condenser microphone includes a plurality of supports, a plate having a fixed electrode supported by the supports, a diaphragm, which has a moving electrode at a center portion and which vibrates due to sound waves applied thereto, a plurality of bridges including beam portions extended inwardly from the supports and interconnecting portions, wherein the first ends of the interconnecting portions are fixed to the beam portions, and the second ends of the interconnecting portions are fixed to the near-end portion of the diaphragm so as to surround the center portion of the diaphragm, and wherein the diaphragm is bridged under tension across the supports in such a way that an air gap is formed between the diaphragm and the plate. Due to the tensile stress remaining in the diaphragm, the second ends of the interconnecting portions included in the bridges are moved close to the center portion of the diaphragm in comparison with the first ends of the interconnecting portions. This reduces the tensile stress of the diaphragm. Hence, it is possible to increase the amplitude of vibration of the diaphragm. Thus, it is possible to increase the sensitivity of the condenser microphone.

In a second aspect of the present invention, a condenser microphone includes a plate having a fixed electrode, a diaphragm having a moving electrode, which vibrates due to sound waves applied thereto, a spacer in which a first end thereof is fixed to the plate, and a second end thereof is fixed to a near-end portion of the diaphragm so as to form an air gap between the plate and the diaphragm, a plurality of supports that are positioned in the periphery of the plate and in the periphery of the diaphragm, and a plurality of bridges, each of which is extended from a prescribed end of the plate or a prescribed end of the diaphragm toward the support and by which a structure constituted of the plate, diaphragm, and spacer is bridged across the supports so as to absorb residual stress of the diaphragm by way of the deformation thereof. By reducing the residual stress of the diaphragm, it is possible for the diaphragm to vibrate with relatively large amplitude due to sound waves. Hence, it is possible to increase the sensitivity of the condenser microphone.

In the above, it is preferable that both of the plate and the diaphragm are formed using the same material. This makes it possible to easily control the residual stress of the plate and the residual stress of the diaphragm, whereby it is possible to realize a relatively large deformation of the aforementioned structure. Hence, it is possible to effectively reduce the residual stress of the diaphragm.

Specifically, the condenser microphone includes a first plate, a diaphragm having a moving electrode, which vibrates due to sound waves applied thereto, a spacer in which a first end thereof is fixed to the first plate, and a second end thereof is fixed to a near-end portion of the diaphragm so as to form an air gap between the first plate and the diaphragm, a plurality of supports, which are formed in the periphery of the plate and in the periphery of the diaphragm, a plurality of bridges, each of which is extended from a prescribed end of the plate or a prescribed end of the diaphragm toward the support and by which a structure constituted of the first plate, diaphragm, and spacer is bridged across the supports so as to absorb the residual stress of the diaphragm by way of the deformation thereof, and a second plate having a fixed electrode, which is positioned opposite to the first plate with respect to the diaphragm and which is supported by the supports. Herein, the bridges absorb the residual stress of the diaphragm so as to reduce the residual stress of the diaphragm, whereby it is possible to realize a relatively large amplitude of vibration of the diaphragm and to thus increase the sensitivity of the condenser microphone.

Alternatively, the condenser microphone includes a plurality of supports, a plate having a fixed electrode, which is supported by the supports, a diaphragm having a moving electrode, which vibrates due to sound waves applied thereto, and a spacer in which a first end thereof is fixed to the plate, and a second end thereof is fixed to the near-end portion of the diaphragm so as to form an air gap between the plate and the diaphragm, wherein the spacer absorbs residual stress of the diaphragm by way of the shearing deformation thereof.

In a third aspect of the present invention, a condenser microphone includes a plate having a fixed electrode and a plurality of holes, a plurality of supports, which are positioned in the periphery of the plate so as to support the plate, and a diaphragm having a center portion having a moving electrode, an intermediate portion, which is formed externally of the center portion and whose rigidity is higher than the rigidity of the center portion, and a near-end portion, which is elongated from the intermediate portion to the supports and whose rigidity is lower than the rigidity of the intermediate portion, wherein the diaphragm is bridged across the supports so as to form an air gap with the plate, so that the diaphragm vibrates due to sound waves applied thereto. Since the rigidity of the near-end portion of the diaphragm is lower than the rigidity of the intermediate portion and the rigidity of the center portion, the diaphragm is capable of vibrating due to sound waves while the near-end portion thereof is being deformed. Since the rigidity of the intermediate portion of the diaphragm is higher than the rigidity of the near-end portion, it is possible to prevent the center portion of the diaphragm from being deformed irrespective of the deformation of the near-end portion. That is, it is possible to guarantee that the center portion of the diaphragm can vibrate with maximum displacement without being deformed by way of the deformation of the near-end portion. This increases the variable capacity formed between the plate and the diaphragm. Hence, it is possible to increase the sensitivity of the diaphragm.

In the above, the thickness of the intermediate portion of the diaphragm is larger than the thickness of the center portion and the thickness of the near-end portion. This increases the rigidity of the intermediate portion of the diaphragm. In addition, the near-end portion of the diaphragm is partially bent and expanded from the intermediate portion to the supports, so that the near-end portion is reduced in rigidity. Compared with the “planar” diaphragm, this diaphragm is reduced in rigidity. Hence, the near-end portion is greatly deformed due to sound waves so that the center portion can vibrate with relatively large displacement. This increases the variable capacity so as to increase the sensitivity of the condenser microphone.

In a fourth aspect of the present invention, a condenser microphone includes a plurality of supports, a plate having a fixed electrode whose periphery is fixed to the supports, a diaphragm having a moving electrode, which is positioned opposite to the fixed electrode, a spacer, which is formed between the diaphragm and the plate, which is distanced from the supports, and which joins the diaphragm, and a plurality of bridges, in which the tip ends thereof joinl the spacer, and the base portions thereof are fixed with the prescribed positioning with the supports and are positioned close to the center of the diaphragm, wherein the bridges are deflected due to the tensile stress of the diaphragm in such a way that the tip ends thereof are moved apart from the plate. Herein, the tensile stress of the diaphragm is exerted to the spacer in such a way that the bridges rotate about the base portions thereof, whereby the tip ends of the bridges are moved apart from the plate and are thus moved toward the center of the diaphragm, thus releasing the tensile stress of the diaphragm. When the tip ends of the bridges are deflected to be apart from the plate, the distance between the plate and diaphragm is increased to be larger than the thickness of the spacer. That is, the distance between the plate and diaphragm becomes larger than the thickness of the layer lying between the plate and the diaphragm. This increases the dynamic range and sensitivity of the condenser microphone without complicating the manufacturing process.

In the above, both of the plate and the bridges are formed using the same thin film having a plurality of cutouts, which in turn form the outlines of the bridges. In addition, the bridges are formed using a first film joining the spacer and a second film joining the spacer opposite to the first film, wherein the tip ends of the bridges are deflected to be apart from the plate due to the tensile stress of the diaphragm, the tensile stress of the first film, and the compressive stress of the second film. That is, the bridges each have a two-layered structure, by which the tip ends thereof tend to be deflected apart from the plate due to the tensile stress and compressive stress. Hence, it is possible to further increase the distance between the plate and the diaphragm.

In a fifth aspect of the present invention, a condenser microphone includes a ring-shaped support, a diaphragm positioned inside of a hole of the ring-shaped support, a back plate that is supported by the ring-shaped support and is positioned in parallel with the diaphragm, a plurality of bridges that are supported by the ring-shaped support in a cantilever manner, a plurality of pillar portions that are inserted between the diaphragm and the back plate and are positioned in proximity to the ring-shaped support, in which, when the bridges are deformed due to tensile stress of the diaphragm, the pillar portions are inclined and moved so as to reduce the tensile stress of the diaphragm, and a stopper for regulating the distance between the diaphragm and the back plate.

In the above, the stopper has a projecting shape arranged between the diaphragm and the back plate. In addition, the hole of the ring-shaped support has a circular shape in plan view so that the bridges and the pillar portions are arranged in a circumferential direction about an axial line of the hole of the ring-shaped support with the prescribed distances therebetween, wherein the stopper is arranged inwardly of the bridges in a radial direction, or wherein a plurality of supports are arranged in the circumferential direction and are positioned between the bridges. Furthermore, the ring-shaped support has a projection projecting inwardly of the hole; the diaphragm has an outer periphery, which is extended externally of the pillar portions and which is deformed and moved toward the projection when the pillar portions are inclined and moved due to the tensile stress of the diaphragm; the outer periphery of the diaphragm comes in contact with the projection so as to serve as the stopper for regulating the distance between the diaphragm and the back plate. Alternatively, the outer periphery of the diaphragm has a plurality of contact portions, wherein when the pillar portions are inclined and moved due to the tensile stress of the diaphragm, the outer periphery of the diaphragm is deformed toward the projection so that the contact portions come in contact with the projection so as to serve as the stopper for regulating the distance between the diaphragm and the back plate. Moreover, the bridges have cutouts partially surrounding the pillar portions in plan view.

### BRIEF DESCRIPTION OF THE DRAWINGS

FIG. 1 is a cross-sectional view showing a sensing portion of a condenser microphone in accordance with a first embodiment of the present invention;

FIG. 2A is a plan view showing a plate of the condenser microphone;

FIG. 2B is a cross-sectional view showing a detecting portion of the condenser microphone;

FIG. 2C is a plan view showing a diaphragm of the condenser microphone;

FIG. 3A is an enlarged view showing a spacer and its associated parts included in the condenser microphone, which is observed just after the completion of manufacturing;

FIG. 3B is an enlarged view showing the spacer and its associated parts included in the condenser microphone, which is observed a prescribed time later after the completion of the manufacturing;

FIG. 4A is a cross-sectional view taken along line A4-A4 in FIG. 5A, which is used for explaining a first step of a manufacturing method of the condenser microphone;

FIG. 4B is a cross-sectional view used for explaining a second step of the manufacturing method of the condenser microphone;

FIG. 4C is a cross-sectional view used for explaining a third step of the manufacturing method of the condenser microphone;

FIG. 4D is a cross-sectional view used for explaining a fourth step of the manufacturing method of the condenser microphone;

FIG. 4E is a cross-sectional view used for explaining a fifth step of the manufacturing method of the condenser microphone;

FIG. 4F is a cross-sectional view used for explaining a sixth step of the manufacturing method of the condenser microphone;

FIG. 5A is a plan view used for explaining the first step of the manufacturing method of the condenser microphone;

FIG. 5B is a plan view used for explaining the second step of the manufacturing method of the condenser microphone;

FIG. 5C is a plan view used for explaining the third step of the manufacturing method of the condenser microphone;

FIG. 5D is a plan view used for explaining the fourth step of the manufacturing method of the condenser microphone;

FIG. 5E is a plan view used for explaining the fifth step of the manufacturing method of the condenser microphone;

FIG. 5F is a plan view used for explaining the sixth step of the manufacturing method of the condenser microphone;

FIG. 6 is a plan view showing a condenser microphone in accordance with a first variation of the first embodiment of the present invention;

FIG. 7A is a cross-sectional view taken along line A7-A7 in FIG. 6;

FIG. 7B is a cross-sectional view taken along line B7-B7 in FIG. 6;

FIG. 8 is a cross-sectional view showing the condenser microphone of the first variation of the first embodiment, which is observed at a prescribed time after the completion of the manufacturing;

FIG. 9A is a plan view showing a further modification of the condenser microphone of the first variation of the first embodiment;

FIG. 9B is a cross-sectional view taken along line B9-B9 in FIG. 9A;

FIG. 10A is a plan view showing a further modification of the condenser microphone of the first variation of the first embodiment;

FIG. 10B is a cross-sectional view taken along line B10-B10 in FIG. 10A;

FIG. 11A is a cross-sectional view taken along line A11-A11 in FIG. 12A, which is used for explaining a first step of a manufacturing method of the condenser microphone;

FIG. 11B is a cross-sectional view used for explaining a second step of the manufacturing method of the condenser microphone;

FIG. 11C is a cross-sectional view used for explaining a third step of the manufacturing method of the condenser microphone;

FIG. 11D is a cross-sectional view used for explaining a fourth step of the manufacturing method of the condenser microphone;

FIG. 11E is a cross-sectional view used for explaining a fifth step of the manufacturing method of the condenser microphone;

FIG. 11F is a cross-sectional view used for explaining a sixth step of the manufacturing method of the condenser microphone;

FIG. 11G is a cross-sectional view used for explaining a seventh step of the manufacturing method of the condenser microphone;

FIG. 12A is a plan view used for explaining the first step of the manufacturing method of the condenser microphone;

FIG. 12B is a plan view used for explaining the second step of the manufacturing method of the condenser microphone;

FIG. 12C is a plan view used for explaining the third step of the manufacturing method of the condenser microphone;

FIG. 12D is a plan view used for explaining the fourth step of the manufacturing method of the condenser microphone;

FIG. 12E is a plan view used for explaining the fifth step of the manufacturing method of the condenser microphone;

FIG. 12F is a plan view used for explaining the sixth step of the manufacturing method of the condenser microphone;

FIG. 12G is a plan view used for explaining the seventh step of the manufacturing method of the condenser microphone;

FIG. 13 is a plan view showing a condenser microphone in accordance with a second variation of the first embodiment of the present invention;

FIG. 14A is a cross-sectional view taken along line A15-A15 in FIG. 13;

FIG. 14B is a cross-sectional view taken along line B15-B15 in FIG. 13;

FIG. 15A is a cross-sectional view taken along line A16-A16 in FIG. 17A, which is used for explaining a first step of a manufacturing method of the condenser microphone;

FIG. 15B is a cross-sectional view used for explaining a second step of the manufacturing method of the condenser microphone;

FIG. 15C is a cross-sectional view used for explaining a third step of the manufacturing method of the condenser microphone;

FIG. 15D is a cross-sectional view used for explaining a fourth step of the manufacturing method of the condenser microphone;

FIG. 16A is a cross-sectional view taken along line B16-B16 in FIG. 17A, which is used for explaining the first step of the manufacturing method of the condenser microphone;

FIG. 16B is a cross-sectional view used for explaining the second step of the manufacturing method of the condenser microphone;

FIG. 16C is a cross-sectional view used for explaining the third step of the manufacturing method of the condenser microphone;

FIG. 16D is a cross-sectional view used for explaining the fourth step of the manufacturing method of the condenser microphone;

FIG. 17A is a plan view used for explaining the first step of the manufacturing method of the condenser microphone;

FIG. 17B is a plan view used for explaining the second step of the manufacturing method of the condenser microphone;

FIG. 17C is a plan view used for explaining the third step of the manufacturing method of the condenser microphone;

FIG. 17D is a plan view used for explaining the fourth step of the manufacturing method of the condenser microphone;

FIG. 18A is a plan view showing a condenser microphone in accordance with a second embodiment of the present invention;

FIG. 18B is a cross-sectional view of the condenser microphone including a diaphragm, a spacer, and a back plate, brides, and supports;

FIG. 19 is a plan view showing a variation of the condenser microphone, which includes a plurality of spacers;

FIG. 20A is an fragmentary enlarged view showing that the bridges are expanded so as to absorb the tensile stress of the diaphragm;

FIG. 20B is a fragmentary enlarged view showing that the bridges are contracted so as to absorb the compressive stress of the diaphragm;

FIG. 21 is a plan view showing a variation of the condenser microphone, in which a plurality of holes are formed so as to form the bridges whose rigidity is lower than the rigidity of the diaphragm;

FIG. 22A is a cross-sectional view taken along line A5-A5 in FIG. 23A, which is used for explaining a first step of a manufacturing method of the condenser microphone;

FIG. 22B is a cross-sectional view used for explaining a second step of the manufacturing method of the condenser microphone;

FIG. 22C is a cross-sectional view used for explaining a third step of the manufacturing method of the condenser microphone;

FIG. 22D is a cross-sectional view used for explaining a fourth step of the manufacturing method of the condenser microphone;

FIG. 22E is a cross-sectional view used for explaining a fifth step of the manufacturing method of the condenser microphone;

FIG. 22F is a cross-sectional view used for explaining a sixth step of the manufacturing method of the condenser microphone;

FIG. 23A is a plan view used for explaining the first step of the manufacturing method of the condenser microphone;

FIG. 23B is a plan view used for explaining the second step of the manufacturing method of the condenser microphone;

FIG. 23C is a plan view used for explaining the third step of the manufacturing method of the condenser microphone;

FIG. 23D is a plan view used for explaining the fourth step of the manufacturing method of the condenser microphone;

FIG. 23E is a plan view used for explaining the fifth step of the manufacturing method of the condenser microphone;

FIG. 23F is a plan view used for explaining the sixth step of the manufacturing method of the condenser microphone;

FIG. 24A is an enlarged cross-section view showing a bridge having a bent portion, which is included in a condenser microphone according to a first variation of the second embodiment of the present invention;

FIG. 24B is an enlarged cross-sectional view showing that the bent portion of the bridge is deformed externally so as to absorb the residual stress of the diaphragm;

FIG. 24C is an enlarged cross-sectional view showing that the bent portion of the bridge is deformed inwardly so as to absorb the residual stress of the diaphragm;

FIG. 25A is a cross-sectional view showing a condenser microphone according to a second variation of the second embodiment of the present invention, wherein a spacer is subjected to shearing deformation inwardly so as to absorb the residual stress of the diaphragm;

FIG. 25B is a cross-sectional view showing that the spacer is subjected to shearing deformation externally so as to absorb the residual stress of the diaphragm;

FIG. 26 is a cross-sectional view showing a condenser microphone according to a third variation of the second embodiment of the present invention, wherein a spacer has projections fixed onto the diaphragm;

FIG. 27 is a cross-sectional view showing a condenser microphone according to a fourth variation of the second embodiment of the present invention;

FIG. 28A is a cross-sectional view showing a condenser microphone according to a fifth variation of the second embodiment of the present invention;

FIG. 28B is a horizontal sectional view taken along line B11-B11 in FIG. 28A;

FIG. 29A is a cross-sectional view showing a condenser microphone according to a sixth variation of the second embodiment of the present invention;

FIG. 29B is a horizontal sectional view taken along line B12-B12 in FIG. 29A;

FIG. 30A is a cross-sectional view taken along line A1-A1 in FIG. 31, which shows a condenser microphone in accordance with a third embodiment of the present invention;

FIG. 30B is a cross-sectional view taken along line B1-B1 in FIG. 31;

FIG. 30C is a horizontal section view taken along line C1-C1 in FIG. 30A;

FIG. 31 is a plan view showing the condenser microphone;

FIG. 32 is a cross-sectional view diagrammatically showing a conventionally-known condenser microphone including a diaphragm having uniformly distributed rigidity;

FIG. 33 is a cross-sectional view used for explaining the operation of a diaphragm included in the condenser microphone according to the third embodiment;

FIG. 34A is a cross-sectional view taken along line A5-A5 in FIG. 35A, which is used for explaining a first step of a manufacturing method of the condenser microphone;

FIG. 34B is a cross-sectional view used for explaining a second step of the manufacturing method of the condenser microphone;

FIG. 34C is a cross-sectional view used for explaining a third step of the manufacturing method of the condenser microphone;

FIG. 34D is a cross-sectional view used for explaining a fourth step of the manufacturing method of the condenser microphone;

FIG. 34E is a cross-sectional view used for explaining a fifth step of the manufacturing method of the condenser microphone;

FIG. 34F is a cross-sectional view used for explaining a sixth step of the manufacturing method of the condenser microphone;

FIG. 34G is a cross-sectional view used for explaining a seventh step of the manufacturing method of the condenser microphone;

FIG. 35A is a plan view used for explaining the first step of the manufacturing method of the condenser microphone;

FIG. 35B is a plan view used for explaining the second step of the manufacturing method of the condenser microphone;

FIG. 35C is a plan view used for explaining the third step of the manufacturing method of the condenser microphone;

FIG. 35D is a plan view used for explaining the fourth step of the manufacturing method of the condenser microphone;

FIG. 35E is a plan view used for explaining the fifth step of the manufacturing method of the condenser microphone;

FIG. 35F is a plan view used for explaining the sixth step of the manufacturing method of the condenser microphone;

FIG. 35G is a plan view used for explaining the seventh step of the manufacturing method of the condenser microphone;

FIG. 36 is a plan view showing a condenser microphone according to a first variation of the third embodiment of the present invention;

FIG. 37A is a cross-sectional view taken along line A9-A9 in FIG. 36;

FIG. 37B is a cross-sectional view taken along line B9-B9 in FIG. 36;

FIG. 38A is a cross-sectional view taken along line A10-A10 in FIG. 40A, which is used for explaining a first step of a manufacturing method of the condenser microphone;

FIG. 38B is a cross-sectional view used for explaining a second step of the manufacturing method of the condenser microphone;

FIG. 38C is a cross-sectional view used for explaining a third step of the manufacturing method of the condenser microphone;

FIG. 38D is a cross-sectional view used for explaining a fourth step of the manufacturing method of the condenser microphone;

FIG. 39A is a cross-sectional view taken along line B10-B10 in FIG. 40A, which is used for explaining the first step of the manufacturing method of the condenser microphone;

FIG. 39B is a cross-sectional view used for explaining the second step of the manufacturing method of the condenser microphone;

FIG. 39C is a cross-sectional view used for explaining the third step of the manufacturing method of the condenser microphone;

FIG. 39D is a cross-sectional view used for explaining the fourth step of the manufacturing method of the condenser microphone;

FIG. 40A is a plan view used for explaining the first step of the manufacturing method of the condenser microphone;

FIG. 40B is a plan view used for explaining the second step of the manufacturing method of the condenser microphone;

FIG. 40C is a plan view used for explaining the third step of the manufacturing method of the condenser microphone;

FIG. 40D is a plan view used for explaining the fourth step of the manufacturing method of the condenser microphone;

FIG. 41 is a plan view showing a condenser microphone according to a second variation of the third embodiment of the present invention;

FIG. 42A is a cross-sectional view taken along line A13-A13 in FIG. 41;

FIG. 42B is a cross-sectional view taken along line B13-B13 in FIG. 41;

FIG. 43 is a cross-sectional view showing a further modification of the condenser microphone in which the near-end portion of a diaphragm has a bent shape;

FIG. 44 is a plan view showing a condenser microphone according to a third variation of the third embodiment of the present invention;

FIG. 45A is a cross-sectional view taken along line A16-A16 in FIG. 44;

FIG. 45B is a cross-sectional view taken along line B16-B16 in FIG. 44;

FIG. 46 is a plan view showing a condenser microphone according to a fourth variation of the third embodiment of the present invention;

FIG. 47A is a cross-sectional view taken along line A18-A18 in FIG. 46;

FIG. 47B is a cross-sectional view taken along line B18-B18 in FIG. 46;

FIG. 48 is an enlarged fragmentary plan view showing a condenser microphone according to a fifth variation of the third embodiment of the present invention;

FIG. 49 is an enlarged fragmentary plan view showing a condenser microphone according to a sixth variation of the third embodiment of the present invention;

FIG. 50A is a plan view showing a further variation of the third embodiment;

FIG. 50B is a cross-sectional view taken along line B21-B21 in FIG. 50A;

FIG. 51 is a cross-sectional view taken along line A-A in FIG. 52, which shows a condenser microphone in accordance with a fourth embodiment of the present invention;

FIG. 52 is a plan view showing the condenser microphone;

FIG. 53 is a plan view showing prescribed parts of the condenser microphone without illustrating a plate;

FIG. 54 is a plan view showing prescribed parts of the condenser microphone without illustrating a spacer;

FIG. 55A is a plan view used for explaining a first step of a manufacturing method of the condenser microphone according to the third embodiment of the present invention;

FIG. 55B is a cross-sectional view taken along line A-A in FIG. 55A;

FIG. 56A is a plan view used for explaining a second step of the manufacturing method of the condenser microphone;

FIG. 56B is a cross-sectional view taken along line A-A in FIG. 56A;

FIG. 57A is a plan view used for explaining a third step of the manufacturing method of the condenser microphone;

FIG. 57B is a cross-sectional view taken along line A-A in FIG. 57A;

FIG. 58A is a plan view used for explaining a fourth step of the manufacturing method of the condenser microphone;

FIG. 58B is a cross-sectional view taken along line A-A in FIG. 58A;

FIG. 59 is a cross-sectional view showing a condenser microphone according to a first variation of the fourth embodiment of the present invention;

FIG. 60A is a plan view showing a condenser microphone according to a second variation of the fourth embodiment of the present invention;

FIG. 60B is a cross-sectional view taken along line A-A in FIG. 60A;

FIG. 61 is a cross-sectional view showing a condenser microphone according to a third variation of the fourth embodiment of the present invention;

FIG. 62 is a plan view showing a condenser microphone in accordance with a fifth embodiment of the present invention;

FIG. 63 is a cross-sectional view taken along line X-X in FIG. 62;

FIG. 64 is a cross-sectional view used for explaining a first step of a manufacturing method of the condenser microphone;

FIG. 65 is a cross-sectional view used for explaining a second step of the manufacturing method of the condenser microphone;

FIG. 66 is a cross-sectional view used for explaining a third step of the manufacturing method of the condenser microphone;

FIG. 67 is a cross-sectional view used for explaining a fourth step of the manufacturing method of the condenser microphone;

FIG. 68 is a cross-sectional view used for explaining a fifth step of the manufacturing method of the condenser microphone;

FIG. 69 is a cross-sectional view used for explaining a sixth step of the manufacturing method of the condenser microphone;

FIG. 70 is a cross-sectional view used for explaining a seventh step of the manufacturing method of the condenser microphone;

FIG. 71 is a cross-sectional view used for explaining an eighth step of the manufacturing method of the condenser microphone;

FIG. 72 is a plan view showing a modification of the condenser microphone;

FIG. 73 is a plan view showing a condenser microphone according to a first variation of the fifth embodiment of the present invention;

FIG. 74 is a cross-sectional view taken along line X-X in FIG. 73;

FIG. 75 is a cross-sectional view used for explaining a first step of a manufacturing method of the condenser microphone;

FIG. 76 is a cross-sectional view used for explaining a second step of the manufacturing method of the condenser microphone;

FIG. 77 is a cross-sectional view used for explaining a third step of the manufacturing method of the condenser microphone;

FIG. 78 is a cross-sectional view used for explaining a fourth step of the manufacturing method of the condenser microphone;

FIG. 79 is a plan view showing a further modification of the condenser microphone shown in FIG. 73;

FIG. 80 is a cross-sectional view taken along line X-X in FIG. 79;

FIG. 81 is a plan view showing a condenser microphone according to a second variation of the fifth embodiment of the present invention;

FIG. 82 is a cross-sectional view taken along line X-X in FIG. 81;

FIG. 83 is a plan view showing a further modification of the condenser microphone shown in FIG. 81;

FIG. 84 is a cross-sectional view taken along line X-X in FIG. 83;

FIG. 85 is a plan view used for explaining a drawback of the condenser microphone, which is solved by the fifth embodiment of the present invention;

FIG. 86 is a cross-sectional view taken along line X-X in FIG. 85;

FIG. 87A is a cross-sectional view showing a normal position of the condenser microphone;

FIG. 87B is a cross-sectional view showing a reverse position of the condenser microphone; and

FIG. 87C is a cross-sectional view showing a vertical position of the condenser microphone.

### BEST MODE FOR CARRYING OUT THE INVENTION

The present invention will be described in detail by way of examples with reference to the accompanying drawings.

### 1. First Embodiment

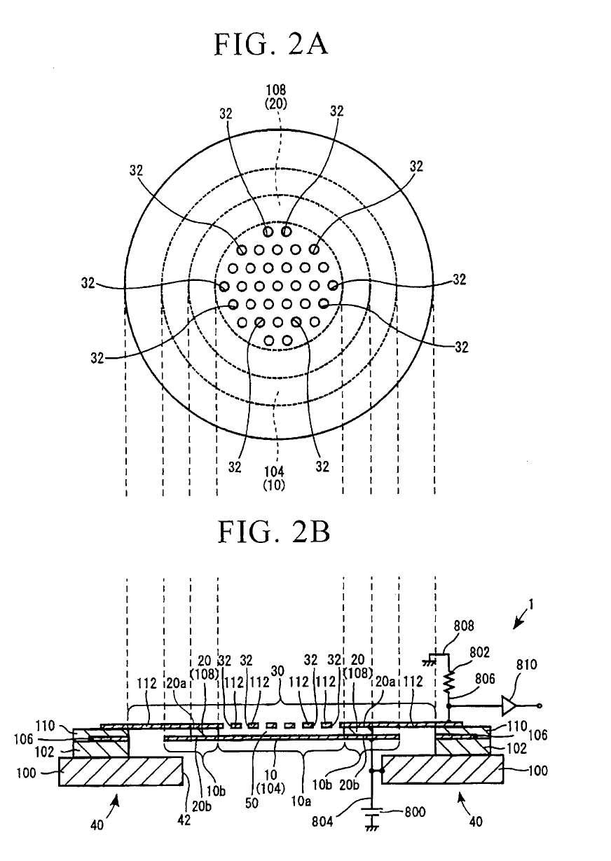

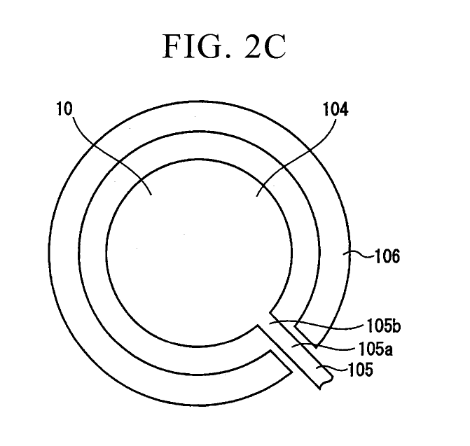

FIGS. 2A, 2B, and 2C show the overall constitution of a condenser microphone 1 just after the manufacturing thereof in accordance with a first embodiment of the present invention. The condenser microphone 1 is a silicon capacitor microphone, which is produced by way of a semiconductor manufacturing process. The condenser microphone 1 has a sensing portion (see a cross-sectional view of FIG. 2B) and a detecting portion (see the circuitry shown in FIG. 2B).

(a) Constitution of Sensing Portion

The sensing portion of the condenser microphone 1 is constituted of a diaphragm 10, a spacer 20, a back plate 30, and supports 40.

The diaphragm 10 is composed of a conductive film 104, which is a semiconductor film composed of polycrystal silicon (or polysilicon), for example. The diaphragm 10 having a conductivity functions as a moving electrode, wherein the diaphragm 10 can be constituted of a plurality of films including an insulating film and a conductive film (which serves as the moving electrode and which is formed at least in the center portion thereof). The diaphragm 10 is not necessarily limited to a disk-like shape; hence, it can be formed in any shape.

The back plate 30 (or the plate 30) is constituted of the prescribed portion of a conductive film 112 that is not fixed to an insulating film 110. The conductive film 112 is a semiconductor film composed of polysilicon, for example, and is bridged across the supports 40. A plurality of holes 32 are formed in the back plate 30 so as to allow sound waves (originated from a sound source, not shown) to propagate therethrough (see FIG. 2A). That is, sound waves from the sound source propagate through the holes 32 of the back plate 30 and are then transmitted to the diaphragm 10. The back plate 30 having a conductivity functions as a fixed electrode, wherein the back plate 30 can be constituted of a plurality of films including an insulating film and a conductive film (which serves as the fixed electrode and which is formed at least in the center portion thereof). Each of the holes 32 is not necessarily limited to a circular shape as shown in FIG. 2A; hence, it can be formed in any shape.

The spacer 20 is constituted of a ring-shaped insulating film 108, which is an oxide film composed of SiO₂, for example. A first end 20a of the spacer 20 is fixed to the back plate 30, and a second end 20b of the spacer 20 is fixed to a near-end portion 10b surrounding a center portion 10a of the diaphragm 10. An air gap 50 is formed between the back plate 30 and the diaphragm 10 by way of the spacer 20. The spacer 20 can be formed in a C-shape surrounding the center portion 10a of the diaphragm 10. Alternatively, it is possible to form a plurality of spacers, which are positioned in a circumferential direction of the diaphragm 10 with equal spacing therebetween.

The supports 40 are each constituted of the prescribed portion of the conductive film 112 that is fixed to the insulating film 110, and the insulating film 110 as well as a conductive film 106, an insulating film 102, and a substrate 100. For example, both of the insulating films 110 and 102 are oxide films composed of SiO₂; the conductive film 106 is a semiconductor film composed of polysilicon; and the substrate 100 is a monocrystal silicon substrate.

As shown in FIG. 2C, the support 40 has an electrode for connecting a bias voltage circuit 800 (serving as the detecting portion) and the diaphragm 10 together and a lead 105a of an electrode extension portion 105. The electrode extension portion 105 is composed of the conductive film 104, by which the electrode and the diaphragm 10 are connected together. Specifically, the electrode extension portion 105 is constituted of the lead 105a, which is extended from the electrode to the diaphragm 10, and a bridge 105b, which lies between the support 40 and the diaphragm 10. An opening 42 is defined between the supports 40 and is formed to run through the substrate 100 and the insulating film 102. The opening 42 forms a back cavity of the condenser microphone 1.

The conductive film 106 forming the supports 40 prevents the capacity, which is formed between the conductive film 112 (forming the back plate 30) and the substrate 100 in proximity to the supports 40, from lying in parallel with the electrostatic capacitance between the diaphragm 10 and the back plate 30; that is, it functions as a guard electrode. However, when the conductive film 106 does not function as a guard electrode in the detecting portion (see FIG. 2B), the supports 40 are not necessarily formed using the conductive film 106.

(b) Constitution of Detecting Portion

The diaphragm 10 is connected to the bias voltage circuit 800, and the back plate 30 is grounded via a resistor 802 and is also connected to a pre-amplifier 810. The detecting portion of the condenser microphone 1 outputs the voltage applied between the back plate 30 and the ground by way of the pre-amplifier 810.

Specifically, a lead 804 connected to the bias voltage circuit 800 is connected to the conductive film 104 (forming the diaphragm 10) and the substrate 100. A lead 806 connected to one end of the resistor 802 is connected to the conductive film 112 forming the back plate 30, and a lead 808 connected to another end of the resistor 802 is grounded via a packaging board (not shown) of the condenser microphone 1. The resistor 802 has a relatively high resistance. Specifically, it is preferable that the resistor 802 has resistance of giga-order ohms. The lead 806 connecting between the back plate 30 and the resistor 802 is connected to an input terminal of the pre-amplifier 810. Incidentally, the pre-amplifier 810 has relatively high input impedance.

It is possible to form a voltage-follower circuit using the pre-amplifier 810, wherein an output terminal of the pre-amplifier 810 is connected to the conductive film 106 serving as the guard electrode. That is, by placing both the back plate 30 and the conductive film 106 substantially at the same potential, it is possible to prevent the capacity, which is formed between the back plate 30 and the substrate 100, from lying in parallel with the electrostatic capacitance between the diaphragm 10 and the back plate 30. Of course, the aforementioned electrical line connection is not necessarily formed in the condenser microphone 1. Hence, it is possible to omit the conductive film 106 from the condenser microphone 1.

(c) Operation of Condenser Microphone

When sound waves propagate through the holes 32 of the back plate 30 and are then transmitted to the diaphragm 10, the diaphragm 10 vibrates due to sound waves applied thereto. The vibration of the diaphragm 10 causes variations of the distance between the back plate 30 and the diaphragm 10, which in turn cause variations of the electrostatic capacitance between the back plate 30 and the diaphragm 10.

Since the back plate 30 is connected to the resistor 802 having relatively high resistance, electric charges accumulated in the capacity between the back plate 30 and the diaphragm 10 do not substantially flow through the resistor 802 even when the electrostatic capacitance changes due to the vibration of the diaphragm 10. That is, it is presumed that substantially no variation occurs with respect to electric charges accumulated in the capacity between the back plate 30 and the diaphragm 10. Thus, it is possible to extract variations of electrostatic capacitance as variations of voltage between the back plate 30 and the ground.

As described above, the condenser microphone 1 can produce electric signals based on very small variations of electrostatic capacitance. That is, the condenser microphone 1 converts variations of sound pressure applied to the diaphragm 10 into variations of electrostatic capacitance, which are then converted into variations of voltage, thus producing electric signals based on variations of sound pressure.

It is previously discussed with reference to FIGS. 2A to 2C that residual stress occurs in the diaphragm 10 just after the manufacturing of the condenser microphone 1. For example, when the conductive film 104 forming the diaphragm 10 is composed of polysilicon, a relatively high tensile stress is likely to occur in the diaphragm 10. When such a relatively high tensile stress remains in the diaphragm 10, it is very difficult for the diaphragm 10 to vibrate with a relatively large amplitude due to sound waves. This reduces the sensitivity of the condenser microphone 1.

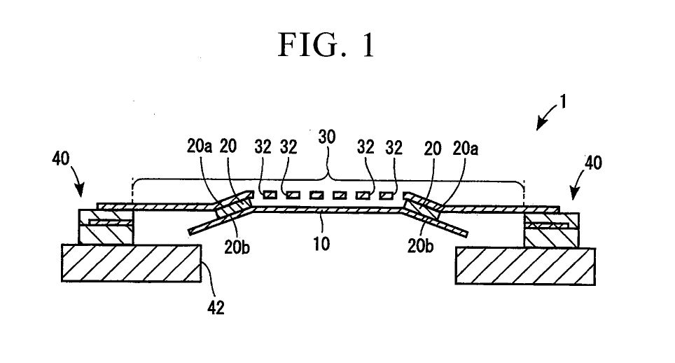

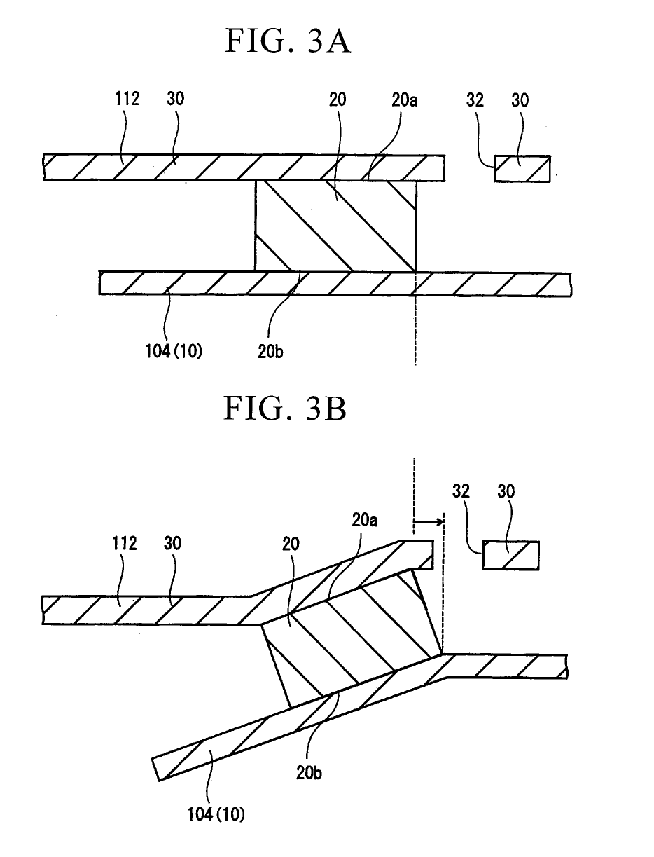

FIG. 1 shows the sensing portion of the condenser microphone 1, which is observed at a prescribed time after the Completion of manufacturing. The shape shift of the sensing portion of the condenser microphone 1, which occurs in the prescribed time after the completion of manufacturing, will be described with reference to FIGS. 3A and 3B. FIG. 3A is an enlarged view showing the spacer 20 and its associated parts just after the completion of manufacturing; and FIG. 3B is an enlarged view of the spacer 20 and its associated parts, which is observed at the prescribed time after the completion of manufacturing.

It is previously described that the first end 20a of the spacer 20 is fixed to the back plate 30, which is bridged across the supports 40, and the second end 20b of the spacer 20 is fixed to the prescribed portion of the diaphragm 10, which is not fixed to the supports 40. When the second end 20b of the spacer 20 is pulled toward the center portion 10a of the diaphragm 10 due to the tensile stress applied to the diaphragm 10, the second end 20b of the spacer 20 is distorted and contracted in a diameter direction. In other words, as shown in FIG. 3B, the second end 20b of the spacer 20 rotates about the first end 20a and is thus distorted and inclined towards the center portion 10a of the diaphragm 10, so that the second end 20b of the spacer 20 is moved slightly close to the center portion 10a of the diaphragm 10 in comparison with the first end 20a. This positional shift occurs in terms of the cross section of the spacer 20, i.e., a vertical section of the spacer 20 taken in its diameter direction.

In the above, the back plate 30 is pulled upwards and partially deformed due to the displacement of the spacer 20, which occurs due to the tensile stress of the diaphragm 10. Specifically, the prescribed portion of the back plate 30, which is fixed to the spacer 20, and its inner portion, project opposite to the diaphragm 10 in a bowl-like form.

As described above, when the second end 20b of the spacer 20 moves close to the center portion 10a of the diaphragm 10 in comparison with the first end 20a, it is possible to reduce the tensile stress of the diaphragm 10, whereby a small amount of tensile stress still remains in the diaphragm 10.

Simulation is conducted on an example of the condenser microphone 1, which is experimentally produced using an example of the diaphragm 10 having a disk-like shape, in which the diameter is 760 μm and the thickness is 0.66 μm, the spacer 20 having a ring shape concentric with the diaphragm 10, in which the inner diameter is 700 μm, the outer diameter is 720 μm, and the thickness is 4 μm, and the back plate 30 having a disk-like shape, in which the diameter is 840 μm, and the thickness is 0.5 μm. The simulation result shows that the tensile stress of the diaphragm 10 decreases from 70 MPa (which occurs just after the completion of the manufacturing) to 10 MPa in the aforementioned example of the condenser microphone 1. This guarantees that the diaphragm 10 vibrates with relatively large amplitude due to sound waves applied thereto. Hence, it is possible to increase the sensitivity of the condenser microphone 1.

(d) Manufacturing Method

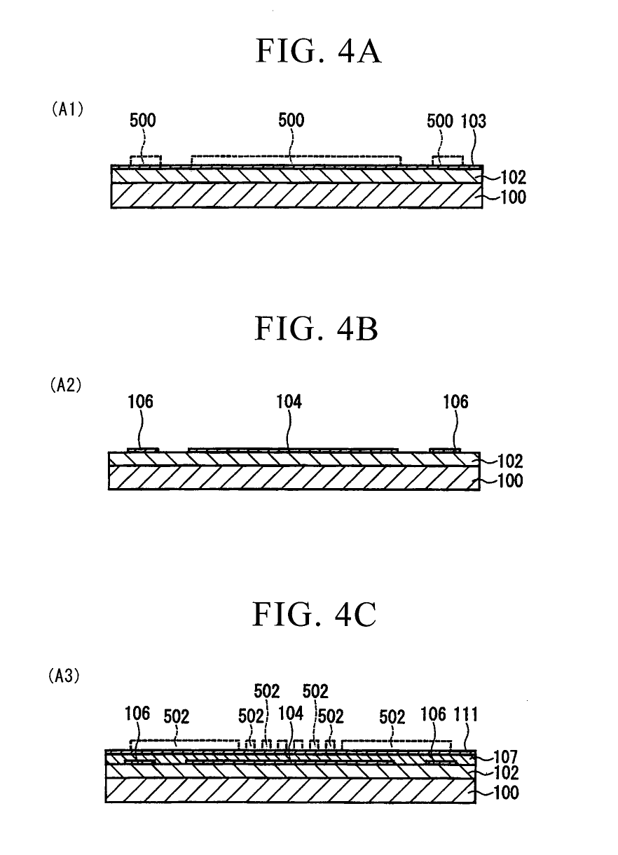

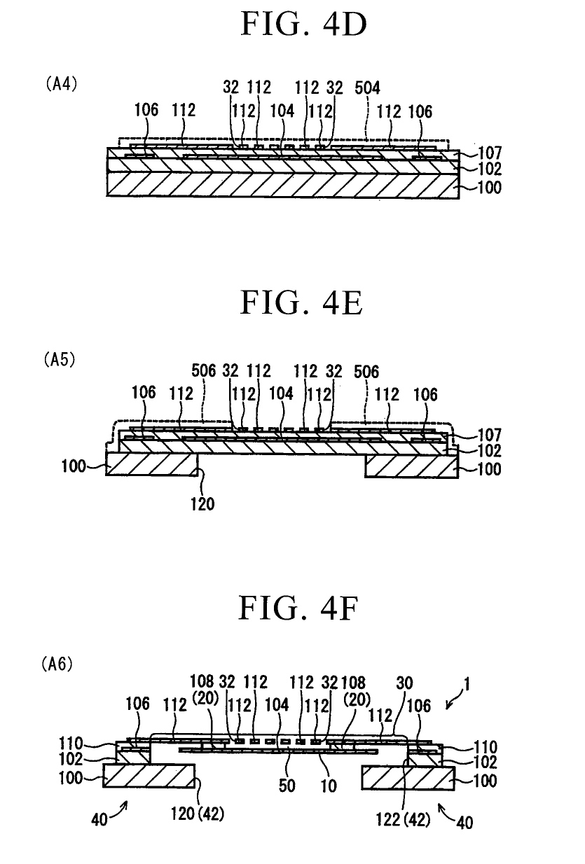

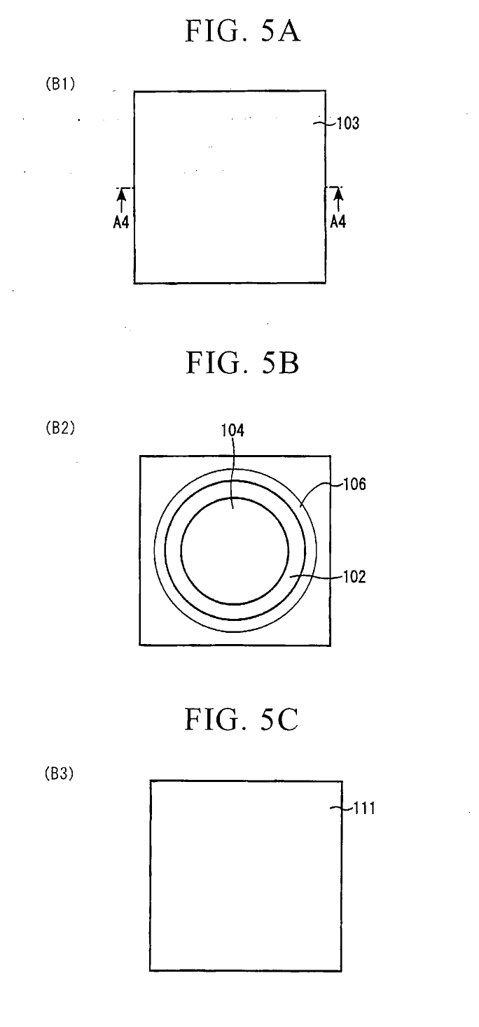

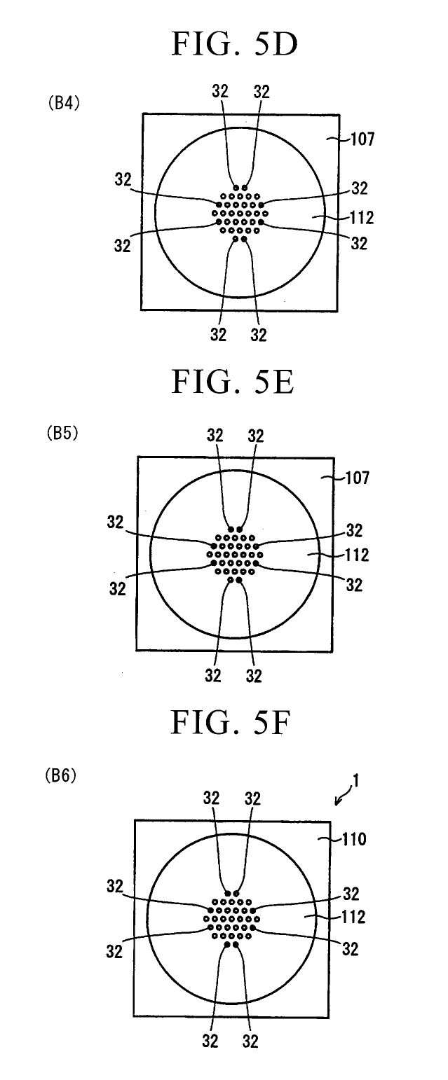

A manufacturing method of the condenser microphone 1 will be described in detail with reference to FIGS. 4A to 4F and FIGS. 5A to 5F, wherein FIGS. 4A to 4F are cross-sectional views taken along line A4-A4 in FIG. 5A, and wherein reference symbols (A1) to (A6) are assigned to FIGS. 4A to 4F in connection with reference symbols (B1) to (B6) assigned to FIGS. 5A to 5F.

In a first step (see (A1), i.e., FIG. 4A), an insulating film 102 is formed on a substrate 100, which is a semiconductor substrate such as a monocrystal silicon substrate, for example. Specifically, an insulating material is deposited on the surface of the substrate 100 by way of CVD (Chemical Vapor Deposition), thus forming the insulating film 102 on the substrate 100.

Next, a conductive film 103 (e.g., a polysilicon film) is formed on the insulating film 102 by way of CVD. This process can be omitted by using an SOI (Silicon On Insulator) substrate.

In a second step (see (B2), i.e., FIG. 5B), the conductive film 103 is subjected to patterning so as to form a conductive film forming the diaphragm 10 and a conductive film 106 forming the supports 40. Specifically, a resist film 500 is formed on the conductive film 103 by way of lithography so as to cover the prescribed portion of the conductive film 103, which must remain in order to form the conductive films 104 and 106, and to expose unnecessary portions of the conductive film 103. More specifically, a resist is applied onto the conductive film 103 so as to form the resist film 500. By use of a mask having a prescribed shape, a resist film is subjected to exposure and development so as to remove unnecessary portions thereof, thus forming the resist film 500 on the conductive film 103. Next, as shown in FIG. 5B (or (B2)), the prescribed portion of the conductive film 103, which is exposed from the resist film 500, is subjected to etching such as RIE (Reaction Ion Etching), thus forming the conductive films 104 and 106. Thereafter, the resist film 500 is removed by use of a resist peeling solution such as NMP (N-methyl-2-pyrrolidone).

In a third step (see (A3), i.e., FIG. 4C), an insulating film 107 whose thickness is larger than the thickness of the conductive films 104 and 106 is formed above the conductive films 104 and 106 by way of CVD. In the following process, the insulating films 102 and 107 are selectively removed in connection with the conductive films 104 and 106 and a conductive film 112 forming the back plate 30. Hence, it is preferable that the insulating films be composed of a prescribed material whose etching ratio is higher than the etching ratio of the conductive films. For example, when the conductive films are composed of polysilicon, the insulating films are composed of SiO₂.

In the process in which the insulating films are selectively removed in connection with the conductive films, the insulating films are partially removed and are partially retained so as to form the prescribed parts of the condenser microphone 1. Hence, it is preferable that the insulating films 102 and 107 be composed of the same material, whereby substantially the same etching rate can be applied to them. This makes it possible to easily control the amount of etching performed on the insulating films.

Next, a conductive film 111 (e.g., a polysilicon film) is formed on the insulating film 107 by way of CVD.

In a fourth step (see (B4), i.e., FIG. 5D), the conductive film 111 is subjected to patterning so as to form a conductive film 112 forming the back plate 30 and the supports 40. Specifically, a resist film 502 is formed on the conductive film 111 by way of lithography so as to cover the prescribed portion of the conductive film 111, which is retained as the conductive film 112, and to expose unnecessary portions of the conductive film 111. Next, the prescribed portion of the conductive film 111, which is exposed from the resist film 502, is subjected to etching such as RIE, thus forming the conductive film 112. Then, the resist film 502 is removed.

In a fifth step (see (A5), i.e., FIG. 4E), the insulating films 102 and 107 are subjected to shaping. Specifically, a resist film 504 is formed so as to expose unnecessary portions of the insulating films 102 and 107. Next, the exposed portions of the insulating films 102 and 107, which are exposed from the resist film 504, are subjected to etching such as RIE, thus appropriately shaping the insulating films 102 and 107.

Next, an opening 120 corresponding to the opening 42 defined by the supports 40 is formed in the substrate 100. Specifically, a resist film for exposing the prescribed portion of the substrate 100, which is used for the formation of the opening 120, is formed by way of lithography. Next, the exposed portion of the substrate 100, which is exposed from the resist film, is removed by way of Deep RIE such that etching is performed toward the insulating film 102, thus forming the opening 120 in the substrate 100. Thereafter, the resist film is removed.

In a sixth step (see (A6), i.e., FIG. 4F), the insulating films 102 and 107 are partially removed so as to form an opening 122 of the insulating film 102 corresponding to the opening 42 defined by the supports 40 and to form an insulating film 108 forming the spacer 20 and an insulating film 110 forming the supports 40 by use of the insulating film 107. Specifically, a resist film 506 for exposing the holes 32 and the opening 42 (see (A5), i.e., FIG. 4E) is formed. Then, the insulating films 102 and 107 are removed by way of wet etching. When the insulating film 102 and 107 are composed of SiO₂, hydrofluoric acid is used as an etching solution. The etching solution is infiltrated into the opening 120 of the substrate 100 and the holes 32 of the conductive film 112 so as to reach the insulating films 102 and 107, which are thus dissolved. Thus, the air gap 50 is formed between the diaphragm 10 and the back plate 30; and the spacer 20 and the supports 40 are formed as well. Thus, it is possible to produce the sensing portion of the condenser microphone 1.

The first embodiment can be further modified in a variety of ways, which will be described below.

(e) First Variation

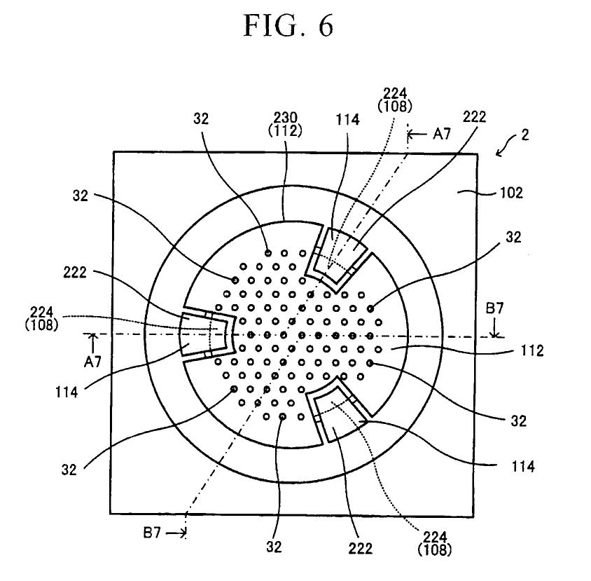

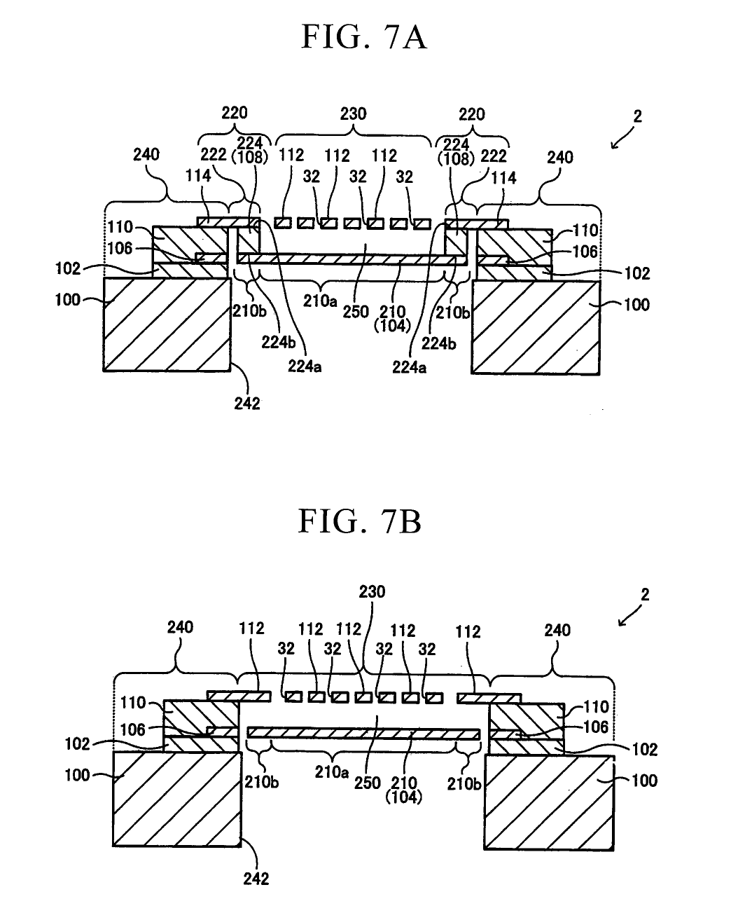

A first variation of the first embodiment will be described with reference to FIG. 6 and FIGS. 7A and 7B, which show a condenser microphone 2 just after the completion of the manufacturing. FIG. 7A is a cross-sectional view taken along line A7-A7 in FIG. 6; and FIG. 7B is a cross-sectional view taken along line B7-B7 in FIG. 6. The detecting portion of the condenser microphone 2 is substantially identical to the detecting portion of the condenser microphone 1. Hence, the following description is given with respect to the constitution of a sensing portion of the condenser microphone 2 and its manufacturing method.

As shown in FIGS. 7A and 7B, the sensing portion of the condenser microphone 2 is constituted of a diaphragm 210, bridges 220, a back plate 230, and supports 240.

The diaphragm 210 is substantially identical to the diaphragm 10; and the back plate 230 is substantially identical to the back plate 30.

The bridges 220 are constituted of beam portions 222 and interconnecting portions 224, by which the diaphragm 210 is bridged across the supports 240 in such a way that an air gap 250 is formed between the diaphragm 210 and the back plate 230. The beam portions 222 are formed using the prescribed portion of a conductive film 114 that is not fixed to the insulating film 110. The conductive film 114 is formed using a semiconductor such as polysilicon and is extended from the supports 240 in a cantilever manner. The interconnecting portions 224 are formed using an insulating film 108, which is an oxide film composed of SiO₂, for example. First ends 224a of the interconnecting portions 224 are fixed to free ends of the beam portions 222, and second ends 224b are fixed to prescribed positions of a near-end portion 210b of the diaphragm 210. Specifically, three bridges 220 are arranged in a circumferential direction of the diaphragm 210 with an angle of 120° therebetween so as to surround a center portion 210a of the diaphragm 210 (see FIG. 6). The diaphragm 210 is bridged across the supports 240 via the bridges 220 at three points.

The supports 240 are substantially identical to the supports 40. Specifically, the supports 240 are constituted of the prescribed portion of the conductive film 112 that is fixed to the insulating film 110 and the prescribed portion of the conductive film 114 that is fixed to the insulating film 110 as well as the insulating film 110, the conductive film 106, the insulating film 102, and the substrate 100. The sensing portion of the condenser microphone 2 is configured similarly to the sensing portion of the condenser microphone 1. That is, the support 240 has an electrode and an electrode extension portion (not shown) for connecting the diaphragm 210 and the bias voltage circuit 800 together. Similar to the opening 42 defined by the supports 40, an opening 242 is defined by the supports 240 so as to form a back cavity. In the condenser microphone 2, the bridges 220 can serve as electrode extension portions by forming the interconnecting portions 224 using a conductive material.

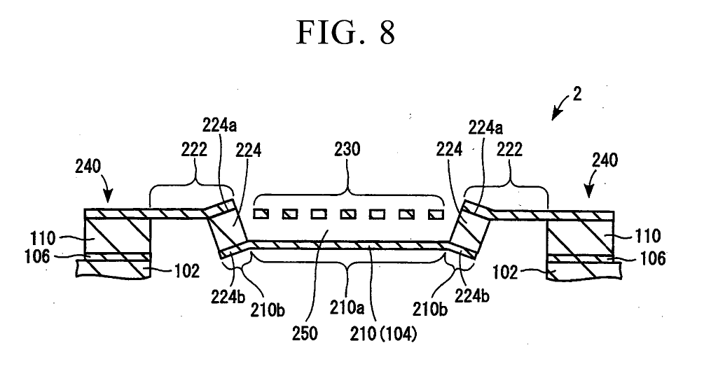

FIG. 8 shows the sensing portion of the condenser microphone 2, which is observed at a prescribed time after the completion of manufacturing thereof.

It is previously described that the first ends 224a of the interconnecting portions 224 included in the bridges 220 are fixed to the beam portions 222, which are extended inwardly from the supports 240, and the second ends 224b of the interconnecting portions 224 are fixed to the prescribed portion of the diaphragm 210, which is not fixed to the supports 240. When the second ends 224b of the interconnecting portions 224 are pulled toward the center portion 210a of the diaphragm 210 due to the tensile stress applied to the diaphragm 210, the second ends 224b of the interconnecting portions 224 are inclined toward the center portion 210a of the diaphragm 210 in such a way that the second ends 224b rotate about the first ends 224a. Due to the displacements of the interconnecting portions 224, which occur due to the tensile stress of the diaphragm 210, the beam portions 222 are pushed upwardly and deformed.

As described above, due to the tensile stress of the diaphragm 210, the second ends 224b of the interconnecting portions 224 are moved close to the center portion 210a of the diaphragm 210 in comparison with the first ends 224a; hence, the tensile stress of the diaphragm 210 is reduced, but slight tensile stress, which is smaller than the tensile stress occurring just after the completion of the manufacturing, still remains in the diaphragm 210. This ensures that the diaphragm 210 vibrates with a relatively large amplitude due to sound waves applied thereto. Hence, it is possible to increase the sensitivity of the condenser microphone 2. Incidentally, it is possible to further increase the sensitivity of the condenser microphone 2 by positioning the diaphragm 210 close to the back plate 230.

The condenser microphone 2 is advantageous in that the sensitivity thereof can be increased irrespective of the tensile stress that remains in the diaphragm 210 just after the completion of manufacturing. When relatively small tensile stress remains in the diaphragm 210 just after the completion of manufacturing, it is further reduced so that very small tensile stress still remains in the diaphragm 210, whereby the diaphragm 210 is positioned close to the back plate 230, thus increasing the sensitivity of the condenser microphone 2. When relatively high tensile stress remains in the diaphragm 210 just after the completion of manufacturing, it is reduced but a tensile stress, which is higher than the aforementioned relatively small tensile stress remaining in the diaphragm 210 just after the completion of the manufacturing, still remains in the diaphragm 210. In this case, the diaphragm 210 moves close to the back plate 230 in comparison with the aforementioned diaphragm 210 bearing the relatively small tensile stress just after the completion of manufacturing. Hence, it is possible to improve the sensitivity of the condenser microphone 2 irrespective of the relatively high tensile stress remaining in the diaphragm 210 just after the completion of manufacturing. That is, the condenser microphone 2 can reduce dispersions of sensitivity, which occur due to dispersions of tensile stress remaining in the diaphragm 210 just after the completion of manufacturing.

The first variation of the first embodiment is directed to the condenser microphone 2, in which the diaphragm 210 is bridged across the supports 240 and is stretched under tension by way of three bridges 220. The condenser microphone 2 can be further modified in such a way that the diaphragm 210 is bridged across the supports 240 and is stretched under tension by way of two bridges 220 or by way of four or more bridges 220.

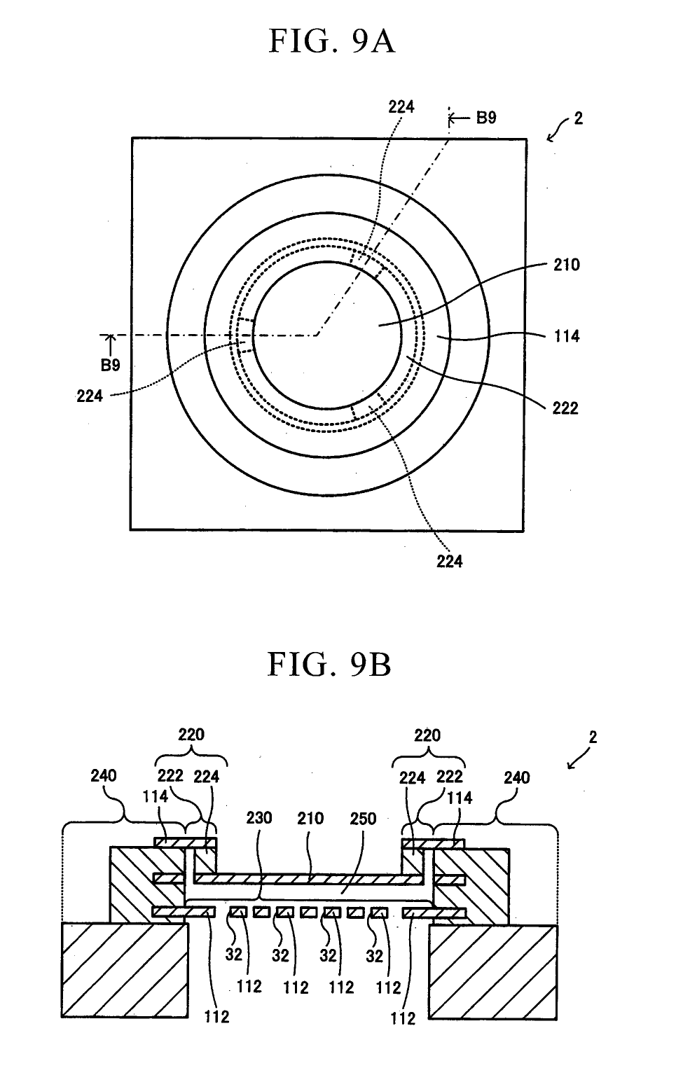

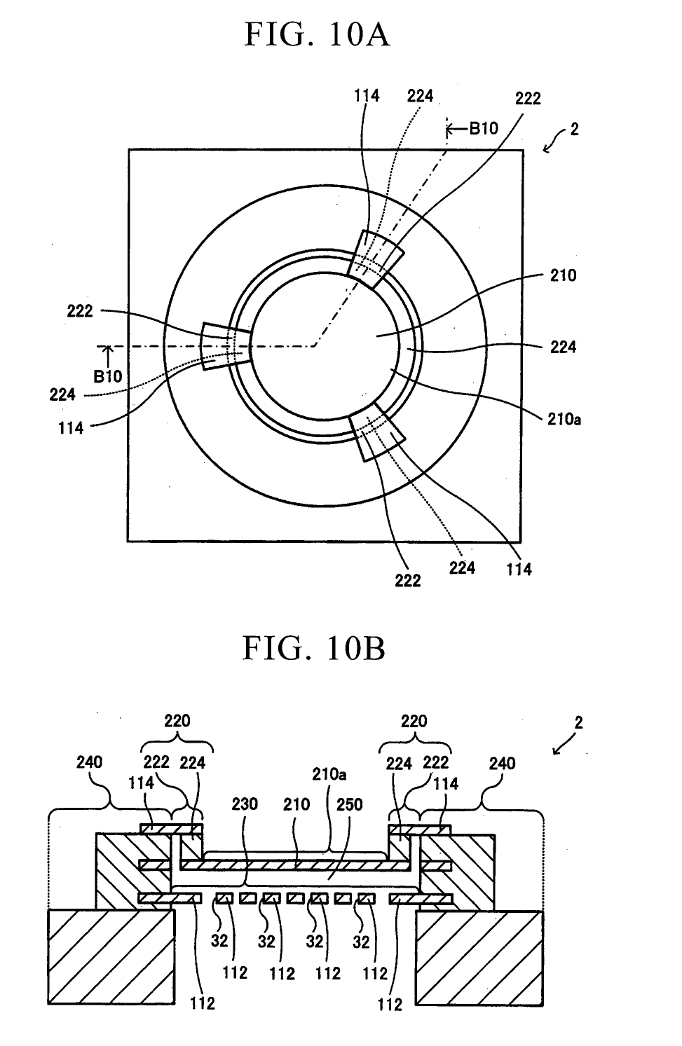

In order to simplify the constitution and manufacturing process of the condenser microphone 2, it is preferable that both of the conductive film 112 forming the back plate 230 and the conductive film 114 forming the beam portions 222 of the bridges 220 be formed by way of the same layer. Alternatively, the conductive films 112 and 114 can be formed in different layers, wherein the beam portion 222 of the bridges 220 has a ring shape, which is extended inwardly from the overall circumferential portion of the support 240 as shown in FIGS. 9A and 9B. In addition, the interconnecting portion 224 can be formed in a ring shape surrounding the center portion 210a of the diaphragm 210 as shown in FIGS. 10A and 10B, or it can be formed in a C-shape, for example.

In addition, the condenser microphone 2 can be redesigned such that, compared with the back plate 230, the diaphragm 210 is positioned closer to a sound source (not shown), so that sound waves are directly transmitted to the diaphragm 210.

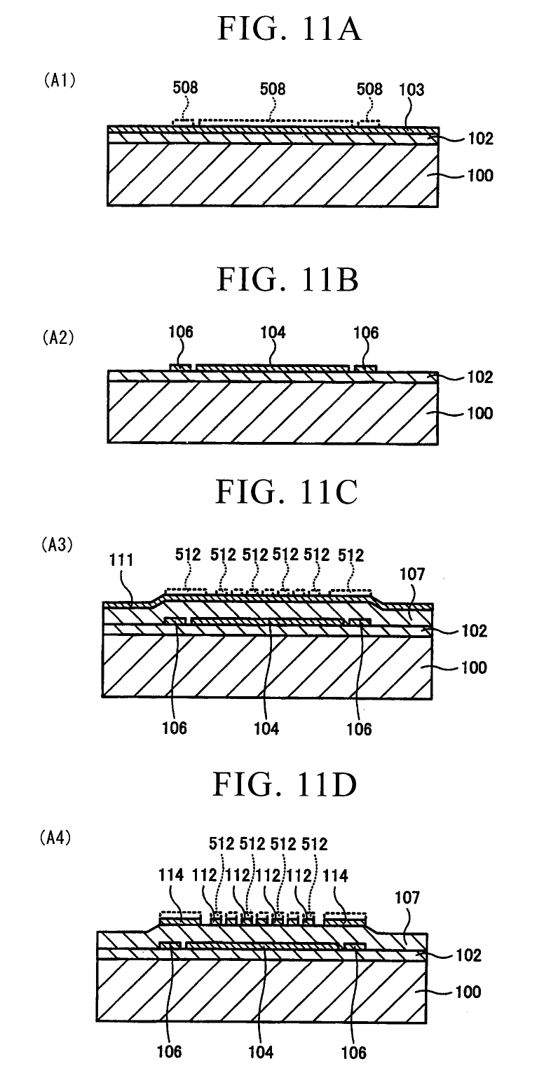

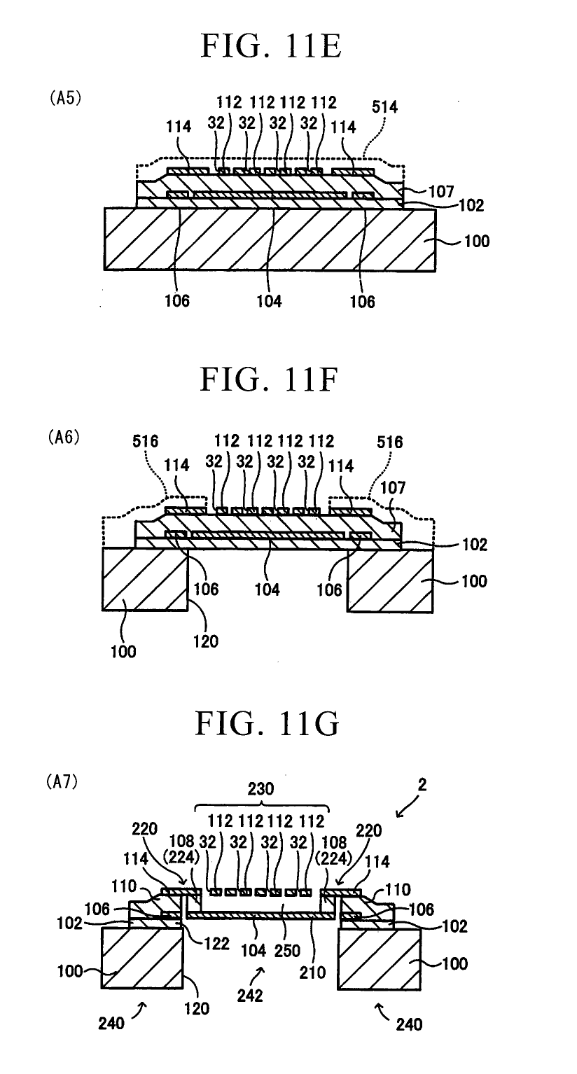

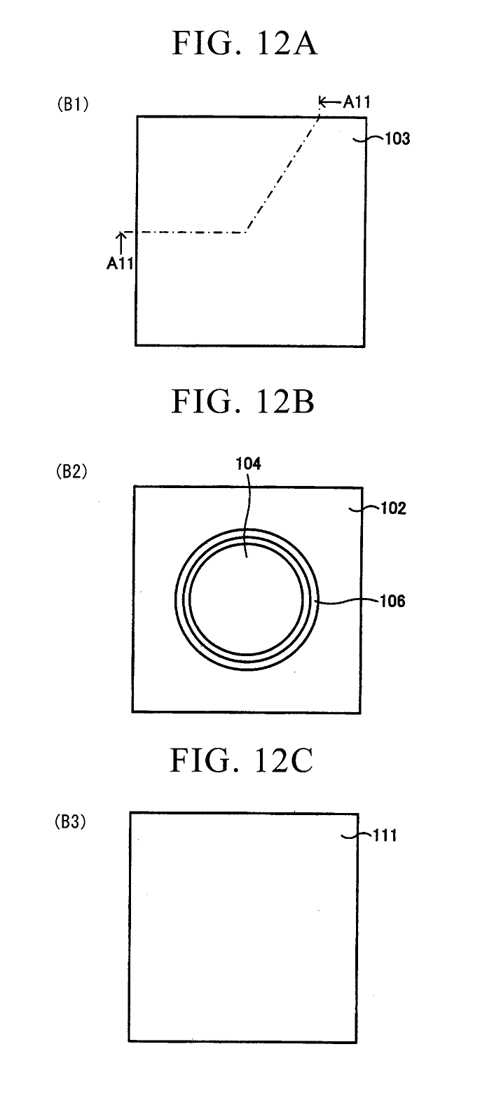

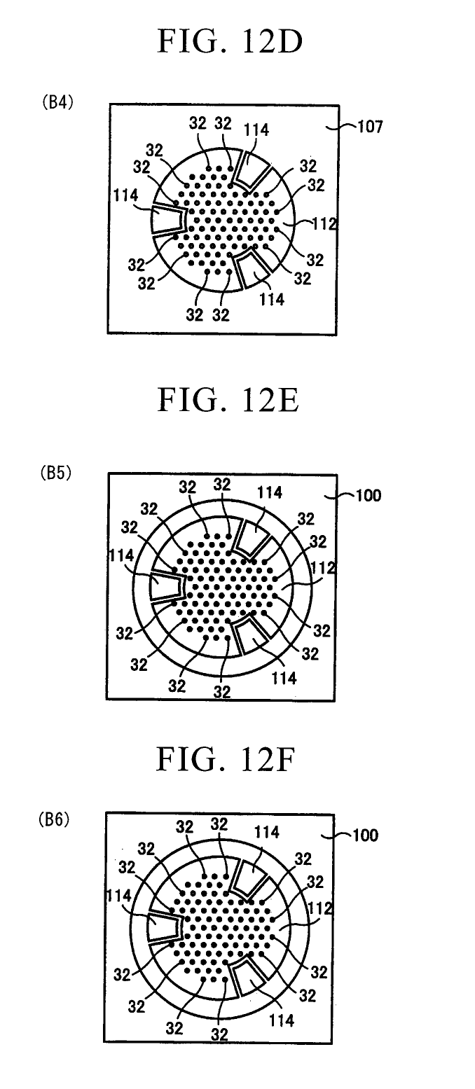

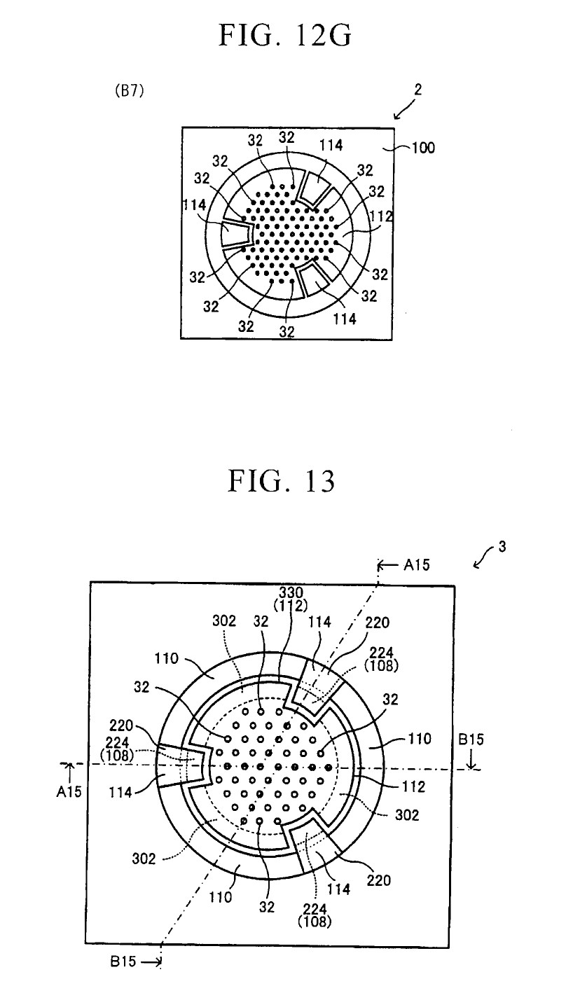

Next, a manufacturing method of the condenser microphone 2 will be described with reference to FIGS. 11A to 11G and FIGS. 12A to 12G, wherein FIGS. 11A to 11G (designated by reference symbols (A1) to (A7)) are cross-sectional views of FIGS. 12A to 12G (designated by reference symbols (B1) to (B7)) and are each taken along line A11-A11 in FIG. 12A.

In a first step of the manufacturing method of the condenser microphone 2 (see (A1), i.e., FIG. 11A), similar to the manufacturing method of the condenser microphone 1, the insulating film 102 is formed on the substrate 100, then, the conductive film 103 is formed on the insulating film 102.

In a second step of the manufacturing method (see (B2), i.e., FIG. 12B), the conductive film 103 is subjected to patterning so as to form the conductive film 104 forming the diaphragm 210 and the conductive film 106 forming the supports 240. Specifically, a resist film 508 is formed on the conductive film 103 by way of lithography so as to cover the prescribed portions of the conductive film 103, which are left as the conductive films 104 and 106, and to expose unnecessary portions of the conductive film 103. Next, the exposed portion of the conductive film 103, which is exposed from the resist film 508, is subjected to etching such as RIE, thus forming the conductive films 104 and 106. Thereafter, the resist film 508 is removed.

In a third step of the manufacturing method (see (A3), i.e., FIG. 11C), the insulating film 107 whose thickness is larger than the thickness of the conductive films 104 and 106 is formed above the conductive films 104 and 106 on the insulating film 102 by way of CVD. Next, the conductive film 111 is formed on the insulating film 107 by way of CVD.

In a fourth step of the manufacturing method (see (B4), i.e., FIG. 12D), the conductive film 111 is subjected to patterning so as to form the conductive film 112 forming the back plate 230 and the conductive film 114 forming the bridges 220 and the supports 240. Specifically, a resist film 512 is formed on the conductive film 111 by way of lithography so as to cover the prescribed portions of the conductive film 111, which are left as the conductive films 112 and 114, and to expose the unnecessary portion of the conductive film 111. Next, the exposed portion of the conductive film 111, which is exposed from the resist film 512, is subjected to etching such as RIE, thus forming the conductive films 112 and 114. Thereafter, the resist film 512 is removed. As described above, both of the conductive films 112 and 114 are formed using the same conductive film 111. Thus, it is possible to simplify the constitution and manufacturing process of the condenser microphone 2.

In a fifth step of the manufacturing method (see (A5), i.e., FIG. 11E), the insulating films 102 and 107 are subjected to shaping. Specifically, a resist film 514 for exposing unnecessary portions of the insulating films 102 and 107 is formed, then, the exposed portions of the insulating films 102 and 107, which are exposed from the resist film 514, are removed by way of RIE. Thereafter, the resist film 514 is removed.

In a sixth step of the manufacturing method (see (A6), i.e., FIG. 1F), similar to the manufacturing method of the condenser microphone 1, the opening 120 corresponding to the opening 242 defined by the supports 240 is formed in the substrate 100.

In a seventh step of the manufacturing method (see (A7), i.e., FIG. 11G), similar to the manufacturing method of the condenser microphone 1, the insulating films 102 and 107 are partially removed by use of a resist film 516 for exposing the holes 32 of the back plate 230. An opening 122 corresponding to the opening 242 defined by the supports 240 is formed in the insulating film 102; and both of the insulating film 108 forming the interconnecting portions 224 and the insulating film 110 forming the supports 240 are formed by use of the insulating film 107. As a result, the air gap 250 is formed between the diaphragm 210 and the back plate 230; the interconnecting portions 224 and the supports 240 are formed. Thus, it is possible to completely produce the sensing portion of the condenser microphone 2.

(f) Second Variation

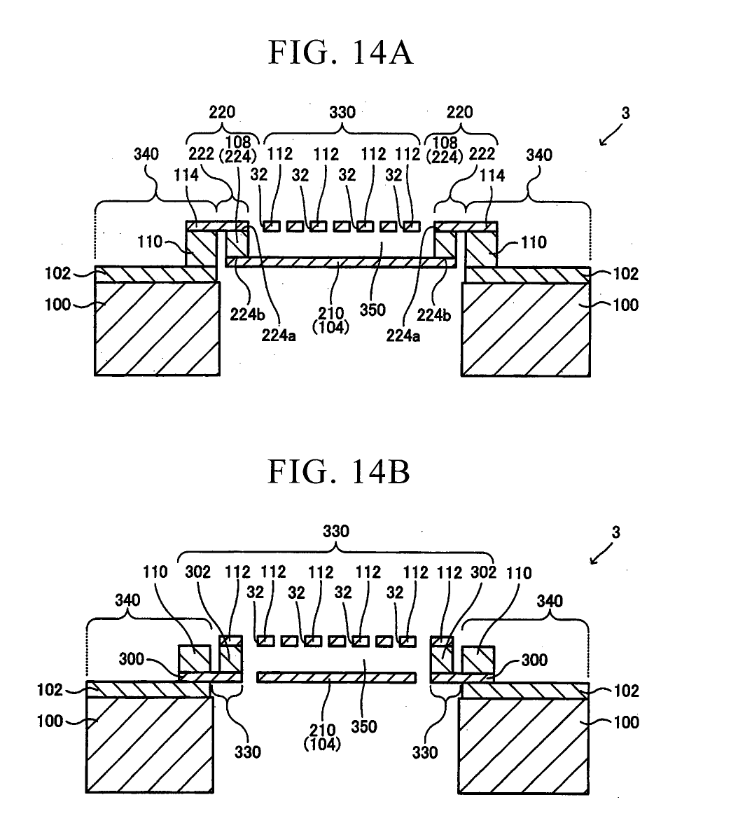

A second variation of the first embodiment of the present invention will be described with reference to FIG. 13 and FIGS. 14A and 14B, which show the constitution of a condenser microphone 3. FIG. 14A is a cross-sectional view taken along line A15-A15 in FIG. 13, and FIG. 14B is a cross-sectional view taken along line B15-B15 in FIG. 13. The detecting portion of the condenser microphone 3 is substantially identical to the detecting portion of the condenser microphone 1. Hence, the following description is given with respect to the constitution of the sensing portion of the condenser microphone 3 and its manufacturing method.

The diaphragm of the condenser microphone 3 is substantially identical to the diaphragm 210 of the condenser microphone 2.

A back plate 330 of the condenser microphone 3 is constituted of the prescribed portion of a conductive film 300, which is not fixed to the insulating film 102, as well as an insulating film 302 and the conductive film 112. The conductive film 112 is held between the conductive film 300 and the insulating film 302. Incidentally, the back plate 330 can be formed using an insulating film (whose shape is identical to the shape of the conductive film 300) instead of the conductive film 300.

Supports 340 are constituted of the prescribed portions of the conductive films 114 and 300, which are fixed to the insulating film 110, as well as the insulating films 110 and 102 and the substrate 100. The supports 340 support the diaphragm 210 and the back plate 330 in such a way that an air gap 350 is formed between the diaphragm 210 (serving as a fixed electrode) and the back plate 330 (serving as a moving electrode).

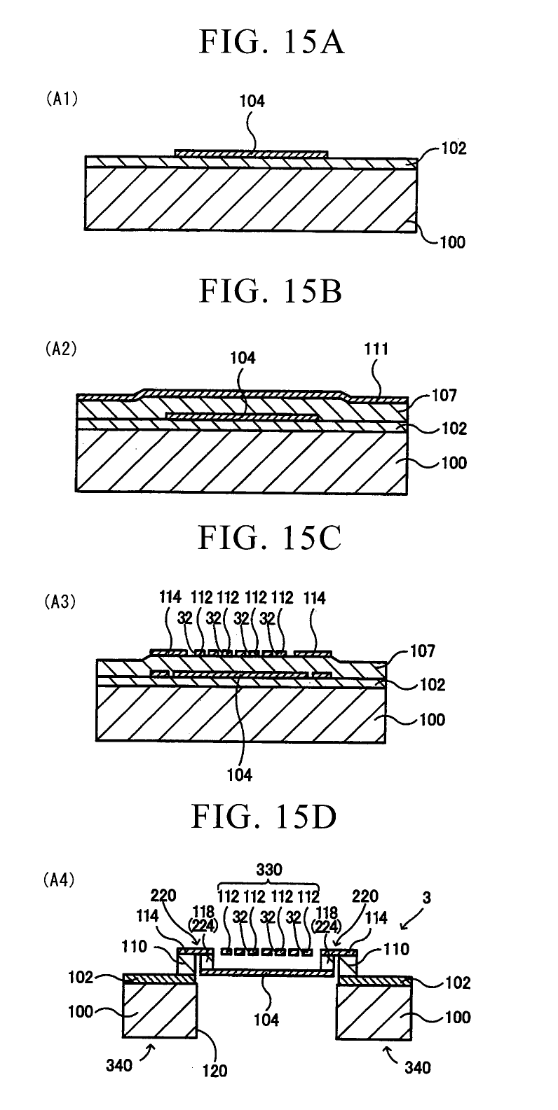

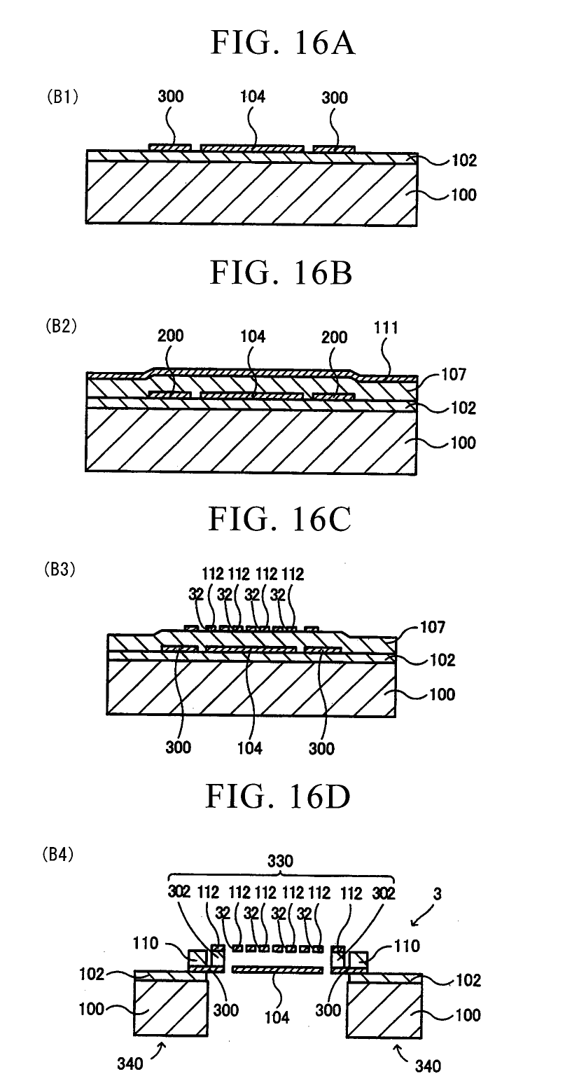

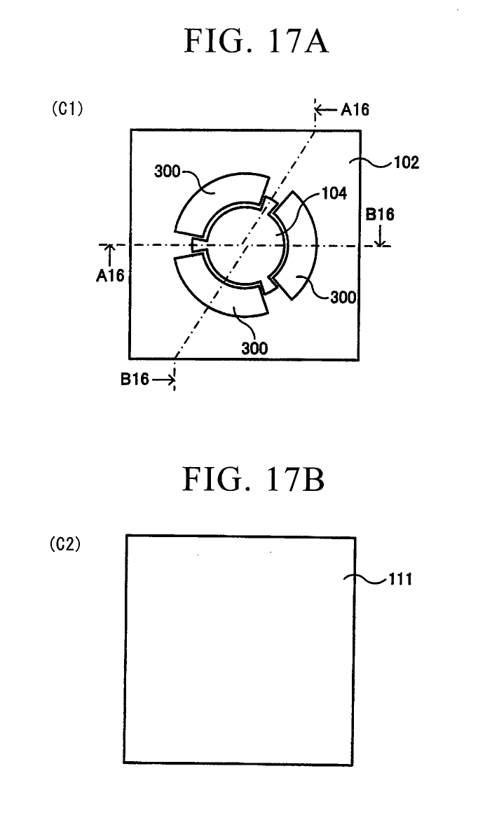

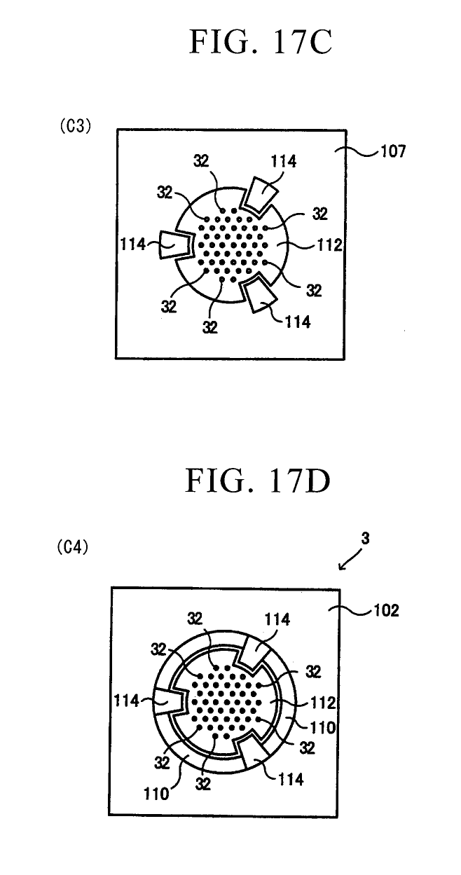

Next, a manufacturing method of the condenser microphone 3 will be described with reference to FIGS. 15A to 15D, FIGS. 16A to 16D, and FIGS. 17A to 17D, wherein FIGS. 15A to 15D (designated by reference symbols (A1) to (A4)) are cross-sectional views of FIGS. 17A to 17D (designated by reference symbols (C1) to (C4)) and are each taken along line A16-A16 in FIG. 17A; and FIGS. 16A to 16D (designated by reference symbols (B1) to (B4)) are cross-sectional views of FIGS. 17A to 17D and are each taken along line B16-B16 in FIG. 17A.

In a first step of the manufacturing method (see (A1), i.e., FIG. 15A), similar to the manufacturing method of the condenser microphone 1, the insulating film 102 is formed on the substrate 100, then, the conductive film 103 is formed on the insulating film 102. Next, the conductive film 103 is subjected to patterning (see (C1), i.e., FIG. 17A) so as to form the conductive film 104 forming the diaphragm 210 and the conductive film 300 forming the back plate 330 and the supports 340.

In a second step of the manufacturing method (see (A2), i.e., FIG. 15B), similar to the manufacturing method of the condenser microphone 1, the insulating film 107 whose thickness is larger than the thickness of the conductive films 104 and 300 is formed on the insulating film 102; then, the conductive film 111 is formed on the insulating film 107.

In a third step of the manufacturing method (see (C3), i.e., FIG. 17C), the conductive film 111 is subjected to patterning so as to form the conductive film 112 forming the back plate 330 and the supports 340 and the conductive film 114 forming the beam portions 222 and the supports 340.

In a fourth step of the manufacturing method (see (B4), i.e., FIG. 16D), similar to the manufacturing method of the condenser microphone 1, the opening 120 is formed in the substrate 100. Then, the insulating films 102 and 107 are partially removed. Thus, it is possible to produce the sensing portion of the condenser microphone 3.

### 2. Second Embodiment

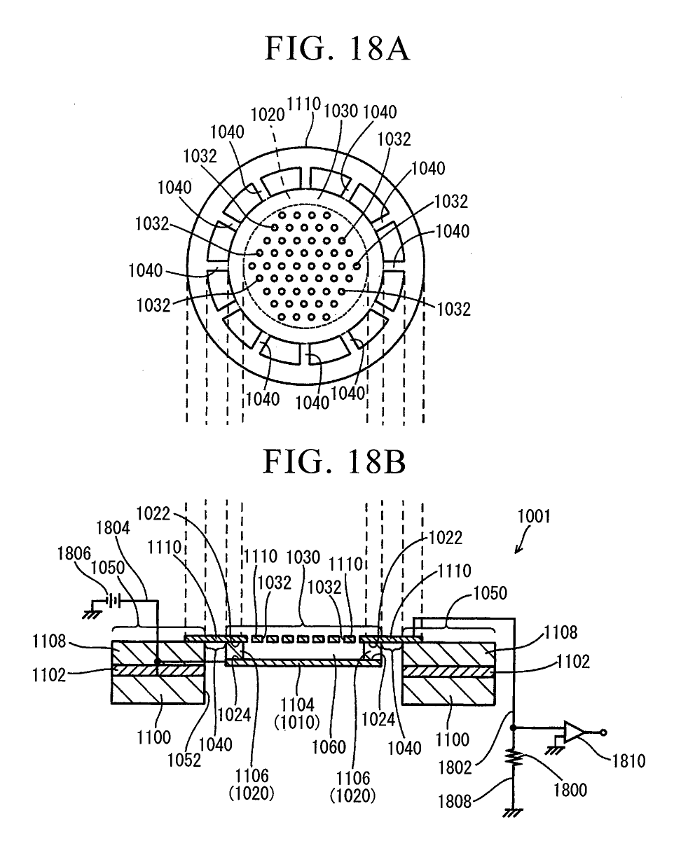

FIGS. 18A and 18B show a condenser microphone in accordance with a second embodiment of the present invention. FIG. 18A is a plan view showing a back plate and its associated parts. A condenser microphone 1001 is a silicon capacitor microphone, which is manufactured using the semiconductor manufacturing process. The condenser microphone 1001 includes a sensing portion (see mechanical parts shown in FIG. 18B) and a detecting portion (see the circuitry shown in FIG. 18B).

(a) Constitution of Sensing Portion

As shown in FIGS. 18A and 18B, the sensing portion of the condenser microphone 1001 is constituted of a diaphragm 1010, a spacer 1020, a back plate 1030, bridges 1040, and supports 1050.

The diaphragm 1010 is formed using a conductive film 1104, which functions as a moving electrode as well. Specifically, the diaphragm 1010 is a semiconductor film composed of polycrystal silicon (or polysilicon), in which the thickness thereof ranges from 0.2 μm to 2.0 μm. The diaphragm 1010 can be formed in a multilayered structure including an insulating film and a conductive film serving as a moving electrode.

The spacer 1020 is formed using an insulating film 1106, which is an oxide film composed of SiO₂, for example. The spacer 1020 has a ring shape in which the thickness thereof ranges from 2.0 μm to 6.0 μm (preferably, the thickness is set to 4.0 μm or so), and the width lying in a radial direction ranges from 5 μm to 20 μm. The spacer 1020 is fixed to the diaphragm 1010 and the back plate 1030 so as to form an air gap 1060 between the diaphragm 1010 and the back plate 1030.

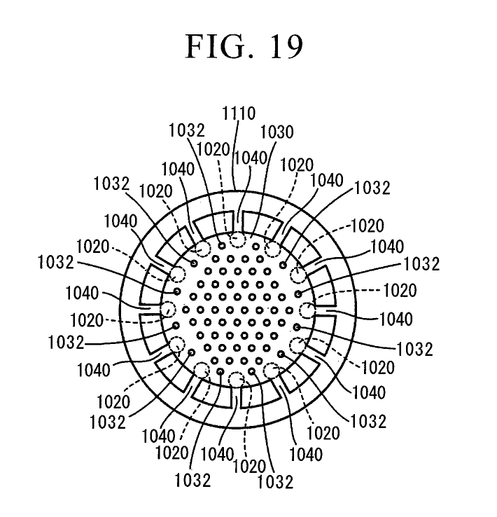

Specifically, a first end 1022 of the spacer 1020 is fixed to the near-end portion of the back plate 1030, and a second end 1024 of the spacer 1020 is fixed to the near-end portion of the diaphragm 1010. FIGS. 18A and 18B show that the circumferential periphery of the ring-shaped spacer 1020 is entirely fixed to the diaphragm 1010 and the back plate 1030. Instead, it is possible to use a C-shaped spacer. Alternatively, a plurality of spacers 1020 are arranged and positioned to surround the center portion of the diaphragm 1010 and the center portion of the back plate 1030 as shown in FIG. 19.

The back plate 1030 is constituted of a prescribed portion of a conductive film 1110, which is fixed to the insulating film 1106, and its inner portion. Specifically, the conductive film 1110 is a polysilicon film whose thickness ranges from 0.5 μm to 2.5 μm. The conductive film 1110 functions as a fixed electrode as well. A plurality of holes 1032 are formed in the back plate 1030 so as to allow sound waves (radiated from a sound source, not shown) to propagate therethrough. Incidentally, the back plate 1030 can be formed in a multilayered structure including an insulating film and a conductive film serving as a fixed electrode.

The bridges 1040 are each constituted of the prescribed portion of the conductive film 1110 that is not fixed to an insulating film 1108 and which lies externally of the prescribed portion forming the back plate 1030. The bridges 1040 are each formed in a band-like shape extending in a radial direction from the outer circumference of the back plate 1030.

The supports 1050 are each constituted of the prescribed portion of the conductive film 1110 that is fixed to the insulating film 1108, and the insulating film 1108 as well as an insulating film 1102 and a substrate 1100. The insulating films 1102 and 1108 are oxide films composed of SiO₂, for example. The substrate 1100 is a semiconductor substrate such as a monocrystal silicon substrate. An opening 1052 defined by the supports 1050 is formed to run through the substrate 1100 and the insulating films 1102 and 1108. A recess is formed by way of the interior surface of the opening 1052, the conductive film 1104, the insulating film 1106, and the conductive film 1110. The recess serves as a back cavity of the condenser microphone 1001.

As described above, the diaphragm 1010 and the back plate 1030 are interconnected together by means of the spacer 1020 so as to form a single structure constituted of the diaphragm 1010, the spacer 1020, and the back plate 1030. Due to residual stress remaining in the diaphragm 1010, the structure is inclined to be deformed. Specifically, when relatively high tensile stress remains in the diaphragm 1010, the structure constituted of the diaphragm 1010, the spacer 1020, and the back plate 1030 is inclined to be deformed such that the diaphragm 1010 is contracted in shape.

The rigidity of the band-shaped bridges 1040 is lower than the rigidity of the structure constituted of the diaphragm 1010, the spacer 1020, and the back plate 1030. For this reason, the bridges 1040 can absorb the displacement of the structure without disturbing the aforementioned deformation of the structure. That is, the bridges 1040 can absorb the residual stress of the diaphragm 1010 by way of the deformation thereof.

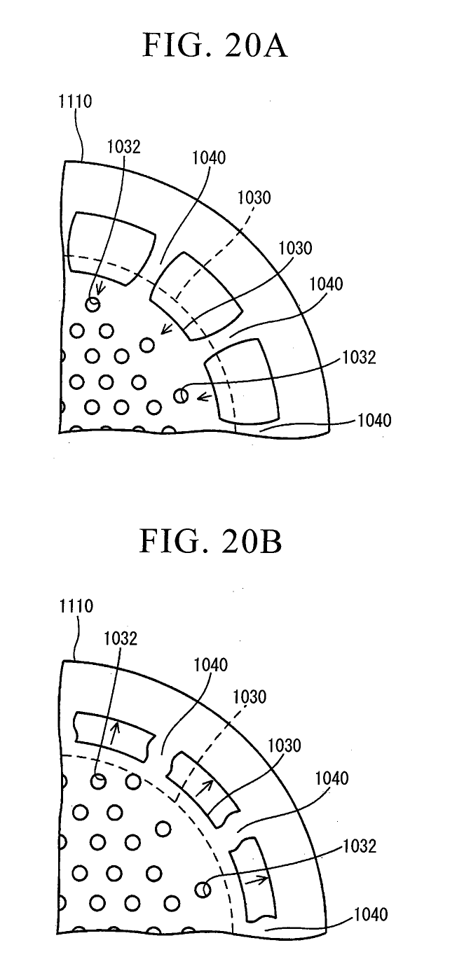

For example, as shown in FIG. 20A, when the structure constituted of the diaphragm 1010, the spacer 1020, and the back plate 1030 is contracted due to the tensile stress of the diaphragm 1010, the bridges 1040 are expanded so as to absorb the tensile stress of the diaphragm 1010. As shown in FIG. 20B, when the structure is expanded due to the compressive stress of the diaphragm 1010, the bridges 1040 are contracted so as to absorb the compressive stress of the diaphragm 1010. As described above, the bridges 1040 function to reduce the residual stress of the diaphragm 1010, whereby the diaphragm 1010 can vibrate with relatively large amplitude due to sound waves applied thereto.

In addition, it is possible to secure a desired rigidity with respect to the bridges 1040 due to the deformation thereof. Herein, the desired rigidity is defined such that the sensitivity of the condenser microphone 1001 will not be degraded irrespective of the deformation of the bridges 1040 due to sound waves. This is because, when the structure vibrates by way of the deformation of the bridges 1040 due to sound waves, the amplitude of vibration of the diaphragm 1010 due to sound waves may be reduced.

As long as the structure constituted of the diaphragm 1010, the spacer 1020, and the back plate 1030 realizes the deformation thereof in response to the residual stress of the diaphragm 1010, the details of designing of the structure such as the layered structure, shape, and materials are not necessarily limited to those described above.

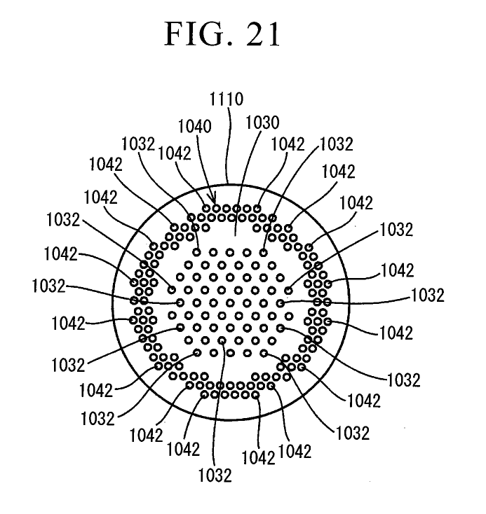

In addition, as long as the bridges 1040 realize the absorption of the deformation (or displacement) of the structure (constituted of the diaphragm 1010, the spacer 1020, and the back plate 1030) by way of the deformation thereof, they can be formed using any type of material, and they can be formed in any shape. For example, as shown in FIG. 21, it is possible to redesign the bridges 1040 whose rigidity is lower than the rigidity of the diaphragm 1010 by forming numerous holes 1042 in the prescribed area externally of the center portion of the conductive film 1110. Alternatively, the bridges 1040 can be positioned to be extended externally of the periphery of the diaphragm 1010.

In addition, the condenser microphone 1001 can be redesigned such that the diaphragm 1010 is positioned close to a sound source (not shown) in comparison with the back plate 1030, wherein sound waves are directly transmitted to the diaphragm 1010.

(b) Constitution of Detecting Portion

As shown in FIG. 18B, the diaphragm 1010 is connected to a bias voltage circuit 1806, and the back plate 1030 is grounded via a resistor 1800. The back plate 1030 is connected to an input terminal of a pre-amplifier 1810 as well.

Specifically, a lead 1804 connected to the bias voltage circuit 1806 is connected to the conductive film 1104 and the substrate 1100, which are used to form the diaphragm 1010. A lead 1802, which is connected to a first end of the resistor 1800, is connected to the conductive film 1110 forming the back plate 1030; and a lead 1808, which is grounded to a printed-circuit board (not shown) for mounting the condenser microphone 1001, is connected to a second end of the resistor 1800. The resistor 1800 has relatively high resistance, which preferably has giga-order ohms. The lead 1802 connecting the back plate 1030 and the resistor 1800 together is connected to the input terminal of the pre-amplifier 1810 as well.

(c) Operation of Condenser Microphone

When sound waves propagate through the holes 1032 of the back plate 1030 and are then transmitted to the diaphragm 1010, the diaphragm 1010 vibrates due to sound waves applied thereto. The vibration of the diaphragm 1010 varies the distance between the diaphragm 1010 and the back plate 1030, so that electrostatic capacitance between the diaphragm 1010 and the back plate 1030 varies.

Since the diaphragm 1010 is connected to the resistor 1800 having relatively high resistance, electric charges accumulated between the diaphragm 1010 and the back plate 1030 do not substantially flow through the resistor 1800 even when the electrostatic capacitance varies due to the vibration of the diaphragm 1010. That is, it is presumed that electric charges accumulated between the diaphragm 1010 and the back plate 1030 do not substantially change. This makes it possible to extract variations of electrostatic capacitance as variations of voltage applied between the diaphragm 1010 and the back plate 1030.

In the condenser microphone 1001, variations of voltage, which occur in the diaphragm 1010 based on the ground, are amplified by means of the pre-amplifier 1810, whereby it is possible to produce electric signals based on very small variations of electrostatic capacitance. That is, the condenser microphone 1001 converts variations of sound pressure applied to the diaphragm 1010 into variations of electrostatic capacitance, which are then converted into variations of voltage, based on which it is possible to produce electric signals in response to variations of sound pressure.

As described above, residual stress remaining in the diaphragm 1010 is reduced by way of the deformation of the bridges 1040. Hence, the diaphragm 1010 can vibrate with relatively large amplitude due to sound waves. This increases variations of electrostatic capacitance. Hence, the condenser microphone 1001 can produce electric signals having relatively large amplitude based on variations of sound pressure. In other words, it is possible to increase the sensitivity of the condenser microphone 1001 by way of the deformation of the bridges 1040, which absorbs the residual stress of the diaphragm 1010.

(d) Manufacturing Method

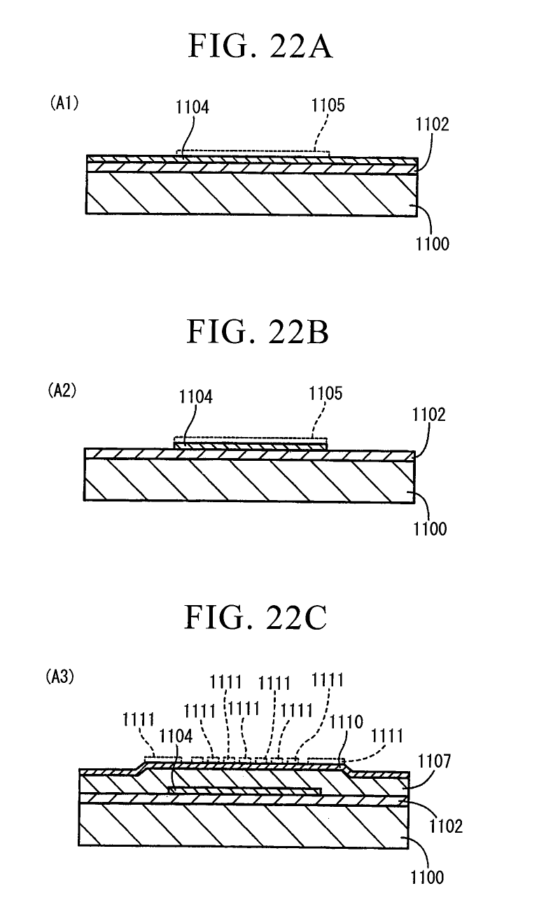

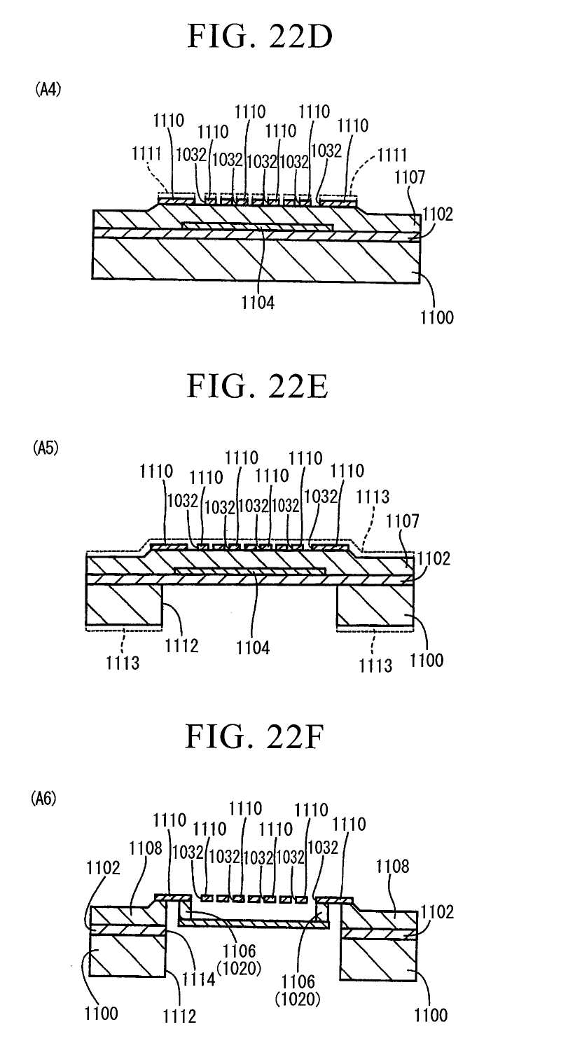

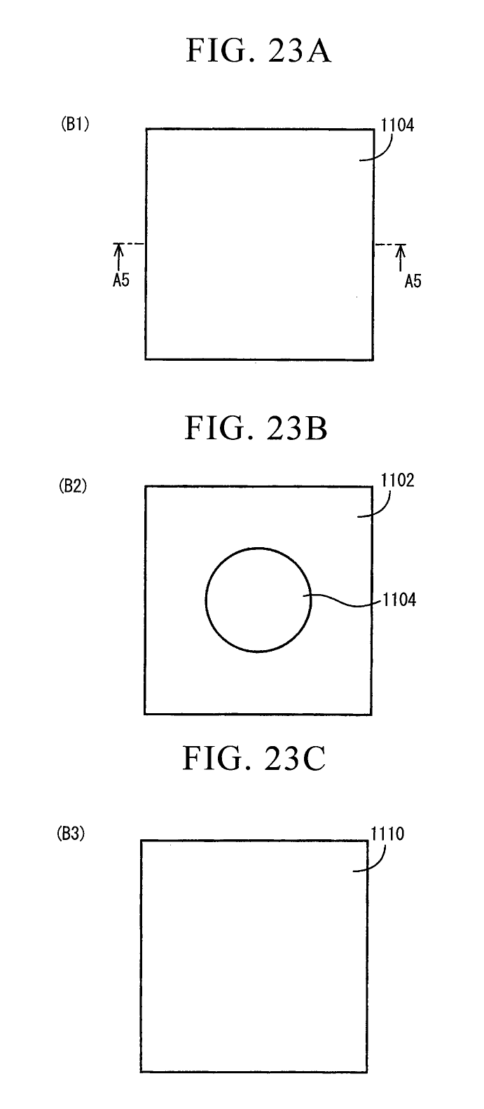

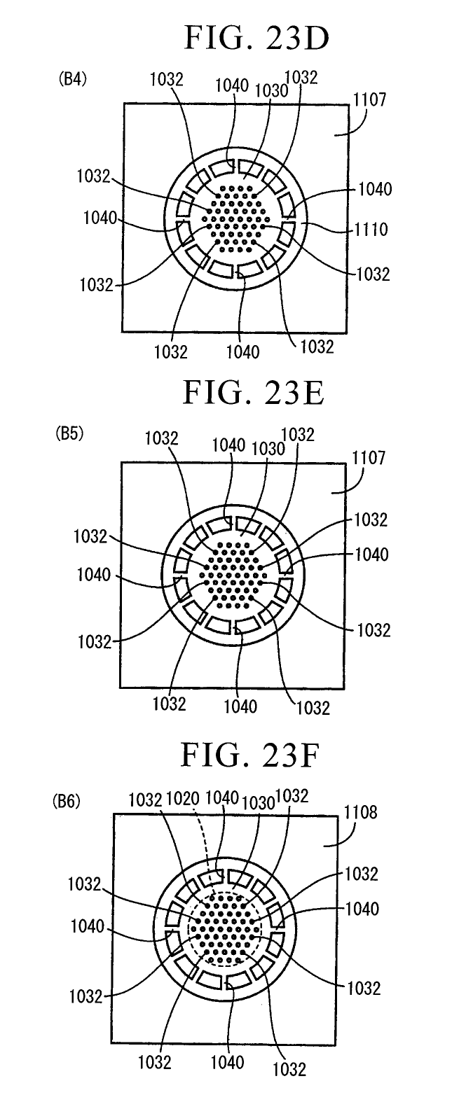

Next, a manufacturing method of the condenser microphone 1001 will be described in detail with reference to FIGS. 22A to 22F and FIGS. 23A to 23F, wherein FIGS. 22A to 22F (designed by (A1) to (A6)) are cross-sectional views of FIGS. 23A to 23F (designated by (B1) to (B6)) and are each taken along line A5-A5 (see FIG. 23A).

In a first step of the manufacturing method (see (A1), i.e., FIG. 22A), an insulating film 1102 is formed on a substrate 1100. Specifically, an insulating material is deposited on the surface of the substrate 1100 by way of CVD (Chemical Vapor Deposition) so as to form the insulating film 1102 on the substrate 1100. This process can be omitted by using an SOI substrate.

Next, a conductive film 1104 is formed on the insulating film 1102 by way of CVD.

In a second step of the manufacturing method (see (B2), i.e., FIG. 23B), the conductive film is subjected to patterning so as to form the diaphragm 1010. Specifically, a resist film 1105, which covers the prescribed portion of the conductive film 1104 forming the diaphragm 1100 and which exposes unnecessary portions of the conductive film 1104, is formed on the conductive film 1104 by way of lithography. More specifically, a resist is applied onto the conductive film 1104 so as to form a resist film, and the resist film is subjected to exposure and development by use of a mask having a prescribed shape. Thus, the resist film 1105 is formed on the conductive film 1104. Next, the exposed portion of the conductive film 1104, which is exposed from the resist film 1105, is subjected to etching such as RIE (Reactive Ion Etching), thus forming the diaphragm 1010. Thereafter, the resist film 1105 is removed.

In a third step of the manufacturing method (see (A3), i.e., FIG. 22C), an insulating film 1107 whose thickness is larger than the thickness of the conductive film 1104 is formed above the conductive film 1104 on the insulating film 1102 by way of CVD. In order to selectively remove the insulating films 1102 and 1107 from the conductive films 1104 and 1110 in the following process, the insulating films are each composed of a prescribed material whose etching ratio is higher than the etching ratio of the material of the conductive films. For example, when the conductive films are composed of polysilicon, the insulating films are composed of SiO₂.

In the process in which the insulating films are selectively removed from the conductive films, it is necessary to retain prescribed portions of the insulating films forming prescribed parts of the condenser microphone 1001 by partially removing the insulating films. For this reason, it is preferable that both of the insulating films 1102 and 1107 are composed of the same material, by which it is possible to set the same etching rate therefor. This makes it possible to easily control the amount of etching with respect to the insulating films.

Next, the conductive film 1110, which is a polysilicon film, is formed on the insulating film 1107 by way of CVD.

In a fourth step of the manufacturing method (see (B4), i.e., FIG. 23D), the conductive film is subjected to patterning so as to form the back plate 1030 and the bridges 1040. Specifically, similar to the patterning of the conductive film 1104, the patterning of the conductive film 1110 is performed by way of etching such as RIE, which is performed on the exposed portion of the conductive film 1110, which is exposed from the resist film 1111.

In a fifth step of the manufacturing method (see (A5), i.e., FIG. 22E), an opening 1112 corresponding to the opening 1052 defined by the supports 1050 is formed in the substrate 1100. Specifically, a resist film 1113 for exposing the prescribed portion of the substrate 1100, which is used for the formation of the opening 1112, is formed by way of lithography. Next, the exposed portion of the substrate 1100, which is exposed from the resist film 1113, is removed by way of Deep RIE, which is performed such that etching progresses toward the insulating film 1102 serving as an etching stopper layer, thus forming the opening 1112 in the substrate 1100. Thereafter, the resist film 1113 is removed.

In a sixth step of the manufacturing method (see (A6), i.e., FIG. 22F), the insulating films 1102 and 1107 are partially removed so as to form an opening 1114 corresponding to the opening 1052 defined by the supports 1050 is formed in the insulating film 1102. Then, the insulating film 1106 forming the spacer 1020 and the insulating film 1108 forming the supports 1050 are formed by use of the insulating film 1107. Specifically, the insulating films 1102 and 1107 are removed by way of wet etching. When the insulating films 1102 and 1107 are composed of SiO₂, it is possible to use hydrofluoric acid as an etching solution. The etching solution is infiltrated into the opening 1112 of the substrate 1100, the holes 1032 of the conductive film 1110, and gaps formed between the conductive film 1110 and the bridges 1040 so as to reach the insulating films 1102 and 1107, which are thus dissolved. This forms an air gap 1060 defined by the spacer 1020, the supports 1050, the diaphragm 1010, and the back plate 1030. This completes the formation of the sensing portion of the condenser microphone 1001.

The second embodiment can be further modified in a variety of ways, which will be described below.

(e) First Variation

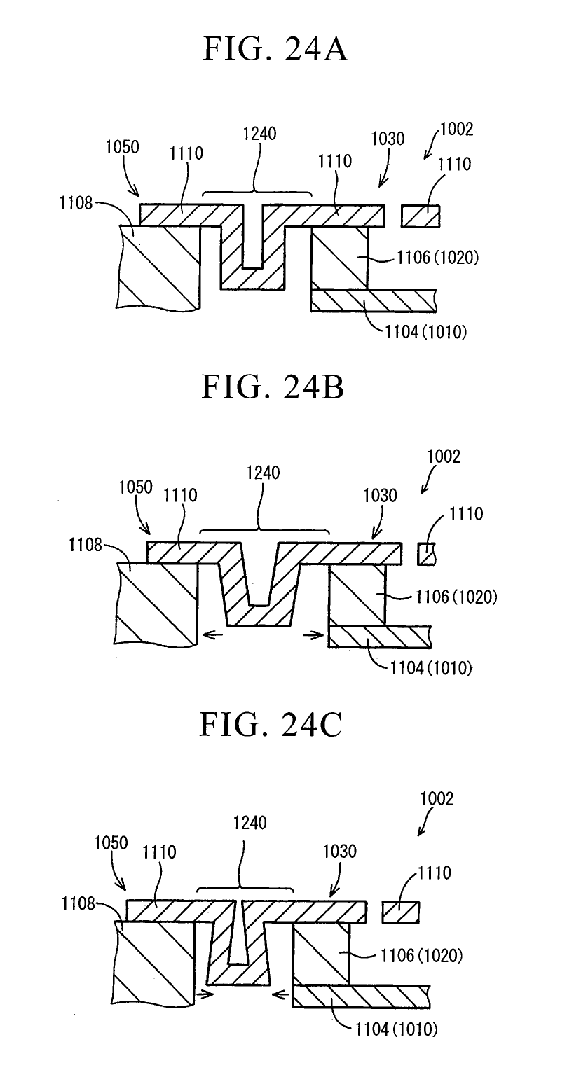

A first variation of the second embodiment will be described by way of a condenser microphone 1002, the constitution of which is basically identical to the constitution of the condenser microphone 1001 except for bridges included in the sensing portion, with reference to FIGS. 24A to 24C. The condenser microphone 1002 has bridges 1240 having bent portions, which are extended from the terminal end of the back plate 1030 toward the supports 1050 (see FIG. 24A). Due to the deformation of the bent portions of the bridges 1240, it is possible to absorb residual stress of the diaphragm (see FIGS. 24B and 24C).

(f) Second Variation

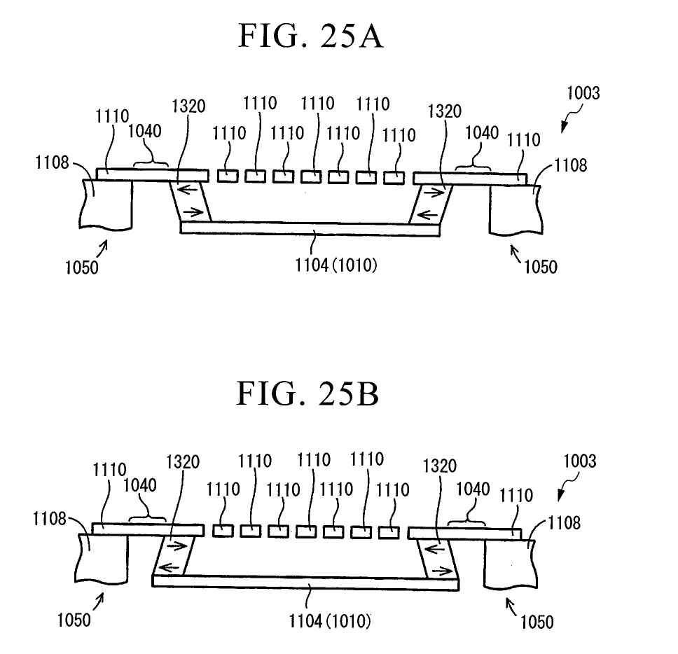

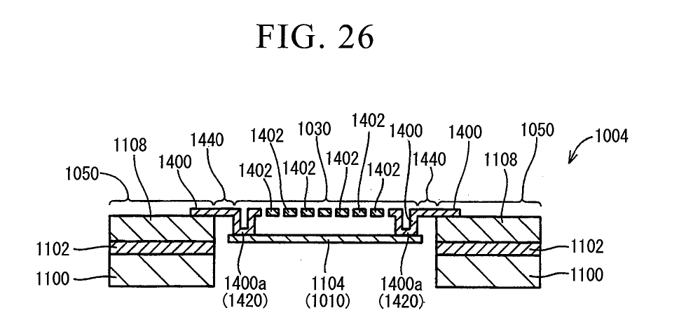

A second variation of the second embodiment will be described by way of a condenser microphone 1003, the constitution of which is basically identical to the constitution of the condenser microphone 1001 except for a spacer included in the sensing portion, with reference to FIGS. 25A and 25B. The condenser microphone 1003 has a spacer 1320, which is subjected to shearing deformation due to residual stress of the diaphragm 1010. That is, due to the shearing deformation of the spacer 1320, it is possible to absorb and reduce the residual stress of the diaphragm 1010 irrespective of the rigidity of the bridges 1040, which may be higher than the rigidity of the diaphragm 1010 and the rigidity of the back plate 1030. Incidentally, the back plate 1030 and the bridges 1040 are combined together so as to form the plate.

(g) Third Variation

A third variation of the second embodiment will be described by way of a condenser microphone 1004, the constitution of which is basically identical to the constitution of the condenser microphone 1001 except for a spacer included in the sensing portion. The condenser microphone 1004 has a spacer 1420 having projections 1400a. Similar to the conductive film 1110 forming the back plate 1030 of the condenser microphone 1001, an insulating film 1400 is bridged across the supports 1050. The projections 1400a, which are formed by means of the insulating film 1400, project toward the conductive film 1104 forming the diaphragm 1010, wherein top portions thereof are fixed to the conductive film 1104. The spacer 1420 can be designed similar to the spacer 1320 of the condenser microphone 1003. That is, the spacer 1420 can be subjected to shearing deformation due to residual stress of the diaphragm 1010.

(h) Fourth Variation

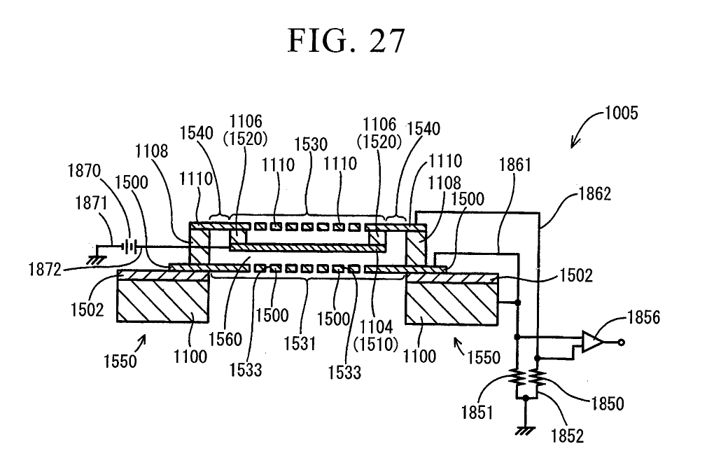

A fourth variation of the second embodiment will be described with reference to FIG. 27, which shows the constitution of a condenser microphone 1005. The condenser microphone 1005 has a sensing portion (whose mechanical parts are shown in FIG. 27) and a detecting portion (see this circuitry shown in FIG. 27).

The condenser microphone 1005 is constituted of a diaphragm 1510, a spacer 1520, bridges 1540, supports 1550, a first back plate 1530, and a second back plate 1531. Herein, the diaphragm 1510, the spacer 1520, the first back plate 1530, and the bridges 1540 are substantially identical to the diaphragm 1010, the spacer 1020, the back plate 1030, and the bridges 1040 included in the condenser microphone 1001.

The second back plate 1531 is positioned opposite to the first back plate 1530 with respect to the diaphragm 1510 and is directly supported by the supports 1550. Specifically, the second back plate 1531 is formed using the prescribed portion of a conductive film 1500 that is not fixed to an insulating film 1502, wherein the conductive film 1500 is bridged across the supports 1550. The conductive film 1500 functions as a fixed electrode as well. A plurality of holes 1533 are formed in the second back plate 1531 so as to establish communication between an air gap 1560, which is formed between the diaphragm 1510 and the second back plate 1531, and a back cavity of the condenser microphone 1005. Incidentally, the second back plate 1531 can be formed in a multilayered structure including an insulating film and a conductive film serving as a fixed electrode.

In the detecting portion of the condenser microphone 1005, a bias voltage is applied to the diaphragm 1510. The first back plate 1530 is grounded via a resistor 1850, and the second back plate 1531 is grounded via a resistor 1851. In addition, the first back plate 1530 is connected to a first input terminal of a pre-amplifier 1856, and the second back plate 1531 is connected to a second input terminal of the pre-amplifier 1856.

Specifically, a lead 1872, which is connected to a bias voltage circuit 1870, is connected to the conductive film 1104 forming the diaphragm 1510. A lead 1862, which is connected to the resistor 1850 and the first input terminal of the pre-amplifier 1856, is connected to the conductive film 1110 forming the first back plate 1530. A lead 1861, which is connected to the resistor 1851 and the second input terminal of the pre-amplifier 1856, is connected to the conductive film 1500 forming the second back plate 1531. The lead 1861, which connects the second back plate 1531 and the resistor 1851 together, is connected to the substrate 1100 as well.

Both of the resistors 1850 and 1851 are connected to a lead 1852, which is grounded via a board (not shown) for mounting the condenser microphone 1005. Similar to the resistor 1800 included in the detecting portion of the condenser microphone 1001 (see FIG. 18B), the resistors 1850 and 1851 have a relatively high resistance.

Next, the operation of the condenser microphone 1005 will be described. Due to the vibration of the diaphragm 1510, which vibrates in the space between the first back plate 1530 and the second back plate 1531, when a first electrostatic capacitance formed between the diaphragm 1510 and the first back plate 1530 increases, a second electrostatic capacitance formed between the diaphragm 1510 and the second back plate 1531 decreases. When the first electrostatic capacitance decreases, the second electrostatic capacitance increases. In other words, a first voltage applied between the diaphragm 1510 and the first back plate 1530 varies complementarily with a second voltage applied between the diaphragm 1510 and the second back plate 1531 due to sound waves applied to the diaphragm 1510. Such complementary variations of the first and second voltages are subjected to differential amplification by means of the pre-amplifier 1856, which thus produce electric signals in response to the sum of variations of the first and second electrostatic capacitances. Thus, it is possible to increase the sensitivity of the condenser microphone 1005.

(i) Fifth Variation

A fifth variation of the second embodiment will be described with reference to

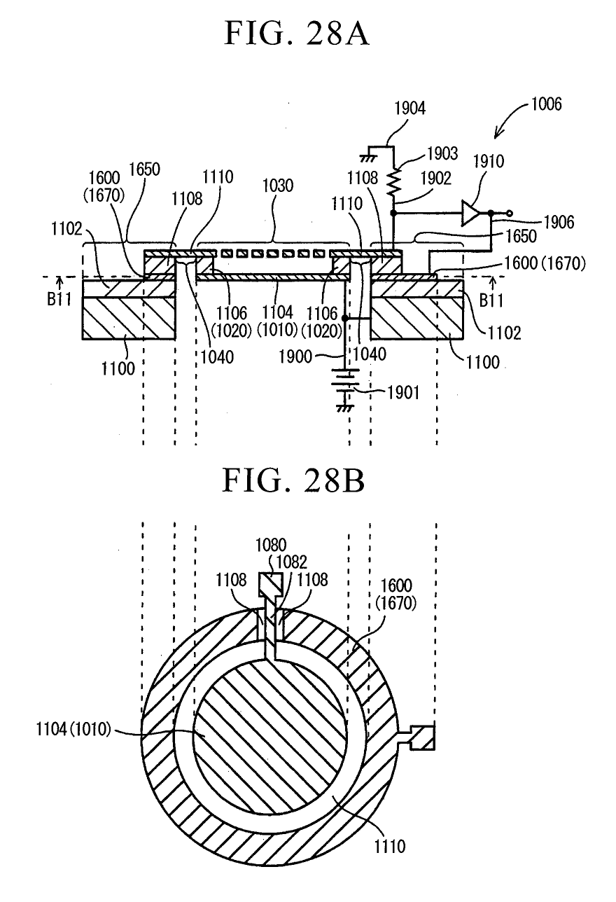

FIGS. 28A and 28B, which show the constitution of a condenser microphone 1006, wherein FIG. 28B is a horizontal sectional view taken along line B11-B11 in FIG. 28A. The condenser microphone 1006 has a sensing portion (whose mechanical parts are shown in FIG. 28A) and a detecting portion (see the circuitry shown in FIG. 28A).

The constitution of the sensing portion of the condenser microphone 1006 is basically identical to the constitution of the sensing portion of the condenser microphone 1001 except for supports 1650. The supports 1650 are constituted of the substrate 1100, the insulating film 1102, a conductive film 1600, the insulating film 1108, and the prescribed portion of the conductive film 1110, which is fixed to the insulating film 1108. The conductive film 1600 is formed between the prescribed portion of the conductive film 1110, which is fixed to the insulating film 1108, and the substrate 1100.

Specifically, as shown in FIG. 28B, the conductive film 1600 has a C-shape surrounding the conductive film 1104 forming the diaphragm 1010, so that a prescribed part of the conductive film 1104 is elongated through the cutout area of the conductive film 1600. The elongated portion of the conductive film 1104, which is elongated through the cutout area of the conductive film 1600, forms a lead (or a conductor) 1082 that establishes an electric connection between the diaphragm 1010 and an electrode 1080, which is used for applying a bias voltage to the diaphragm 1010. The conductive film 1600 is biased substantially at the same potential with the conductive film 1110 or the substrate 1100, thus functioning as a guard electrode 1670 for reducing the parasitic capacity of the condenser microphone 1006. Details will be described later.

It is preferable that both of the conductive film 1600 forming the guard electrode 1670 and the conductive film 1104 forming the diaphragm 1010 be formed using the same film configuration. Specifically, similar to the manufacturing method of the condenser microphone 1001, the insulating film 1102 is formed on the substrate 1100; a conductive film is formed on the insulating film 1102; and then, the conductive film is subjected to patterning so as to form the conductive films 1600 and 1104. When the guard electrode 1670 is formed using the same film configuration of the diaphragm 1010, it is possible to simplify the manufacture of the condenser microphone 1006.

Referring to the detecting portion of the condenser microphone 1006, both of the diaphragm 1010 and the substrate 1100 are connected to a bias voltage circuit 1901. The back plate 1030 is grounded via a resistor 1903 and is also connected to an input terminal of a pre-amplifier 1910. That is the detecting portion of the condenser microphone 1006 is designed such that the pre-amplifier 1910 produces electric signals based on the voltage applied between the back plate 1030 and the ground. The output voltage of the detecting portion is applied to the guard electrode 1670.

Specifically, a lead 1900, which is connected to the bias voltage circuit 1901, is connected to the conductive film 1104 forming the diaphragm 1010 and the substrate 1100. A lead 1902, which is connected to a first end of the resistor 1903, is connected to the conductive film 1110 forming the back plate 1030; and a lead 1904, which is grounded on a board for mounting the condenser microphone 1006, is connected to a second end of the resistor 1903. The lead 1902 for connecting the back plate 1030 and the resistor 1903 together is connected to the input terminal of the pre-amplifier 1910 as well. The pre-amplifier 1910 forms a voltage-follower circuit. A lead 1906, which is connected to the output terminal of the pre-amplifier 1910, is connected to the conductive film 1600 forming the guard electrode 1670.

When both of the conductive film 1110 forming the back plate 1030 and the guard electrode 1670 are placed substantially at the same potential, it is possible to eliminate the parasitic capacity between the conductive film 1110 and the guard electrode 1670. Hence, it is possible to reduce parasitic capacity between the conductive film 1110 and the substrate 1100. Thus, it is possible to increase the sensitivity of the condenser microphone 1006.

(j) Sixth Variation

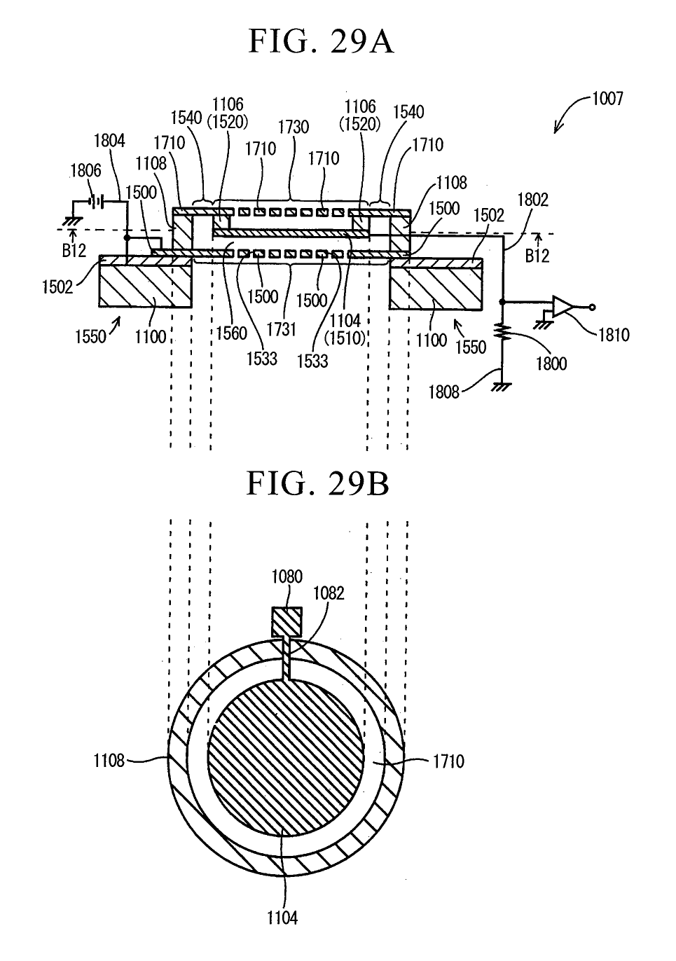

A sixth variation of the second embodiment will be described with reference to FIGS. 29A and 29B, wherein FIG. 29B is a horizontal sectional view taken along line B12-B12 in FIG. 29A.

The constitution of the sensing portion of a condenser microphone 1007 is basically identical to the constitution of the sensing portion of the condenser microphone 1005 except that a first back plate 1730 does not have a fixed electrode. The first back plate 1730 is formed using an insulating film 1710, which is bridged across supports 1550. A second back plate 1731 is positioned opposite to the first back plate 1730 with respect to the diaphragm 1510. Incidentally, the first back plate 1730 can be formed in a multilayered structure.

Referring to the circuitry shown in FIG. 29A, the diaphragm 1510 is grounded via the resistor 1800, and the second back plate 1731 is connected to the bias voltage circuit 1806. The diaphragm 1510 is connected to the input terminal of the pre-amplifier 1810 as well.

Specifically, the lead 1802, which is connected to the first end of the resistor 1800, is connected to the conductive film 1104 forming the diaphragm 1510. In addition, the lead 1808, which is grounded onto a board (not shown) for mounting the condenser microphone 1007, is connected to the second end of the resistor 1800. The lead 1802, which connects the diaphragm 1510 and the resistor 1800 together, is connected to the input terminal of the pre-amplifier 1810 as well. The lead 1804, which is connected to the bias voltage circuit 1806, is connected between the conductive film 1500 forming the second back plate 1731 and the substrate 1100.

When the diaphragm 1510 vibrates due to sound waves, electrostatic capacitance formed between the diaphragm 1510 and the second back plate 1731 varies. In the condenser microphone 1007, the pre-amplifier 1810 amplifies variations of voltage between the diaphragm 1510 and the second back plate 1731.

### 3. Third Embodiment

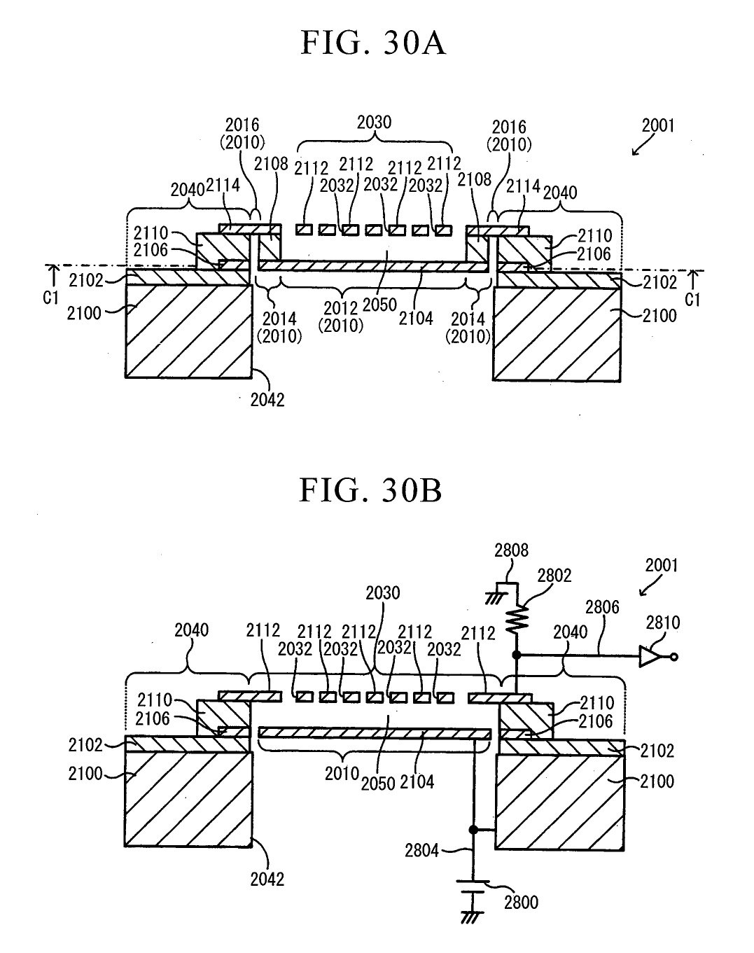

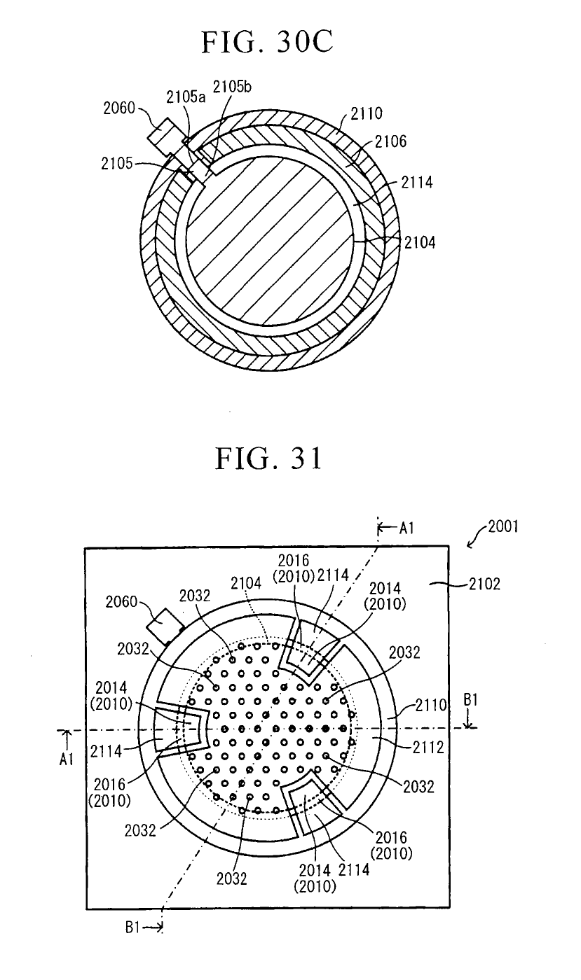

A condenser microphone 2001 according to a third embodiment of the present invention will be described with reference to FIGS. 30A to 30C and FIG. 31, wherein FIG. 30A is a cross-sectional view taken along line A1-A1 in FIG. 31; FIG. 30B is a cross-sectional view taken along line B1-B1 in FIG. 31; and FIG. 30C is a horizontal sectional view taken along line C1-C1 in FIG. 30A.

The condenser microphone 2001 is a silicon capacitor microphone, which is manufactured by way of the semiconductor manufacturing process. The condenser microphone 2001 has a sensing portion (whose mechanical parts are shown in FIGS. 30A and 30B) and a detecting portion (see the circuitry shown in FIG. 30A).

(a) Constitution of Sensing Portion

The sensing portion of the condenser microphone 2001 is constituted of a diaphragm 2010, a back plate 2030, and supports 2040. The diaphragm 2010 is formed using the prescribed portion of a conductive film 2114 that is not fixed to an insulating film 2110, an insulating film 2108, and a conductive film 2104. The diaphragm 2010 is bridged across the supports 2040 so as to form an air gap with the back plate 2030.

Both of the conductive films 2104 and 2114 are semiconductor films composed of polycrystal silicon (or polysilicon), for example, wherein the thickness of the conductive film 2114 is smaller than the thickness of the conductive film 2104. Specifically, the thickness of the conductive film 2114 ranges from 0.6 μm to 2.0 μm, and the thickness of the conductive film 2104 ranges from 0.5 μm to 1.5 μm, for example. The insulating film 2108 is an oxide film composed of SiO₂, for example. The insulating film 2108 whose thickness ranges from 2.0 μm to 6.0 μm (preferably, 4.0 μm) and whose width ranges from 10 μm to 20 μm is formed on the near-end portion of the conductive film 2104. Herein, the width of the insulating film 2108 lies in an extending direction of the diaphragm 2010, which is extended between the supports 2040. One end of the insulating film 2108 is fixed to the conductive film 2104, while the opposite end thereof is fixed to the conductive film 2114. The conductive film 2114 is elongated horizontally toward the surface of the insulating film 2110 forming the supports 2040.

A center portion 2012 of the diaphragm 2010 is formed using the prescribed portion of the conductive film 2104 that is not fixed to the insulating film 2108; an intermediate portion 2014 of the diaphragm 2010 is formed using the prescribed portion of the conductive film 2104 that is fixed to the insulating film 2108 and the prescribed portion of the conductive film 2114 that is fixed to the insulating film 2108 as well as the insulating film 2108; and a near-end portion 2016 of the diaphragm 2010 is formed using the prescribed portion of the conductive film 2114 that is not fixed to the insulating films 2108 and 2110.

The near-end portion 2016 of the conductive film 2010 is formed using the conductive film 2114 whose thickness is smaller than the thickness of the conductive film 2104 forming the center portion 2012. The intermediate portion 2014 of the diaphragm 2010 is formed using the conductive film 2104 forming the center portion 2012, the conductive film 2114 forming the near-end portion 2016, and the insulating film 2108, wherein the thickness of the intermediate portion 2014 is larger than the thickness of the center portion 2012 and the thickness of the near-end portion 2016, and wherein the rigidity of the intermediate portion 2014 is higher than the rigidity of the center portion 2012 and the rigidity of the near-end portion 2016.

The materials and shapes of the conductive films 2104 and 2114 forming the diaphragm 2010 can be appropriately determined to such an extent that the rigidity of the near-end portion 2016 becomes lower than the rigidity of the center portion 2012. For example, when the conductive film 2114 is formed using a prescribed material whose hardness is lower than the hardness of the conductive film 2104, both of the conductive films 2114 and 2104 can be formed with the same thickness, alternatively, the thickness of the conductive film 2114 can be increased to be larger than the thickness of the conductive film 2104.

The center portion 2012, the intermediate portion 2014, and the near-end portion 2016 of the diaphragm 2010 can be each formed using a single layer such that they differ from each other in thickness as long as the aforementioned relationships are established. Alternatively, the center portion 2012 and the near-end portion 2016 can be each formed in a multilayered structure, and the intermediate portion 2014 can be formed in a multilayered structure including two layers or four or more layers. Incidentally, the rigidity of the diaphragm 2010 can be controlled by way of ion implantation using impurities.

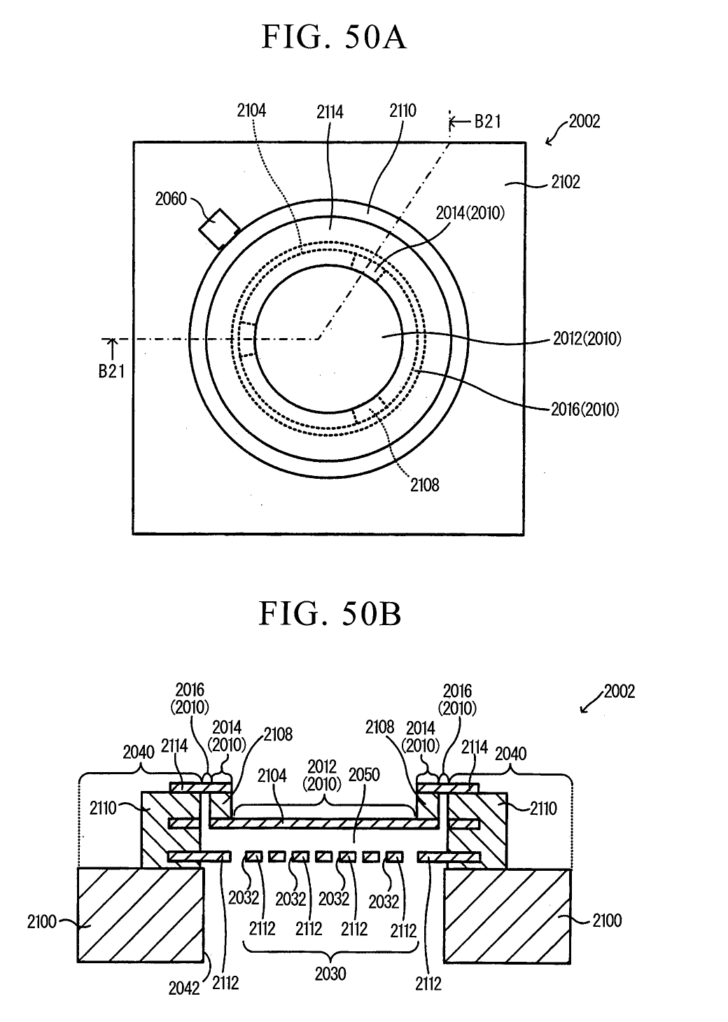

FIG. 31 shows an example of the diaphragm 2010, which is fixed at three points by means of the supports 2040, wherein three intermediate portions 2014 are formed and positioned to surround the center portion 2012 of the diaphragm 2010 with prescribed distances therebetween, and wherein the near-end portions 2016 are extended in a radial direction toward the supports 2040. Of course, the diaphragm 2010 can be designed such that it is fixed at three or more points. Alternatively, as shown in FIGS. 50A and 50B, all of the thin films forming the diaphragm 2010 are formed in layers different from the layers forming the back plate 2030, so that the circumferential periphery of the diaphragm 2010 is entirely fixed. Alternatively, the intermediate portion 2014 can be formed in a ring shape surrounding the center portion 2012, or it can be formed in a C-shape. The diaphragm 2010 having conductivity functions as a moving electrode, wherein the diaphragm 2010 can be constituted of a conductive film serving as a moving electrode and an insulating film whose shape is identical to the shape of the conductive film 2104.

The back plate 2030 is formed using the prescribed portion of a conductive film 2112 that is not fixed to the insulating film 2110. The conductive film is a semiconductor film composed of polysilicon, for example. A plurality of holes 2032 are formed in the back plate 2030 (see FIG. 31). Sound waves radiated from a sound source (not shown) propagate through the holes 2032 of the back plate 2030 and are then transmitted to the diaphragm 2010. The back plate 2030 having a conductivity functions as a fixed electrode, wherein the back plate 2030 can be formed using a conductive film serving as a fixed electrode and an insulating film whose shape is identical to the shape of the conductive film 2112. The holes 2032 are not necessarily formed in a circular shape. Hence, they can be formed in other shapes.

The supports 2040 are formed using the prescribed portion of the conductive film 2112 that is fixed to the insulating film 2110 and the prescribed portion of the conductive film 2114 that is fixed to the insulating film 2110 as well as the insulating film 2110, a conductive film 2106, an insulating film 2102, and a substrate 2100. The insulating films 2102 and 2110 are oxide films composed of SiO₂; the conductive film 2106 is a semiconductor film composed of polysilicon; and the substrate 2100 is a monocrystal silicon substrate, for example.

As shown in FIG. 30C, the substrate 2100 is interconnected with a bias voltage circuit 2800 (serving as the detecting portion, see FIG. 30B), an electrode 2060 for establishing connection with the diaphragm 2010, and a lead 2105a of an electrode extension portion 2105. The electrode extension portion 2105 is formed using the conductive film 2104 so as to connect the electrode 2060 and the diaphragm 2010 together. Specifically, the electrode extension portion 2105 is constituted of the lead 2105a, which is extended from the electrode 2060 to the diaphragm 2010, and a bridge 2105b, which is bridged across the support 2040 and the diaphragm 2010. An opening 2042 is defined by the supports 2040 so as to run through the substrate 2100 and the insulating film 2102. The opening 2042 forms a back cavity of the condenser microphone 2001.

It is possible to redesign the condenser microphone 2001 in such a way that, compared with the back plate 2030, the diaphragm 2010 is positioned close to a sound source (not shown), thus allowing sound waves to be directly transmitted to the diaphragm 2010. In this case, the holes 2032 of the back plate 2030 function as passages for establishing communication between the back cavity and an air gap 2050 formed between the diaphragm 2010 and the back plate 2030.

(b) Constitution of Detecting Portion

As shown in FIG. 30B, the diaphragm 2010 is connected to a bias voltage circuit 2800, and the back plate 2030 is grounded via a resistor 2802 and is also connected to a pre-amplifier 2810. The detecting portion of the condenser microphone 2001 produces electric signals based on the voltage of the back plate 2030 (which is measured based on the ground) by means of the pre-amplifier 2810.

Specifically, a lead 2804, which is connected to the bias voltage circuit 2800, is connected to the conductive film 2104 and the substrate 2100. A lead 2806, which is connected to a first end of the resistor 2802, is connected to the conductive film 2112 forming the back plate 2030; and a lead 2808, which is connected to a second end of the resistor 2802, is grounded onto a board (not shown) for mounting the condenser microphone 2001. The resistor 2802 has relatively high resistance. It is preferable that the resistor 2802 have giga-order ohms. The lead 2806 for connecting the back plate 2030 and the resistor 2802 together is connected to the input terminal of the pre-amplifier 2810 as well. It is preferable that the pre-amplifier 2810 have relatively high input impedance.

(c) Operation of Condenser Microphone

When sound waves propagate through the holes 2032 of the back plate 2030 and are then transmitted to the diaphragm 2010, the diaphragm 2010 vibrates due to sound waves applied thereto. Due to the vibration of the diaphragm 2010, the distance between the back plate 2030 and the diaphragm 2010 varies so that electrostatic capacitance formed between the diaphragm 2010 and the back plate 2030 varies correspondingly.

Since the back plate 2030 is connected to the resistor 2802 having relatively high resistance, electric charges accumulated between the diaphragm 2010 and the back plate 2030 do not substantially flow through the resistor 2802 even when the electrostatic capacitance varies due to the vibration of the diaphragm 2010. That is, it is presumed that accumulated electric charges do not substantially vary. Thus, variations of electrostatic capacitance can be translated into variations of the voltage applied between the back plate 2030 and the ground.

As described above, the condenser microphone 2001 can produce electric signals based on very small variations of electrostatic capacitance. That is, variations of sound pressure applied to the diaphragm 2010 are converted into variations of electrostatic capacitance, which are then converted into variations of voltage, based on which the condenser microphone 2001 produces electric signals based on variations of sound pressure.

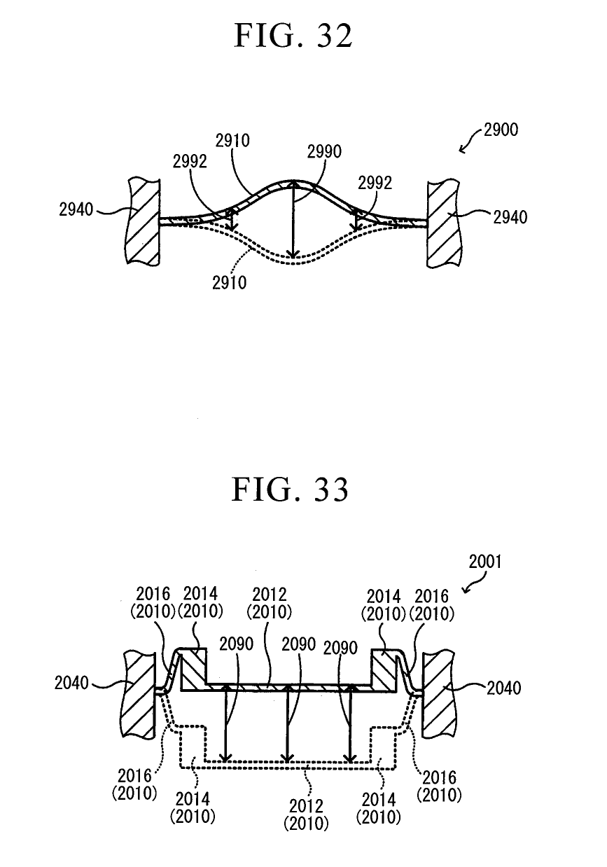

FIG. 32 shows a conventionally-known condenser microphone 2900 including a diaphragm 2910 having uniformly distributed rigidity. Herein, the diaphragm 2910 vibrates in such a manner that only the center portion thereof is subjected to maximum displacement (see an arrow 2990), wherein the displacement of the diaphragm 2910 due to its vibration becomes small toward the outer periphery fixed to supports 2940 (see arrows 2992). This reduces the sensitivity of the condenser microphone 2900.

The sensitivity of the condenser microphone 2900 may be increased by increasing the maximum displacement of the diaphragm 2910 within the distance between the diaphragm 2910 and a back plate (not shown). In this case, however, a pull-in phenomenon may likely occur in such a way that, due to electrostatic attraction, the diaphragm 2910 is attracted to the back plate when the diaphragm 2910 moves close to the back plate.

Next, the operation of the condenser microphone 2001 will be described with reference to FIG. 33.

As described above, the rigidity of the near-end portion 2016 of the diaphragm 2010 is lower than the rigidity of the center portion 2012 and the rigidity of the intermediate portion 2014. Hence, the diaphragm 2010 vibrates due to sound waves in such a way that the near-end portion 2016 is deformed. In addition, the rigidity of the intermediate portion 2014 is higher than the rigidity of the center portion 2012 and the rigidity of the near-end portion 2016. Hence, the center portion 2012 is not deformed irrespective of the deformation of the near-end portion 2016.

That is, the diaphragm 2010 vibrates such that the near-end portion 2016 is deformed without substantially causing deformation of the center portion 2012. In other words, the condenser microphone 2001 guarantees that the center portion 2012 of the diaphragm 2010 can vibrate with maximum displacement (see arrows 2090 in FIG. 33). Hence, compared with the conventionally-known condenser microphone (see FIG. 32) including the diaphragm 2910 having uniformly distributed rigidity (see FIG. 32), it is possible to increase variable capacity formed between the diaphragm 2010 and the back plate 2030. Hence, it is possible to increase the sensitivity of the condenser microphone 2001.

(d) Manufacturing Method

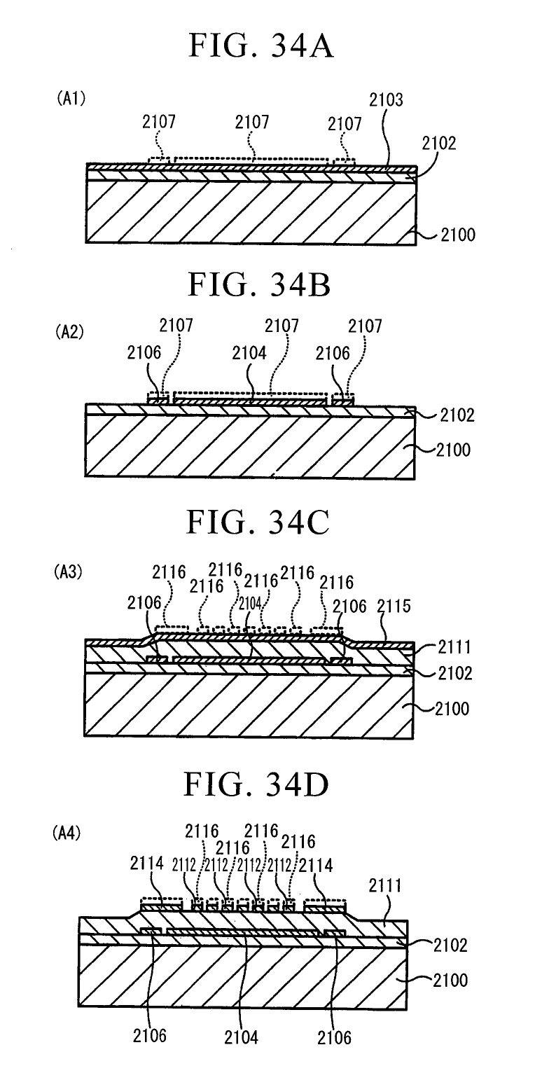

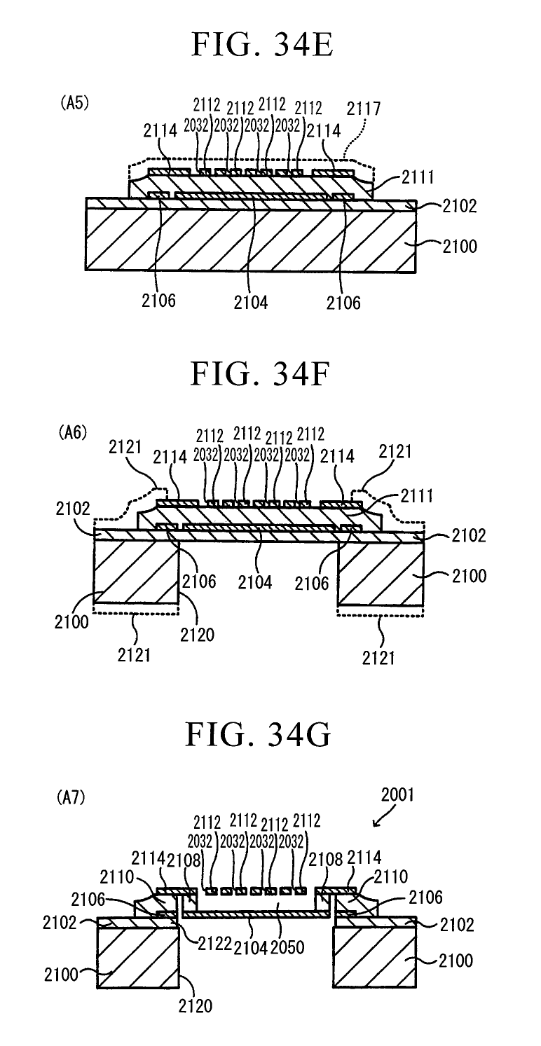

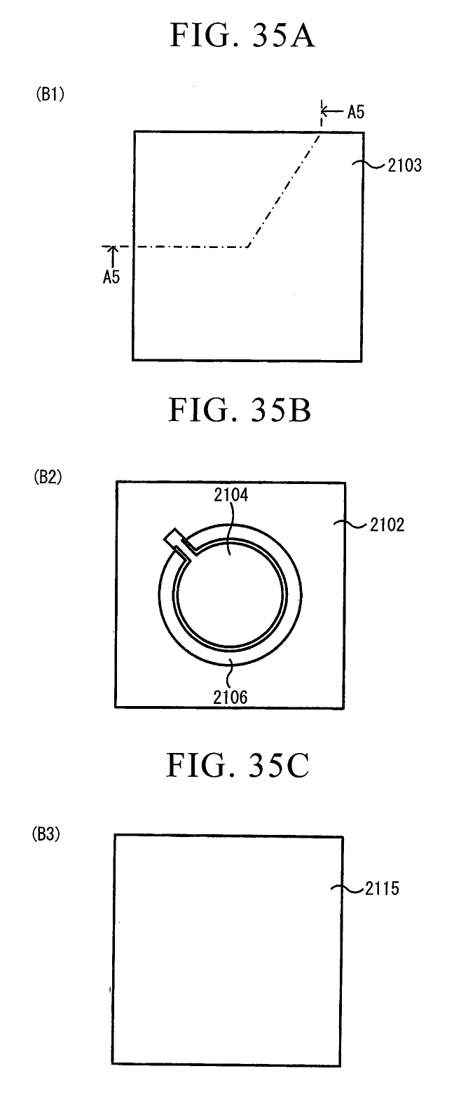

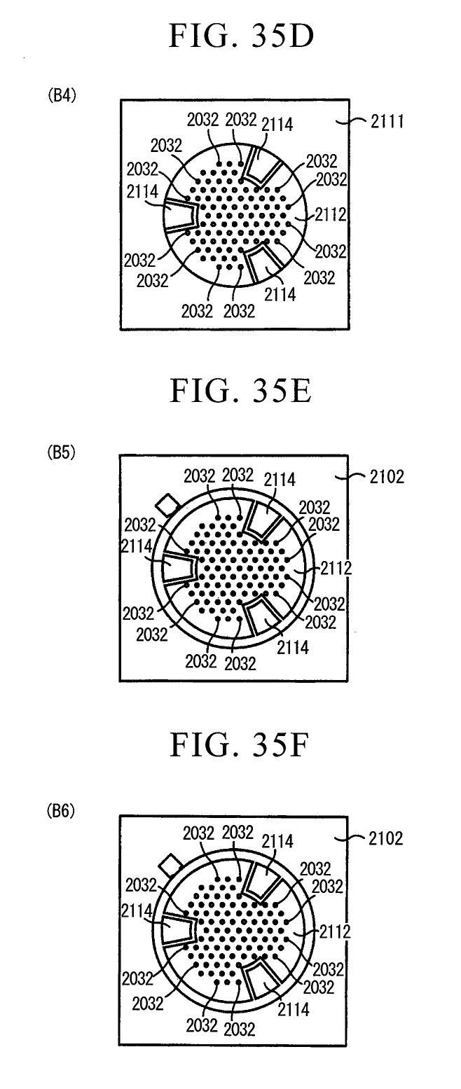

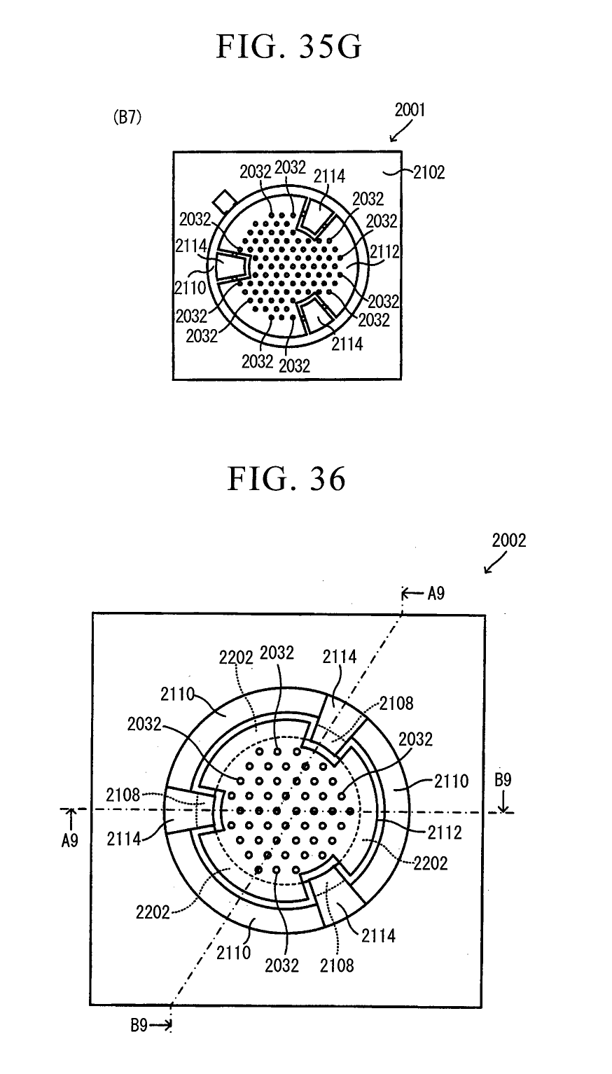

Next, a manufacturing method of the condenser microphone 2001 will be described with reference to FIGS. 34A to 34G and FIGS. 35A to 35G, wherein FIGS. 34A to 34G (designated by reference symbols (A1) to (A7)) are cross-sectional views of FIGS. 35A to 35G (designated by reference symbols (B1) to (B7)) and are each taken along line A5-A5 in FIG. 35A.

In a first step of the manufacturing method (see (A1), i.e., FIG. 34A), an insulating film 2102 is formed on the substrate 2100, which is a semiconductor substrate such as a monocrystal silicon substrate, for example. Specifically, an insulating material is deposited on the surface of the substrate 2100 by way of CVD (Chemical Vapor Deposition), thus forming the insulating film 2102 on the substrate 2100.

Next, a conductive film 2103 (e.g., a polysilicon film) is formed on the insulating film 2102 by way of CVD.

The aforementioned process can be omitted by using an SOI substrate.

In a second step (see (B2), i.e., FIG. 35B), the conductive film 2103 is subjected to patterning so as to form a conductive film 2104 forming the diaphragm 2010 and a conductive film 2106 forming the supports 2040. Specifically, a resist film 2107 is formed on the conductive film 2103 by way of lithography so as to cover the prescribed portion of the conductive film 2103, which is left as the conductive films 2104 and 2106, and to expose unnecessary portions of the conductive film 2103. More specifically, a resist is applied onto the conductive film 2103 so as to form a resist film, which is then subjected to exposure and development by use of a mask having a prescribed shape so that unnecessary portions thereof is removed, thus forming the resist film 2107 on the conductive film 2103. Then, the exposed portion of the conductive film 2103, which is exposed from the resist film 2107, is subjected to etching such as RIE (Reactive Ion Etching), thus forming the conductive films 2104 and 2106. Thereafter, the resist film 2107 is removed.

In a third step (see (A3), i.e., FIG. 34C), an insulating film 2111 whose thickness is larger than the thickness of the conductive films 2104 and 2106 is formed above the conductive films 2104 and 2106 on the insulating film 2102 by way of CVD. In the following process, the insulating films 2102 and 2111 are selectively removed from the conductive films 2104 and 2106 as well as conductive films 2112 and 2114, whereby the insulating films are formed using a prescribed material whose etching ratio is higher than that of the material of the conductive films. For example, when the conductive films are composed of polysilicon, the insulating films are composed of SiO₂.

In the process in which the insulating films are selectively removed from the conductive films, the insulating films are partially removed but are still left in order to form several parts of the condenser microphone 2001. Hence, it is preferable that the insulating films 2102 and 2111 be composed of the same material, by which the same etching rate can be set to them. This makes it possible to easily control the amount of etching with respect to the insulating films.

Next, a conductive film 2115 (e.g., a polysilicon film) is formed on the insulating film 2111 by way of CVD.

In a fourth step (see (B4), i.e., FIG. 35D), the conductive film 2115 is subjected to patterning so as to form the conductive film 2112 forming the back plate 2030 and the conductive film 2114 forming the diaphragm 2010. Specifically, a resist film 2116 is formed on the conductive film 2115 by way of lithography so as to cover prescribed portions of the conductive film 2115, which are left as the conductive films 2112 and 2114, and to expose unnecessary portions of the conductive film 2115. Next, the exposed portion of the conductive film 2115, which is exposed from the resist film 2116, is subjected by etching such as RIE, thus forming the conductive films 2112 and 2114. Thereafter, the resist film 2116 is removed. Since both of the conductive films 2112 and 2114 are formed using the same conductive film 2115, it is possible to simplify the manufacturing process of the condenser microphone 2001.

In a fifth step (see (A5), i.e., FIG. 34E), the outlines of the supports 2040 are shaped. Specifically, the prescribed portion of the insulating film 2111 is exposed in the area between the conductive films 2112 and 2114; the prescribed portions of the insulating film 2111 are exposed by way of the holes 2032 formed in the conductive film 2112; and a resist film 2117 is formed so as to cover the conductive films 2112 and 2114. Then, the exposed portion of the insulating film 2111, which is exposed from the resist film 2117, is removed by way of RIE. Thereafter, the resist film 2117 is removed.

In a sixth step (see (A6), i.e., FIG. 34F), an opening 2120 corresponding to the opening 2042 defined by the supports 2040 is formed in the substrate 2100. Specifically, a resist film 2121 for exposing the prescribed area of the substrate 2100 corresponding to the opening 2120 is formed by way of lithography. Then, the exposed portion of the substrate 2100, which is exposed from the resist film 2121, is removed by way of Deep RIE such that etching progresses to reach the insulating film 2102, thus forming the opening 2120 in the substrate 2100. Thereafter, the resist film 2121 is removed.

In a seventh step (see (A7), i.e., FIG. 34G), the insulating films 2102 and 2111 are partially removed so as to form an air gap 2050 between the diaphragm 2010 and the back plate 2030; to form an opening 2122 (corresponding to the opening 2042 defined by the supports 2040) in the insulating film 2102; and to form the insulating film 2108 (forming the diaphragm 2010) and the insulating film 2110 (forming the supports 2040) by use of the insulating film 2111. Specifically, the insulating films 2102 and 2111 are removed by way of wet etching. When the insulating films 2102 and 2111 are composed of SiO₂, it is possible to use hydrofluoric acid as an etching solution. The etching solution is infiltrated into the opening 2120 of the substrate 2100 and the holes 2032 of the conductive film 2112 so as to reach the insulating films 2102 and 2111, which are thus dissolved. Thus, it is possible to form the air gap 2050 between the diaphragm 2010 and the back plate 2030 as well as the diaphragm 2010 and the supports 2040. Hence, it is possible to complete the formation of the sensing portion of the condenser microphone 2001.

The third embodiment can be further modified in a variety of ways, which will be described below.

(e) First Variation

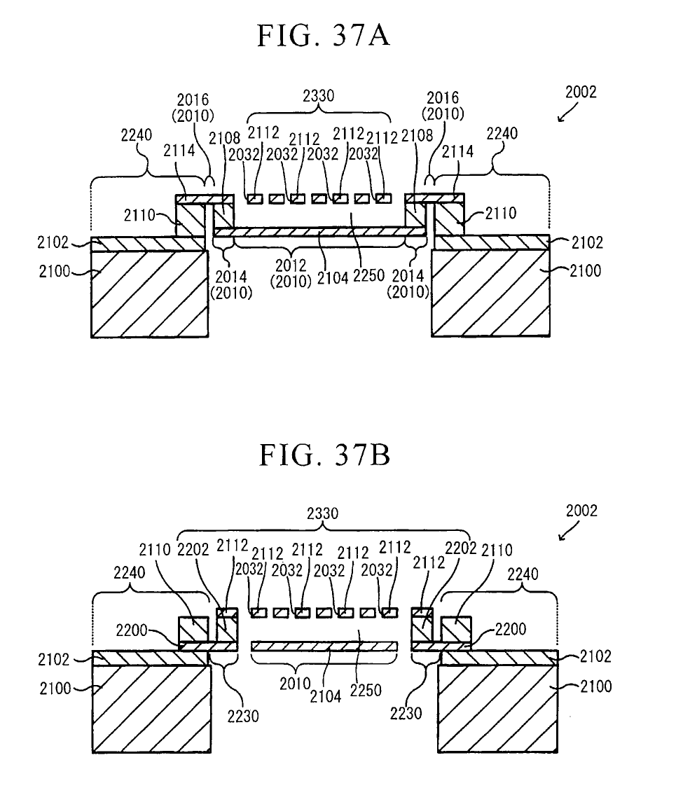

A first variation of the third embodiment will be described with reference to FIG. 36 and FIGS. 37A and 37B, wherein FIG. 37A is a cross-sectional view taken along line A9-A9 in FIG. 36, and FIG. 37B is a cross-sectional view taken along line B9-B9 in FIG. 36. A condenser microphone 2002 according to the first variation of the third embodiment is constituted of a detecting portion and a sensing portion. The constitution of the detecting portion of the condenser microphone 2002 is substantially identical to the constitution of the detecting portion of the condenser microphone 2001.

The condenser microphone 2002 includes the electrode 2060 and the electrode extension portion 2105 (which are connected to the diaphragm 2010), which are not illustrated and not described for the sake of convenience.

The sensing portion of the condenser microphone 2002 is constituted of the diaphragm 2010 (as similar to the condenser microphone 2001), a back plate 2230, and supports 2240.

The back plate 2230 is formed using the prescribed portion of a conductive film 2200 that is fixed to the insulating film 2102 as well as an insulating film 2202 and the conductive film 2112. The conductive film 2112 is held by means of the conductive film 2200 and the insulating film 2202 so as to form an air gap 2250 between the back plate 2230 and the center portion 2012 of the diaphragm 2010.

The supports 2240 are formed using prescribed portions of the conductive films 2114 and 2200, which are fixed to the insulating film 2110, the insulating films 2110 and 2102, and the substrate 2100.

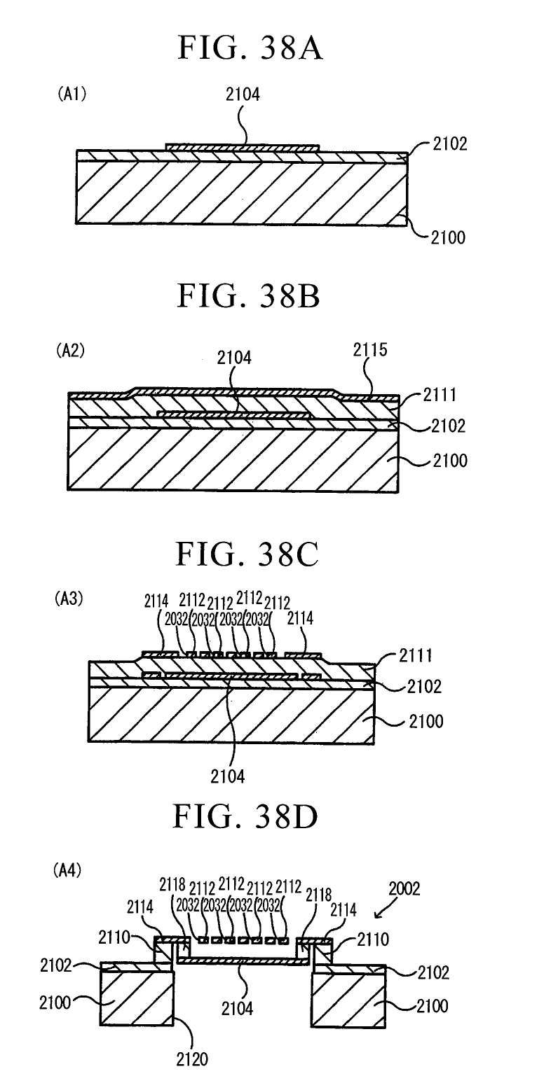

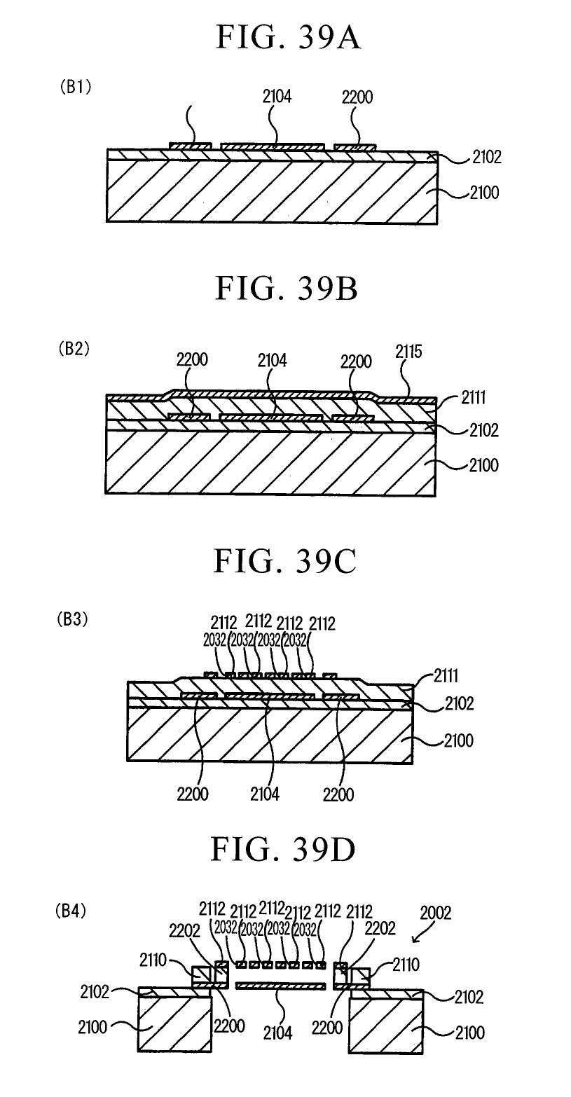

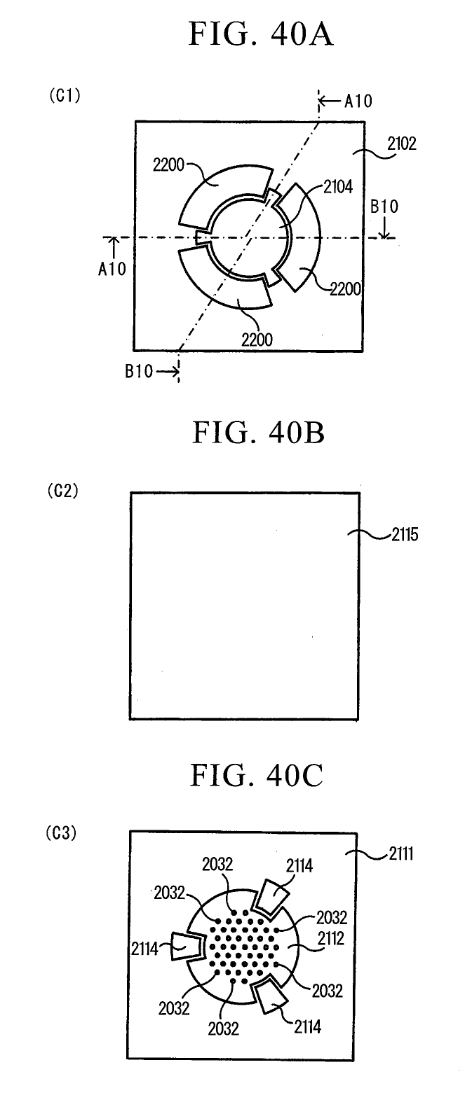

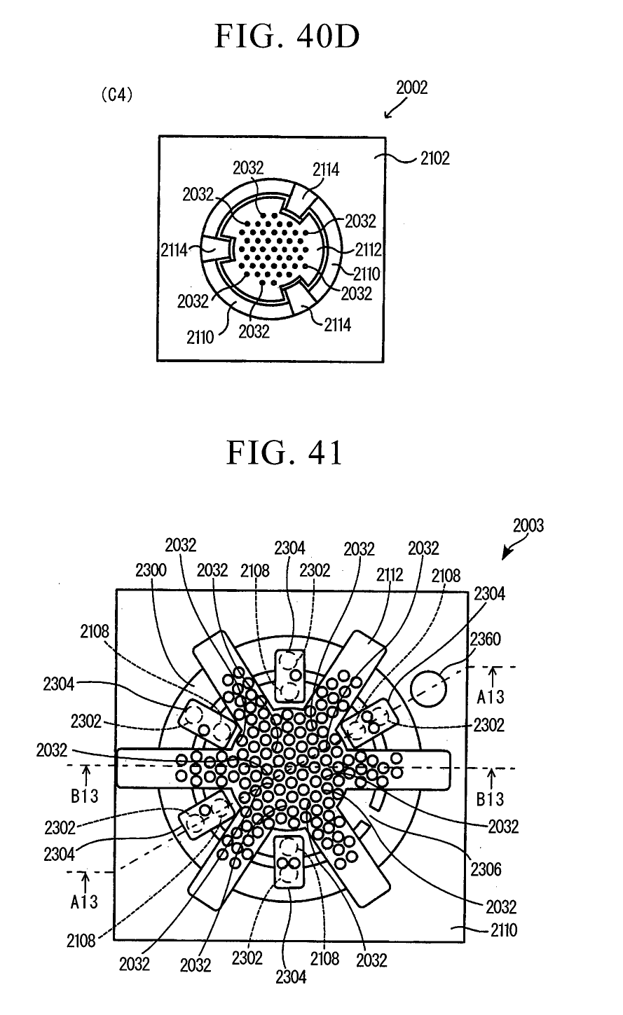

Next, a manufacturing method of the condenser microphone 2002 will be described with reference to FIGS. 38A to 38D, FIGS. 39A to 39D, and FIGS. 40A to 40D, wherein FIGS. 38A to 38D (designated by reference symbols (A1) to (A4)) are cross-sectional views of FIGS. 40A to 40D (designated by reference symbols (C1) to (C4)) and are each taken along line A10-A10 in FIG. 40A, and FIGS. 39A to 39D (designated by reference symbols (B1) to (B4)) are cross-sectional views of FIGS. 40A to 40D and are each taken along line B10-B10 in FIG. 40A.

In a first step (see (A1), i.e., FIG. 38A) of the manufacturing method of the condenser microphone 2002, similar to the manufacturing method of the condenser microphone 2001, the insulating film 2102 is formed on the substrate 2100. Then, the conductive film 2103 is formed on the insulating film 2102.

Next, the conductive film 2103 is subjected to pattering (see (B1), i.e., FIG. 39A) so as to form the conductive film 2104 forming the diaphragm 2010 and the conductive film 2200 forming the back plate 2230 and the supports 2240. Since both of the conductive films 2104 and 2200 are formed using the same conductive film 2103, it is possible to simplify the manufacturing process of the condenser microphone 2002.

In a second step (see (A2), i.e., FIG. 38B), similar to the manufacturing method of the condenser microphone 2001, the insulating film 2111 whose thickness is larger than the thickness of the conductive films 2104 and 2200 is formed on the insulating film 2102. Then, the conductive film 2115 is formed on the insulating film 2111.

In a third step (see (B3), i.e., FIG. 39C), the conductive film 2115 is subjected to patterning so as to form the conductive film 2112 forming the back plate 2230 and the conductive film 2114 forming the diaphragm 2010. Since both of the conductive films 2112 and 2114 are formed using the same conductive film 2115, it is possible to simplify the manufacturing process of the condenser microphone 2002.

In a fourth step (see (B4), i.e., FIG. 39D), similar to the manufacturing method of the condenser microphone 2001, the opening 2120 is formed in the substrate 2100. Then, the insulating films 2102 and 2111 are partially removed. This completes the formation of the sensing portion of the condenser microphone 2002.

Next, second to sixth variations of the third embodiment will be described by way of condenser microphones. The detecting portions of the condenser microphones according to second to sixth variations of the third embodiment are each identical to the detecting portion of the condenser microphone 2001. In addition, sensing portions of the condenser microphones according to second to sixth variations of the third embodiment can be each manufactured by slightly changing the patterning of the conductive film 2103 and the patterning of the conductive film 2115 adapted to the manufacturing method of the condenser microphone 2001.

(f) Second Variation

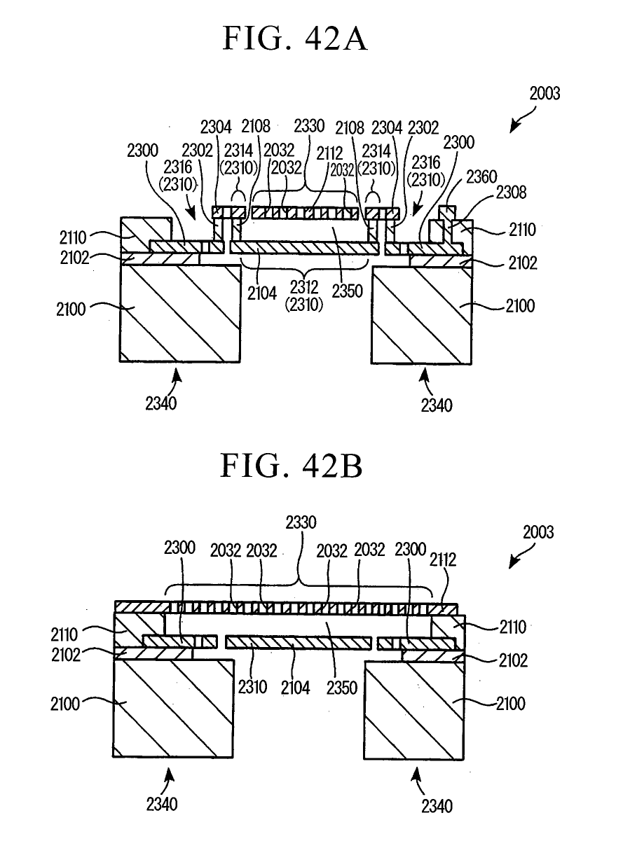

A condenser microphone 2003 according to a second variation of the third embodiment will be described with reference to FIG. 41 and FIGS. 42A and 42B, wherein FIG. 42A is a cross-sectional view taken along line A13-A13 in FIG. 41, and FIG. 42B is a cross-sectional view taken along line B13-B13 in FIG. 41. In the following description, the electrode and electrode extension portion connected to a diaphragm 2310 included in the condenser microphone 2003 are not described for the sake of convenience.

The sensing portion of the condenser microphone 2003 is constituted of the diaphragm 2310, a back plate 2330, supports 2340, and an electrode 2360. The diaphragm 2310 is bridged across the supports 2340 so as to form an air gap 2350 with the back plate 2330. The diaphragm 231, has a center portion 2312, which is substantially identical to the center portion 2012 of the diaphragm 2010 included in the condenser microphone 2001. That is, the center portion 2312 of the diaphragm 2310 is formed using the prescribed portion of the conductive film 2104 that is fixed to the insulating film 2108. The diaphragm 2310 has an intermediate portion 2314, which is substantially identical to the intermediate portion 2014 of the diaphragm 2010. Hence, the intermediate portion 2314 of the diaphragm 2310 is formed using the prescribed portion of the conductive film 2104 and a prescribed portion of a conductive film 2304, both of which are fixed to the insulating film 2108, as well as the insulating film 2108. The conductive film 2304 is a semiconductor film composed of polysilicon, for example. A near-end portion 2316 of the diaphragm 2310 is formed using the prescribed portion of the conductive film 2304 that is not fixed to the insulating film 2108 and the prescribed portion of a conductive film 2300 that is not fixed to the insulating film 2102 as well as an insulating film 2302. The conductive film 2300 is a semiconductor film composed of polysilicon, for example.

One end of the insulating film 2108 is formed on the near-end portion of the conductive film 2104, and the opposite end of the insulating film 2108, which is positioned opposite to the conductive film 2104, is fixed to the conducive film 2304. The conductive film 2304 is elongated from the insulating film 2108 to the support 2340. The near-end portion of the conductive film 2304, which is close to the support 2340, is fixed to the insulating film 2302, which is formed in the same layer as the insulating film 2108. The insulating film 2302 is formed on the conductive film 2300, which is formed in the same layer as the conductive film 2104. The conductive film 2300 is extended outwardly from the insulating film 2302, which the conductive film 2300 is fixed to, toward the insulating film 2102 forming the support 2340.

The near-end portion 2316 of the diaphragm 2310 is bent and extended from the intermediate portion 2314 to the supports 2340. Hence, the rigidity of the near-end portion 2316 is lower than the rigidity of the “planar” portion. This realizes a relatively large deformation of the near-end portion 2316 of the diaphragm 2310 due to sound waves, which in turn realizes a relatively large deformation of the center portion 2312 of the diaphragm 2310 due to sound waves. That is, the second variation of the third embodiment guarantees relatively large displacement of the center portion 2312 of the diaphragm 2310 in vibration due to sound waves because of a relatively large deformation of the near-end portion 2316. Hence, it is possible to increase variable capacity formed between the diaphragm 2310 and the back plate 2330. Thus, it is possible to increase the sensitivity of the condenser microphone 2003.

The back plate 2330 of the condenser microphone 2003 is substantially identical to the back plate 2030 of the condenser microphone 2001. The supports 2340 of the condenser microphone 2003 are substantially identical to the supports 2040 of the condenser microphone 2001. That is, the supports 2340 are formed using the prescribed portions of the conductive films 2112 and 2300, which are fixed to the insulating film 2110, as well as the insulating films 2110 and 2102 and the substrate 2100. The electrode 2360 connects the diaphragm 2310 (serving as a moving electrode) and the detecting portion together. As shown in FIG. 41, the electrode 2360 is connected to the conductive film 2104 via an interconnecting portion 2306, which connects the conductive films 2104 and 2300 together, and a conductive film 2308 formed on the conductive film 2300.

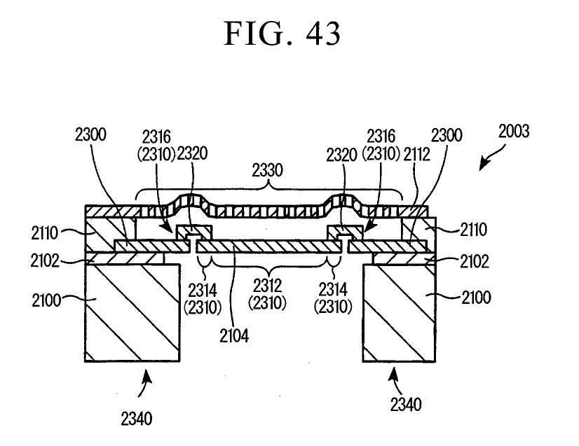

Incidentally, the condenser microphone 2003 can be further modified as shown in FIG. 43 in such a way that the near-end portion 2316 of the diaphragm 2310 is formed in a two-layered structure including the conductive film 2300 and a thin film 2320 having a bent shape. Alternatively, the conductive films 2304 and 2320 (forming the diaphragm 2310) and the conductive film 2112 (forming the back plate 2330) can be formed in different layers.

(g) Third Variation

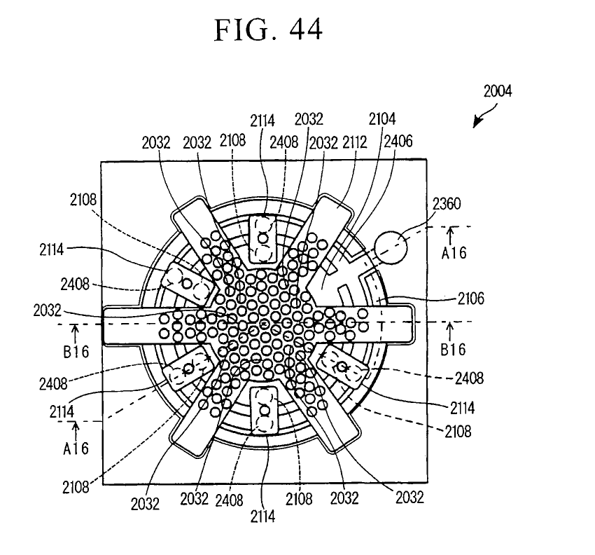

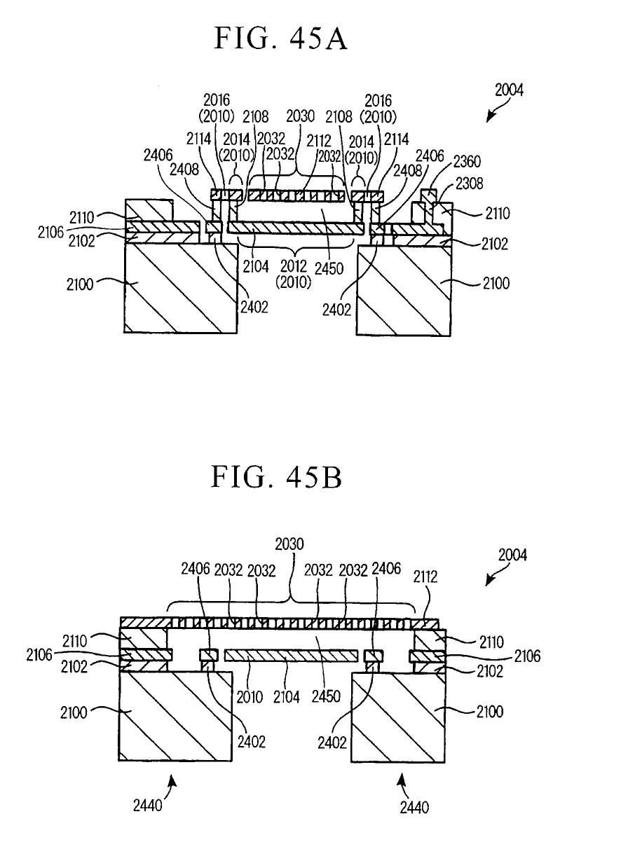

A condenser microphone 2004 according to a third variation of the third embodiment will be described with reference to FIG. 44 and FIGS. 45A and 45B, wherein FIG. 45A is a cross-sectional view taken along line A16-A16 in FIG. 44, and FIG. 45B is a cross-sectional view taken along line B16-B16 in FIG. 44. The sensing portion of the condenser microphone 2004 is basically identical to the sensing portion of the condenser microphone 2001 except for supports 2440.

The supports 2440 of the condenser microphone 2004 are formed using an insulating film 2402, a conductive film 2406, and an insulating film 2408 in addition to the aforementioned conductive films and insulating films forming the supports 2040 included in the condenser microphone 2001. The insulating films 2402 and 2408 are oxide films composed of SiO₂, for example. The conductive film 2406 is a semiconductor film composed of polysilicon, for example. Each of the supports 2440 has two support structures. A first support structure is constituted of a prescribed portion of the conductive film 2112, which is fixed to the insulating film 2110, as well as the insulating film 2110, the conductive film 2106, and the insulating film 2102, so that the back plate 2030 is bridged across the first support structure. A second support structure is constituted of a prescribed portion of the conductive film 2114, which is fixed to the insulating film 2408, as well as the insulating film 2408, the conductive film 2406, and the insulating film 2402, so that the diaphragm 2010 is bridged across the second support structure.

As shown in FIG. 44, the conductive film 2106 is electrically insulated from other conductive films, which are formed in the same layer therewith, so that the conductive film 2106 is formed between the back plate 2030 and the substrate 2100. That is, the conductive film 2106 of the condenser microphone 2004 can be used as a guard electrode, which functions to reduce parasitic capacitance formed between the back plate 2030 and the substrate 2100. Specifically, when the conductive film 2106 serves as a guard electrode, the output terminal of the pre-amplifier 2810 (see FIG. 30B) is connected to the conductive film 2106 so that the pre-amplifier 2810 forms a voltage follower circuit. By placing the back plate 2030 and the conductive film 2106 substantially at the same potential, it is possible to remove the parasitic capacitance between the back plate 2030 and the conductive film 2106. Hence, it is possible to reduce the parasitic capacitance between the back plate 2030 and the substrate 2100.

(h) Fourth Variation

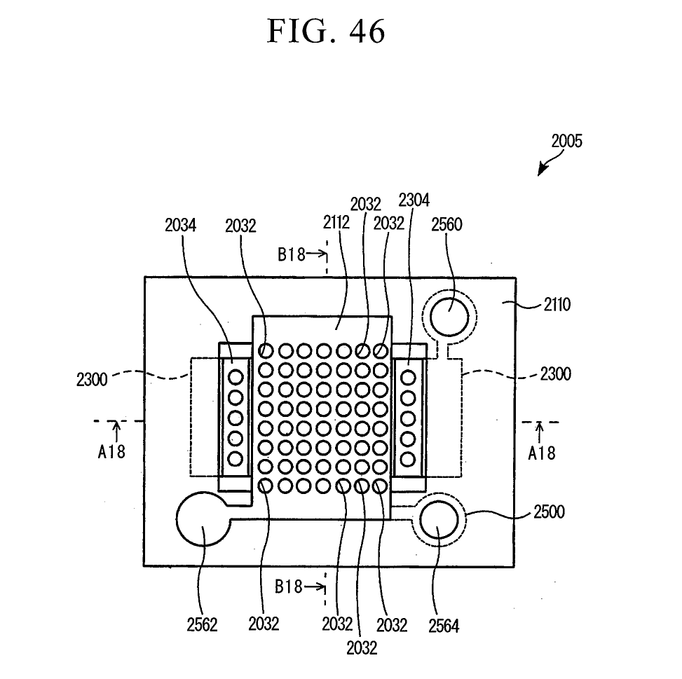

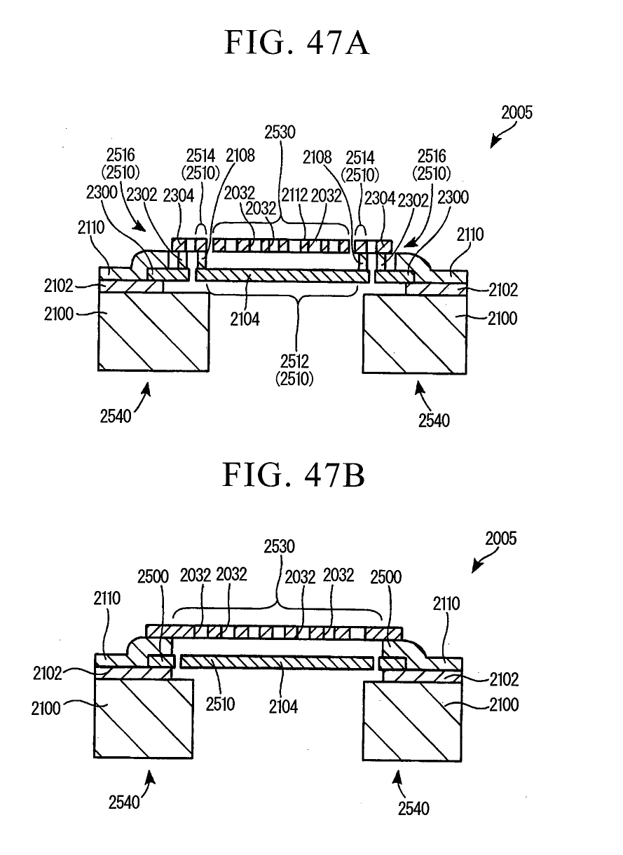

A condenser microphone 2005 according to a fourth variation of the third embodiment will be described with reference to FIG. 46 and FIGS. 47A and 47B, wherein FIG. 47A is a cross-sectional view taken along line A18-A18 in FIG. 46, and FIG. 47B is a cross-sectional view taken along line B18-B18 in FIG. 46.

The sensing portion of the condenser microphone 2005 is constituted of a diaphragm 2510, a back plate 2530, and supports 2540.

The diaphragm 2510 has a rectangular shape, wherein the diaphragm 2510 is bridged across the supports 2540 such that both ends of the diaphragm 2510 lying in its long side are fixed to the supports 2540.

The diaphragm 2510 is constituted of a plurality of thin films, which are basically identical to the aforementioned conductive film and insulating film of the diaphragm 2310 included in the condenser microphone 2003 except for the shapes thereof. Specifically, the conductive film 2104 included in the diaphragm 2510 has a rectangular shape, so that two insulating films 2108 are respectively formed on the opposite ends (i.e., near-end portions) of the conductive film 2104. The two insulating films 2108 have linear shapes lying in parallel with the opposite ends of the conductive film 2104. Conductive films 2304 are elongated inwardly from the insulating films 2108 toward the supports 2540. The near-end portions of the conductive films 2304, which are close to the supports 2540, are fixed to insulating layers 2302, which are formed in the same layer as the insulating films 2108. The insulating layers 2302, which have linear shapes lying in parallel with the insulating films 2108, are formed on the conductive film 2300. The conductive film 2300 is partially fixed to the insulating films 2302 and is elongated toward the supports 2540, which are formed using the insulating film 2102.

The back plate 2530 having a rectangular shape is bridged across the supports 2540 such that it three-dimensionally crosses the diaphragm 2510. The back plate 2530 is positioned to be opposite to a center portion 2512 of the diaphragm 2510 but not to be opposite to an intermediate portion 2514 and a near-end portion 2516 of the diaphragm 2510. That is, the back plate 2530 is positioned to be opposite only to the center portion 2512 of the diaphragm 2510, which vibrates with maximum displacement. Hence, it is possible to reduce a capacity component, which does not vary due to sound waves within the capacity between the diaphragm 2510 and the back plate 2530. Thus, it is possible to increase the sensitivity of the condenser microphone 2005.

The supports 2540 are composed of a plurality of thin films, which are basically identical to the aforementioned conductive film and insulating film forming the supports 2340 included in the condenser microphone 2003 except for the shapes thereof. That is, the supports 2540 are formed using a conductive film 2500 in addition to the conductive film and insulating film forming the supports 2340. The conductive film 2500 is electrically insulted from other conductive films.

An electrode 2560 is substantially identical to the electrode 2360 included in the condenser microphone 2003 and is provided to establish connection between the diaphragm 2510 and the detecting portion of the condenser microphone 2005. An electrode 2562 is provided to establish connection between the back plate 2530 and the detecting portion of the condenser microphone 2005. An electrode 2564 is connected to the conductive film 2500, which is positioned opposite to the back plate 2530 via the insulating film 2110. Similar to the condenser microphone 2004 in which the conductive film 2106 serves as a guard electrode, the output terminal of the pre-amplifier 2810 (see FIG. 30B) is connected to the electrode 2564, so that the conductive film 2500 serves as a guard electrode.

(i) Fifth Variation

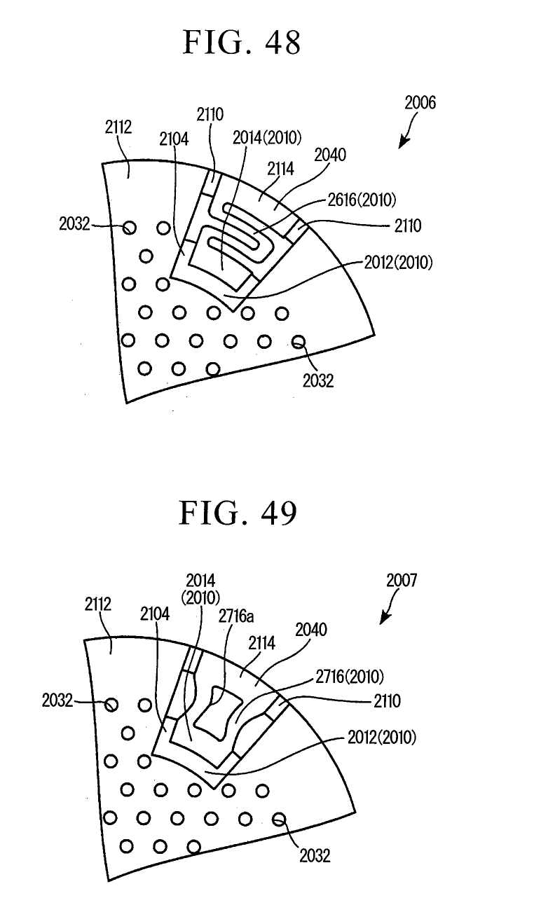

FIG. 48 shows a condenser microphone 2006 according to a fifth variation of the third embodiment. The constituent elements of the condenser microphone 2006 are basically identical to those of the condenser microphone 2001 except that the shape of a near-end portion 2616 of the diaphragm 2010 differs from the shape of the near-end portion 2016 of the diaphragm 2010 included in the condenser microphone 2001.

That is, the near-end portion 2616 of the diaphragm 2010 included in the condenser microphone 2006 is bent and expanded from the intermediate portion 2014 to the supports 2040. Hence, it has relatively low rigidity. Specifically, the conductive film 2104 is meandered and expanded from the intermediate portion 2014 of the diaphragm 2010 to the support 2040.

Incidentally, the aforementioned near-end portions of the diaphragms according to the first to fourth variations of the third embodiment can be modified in such a way that they are partially bent or meandered similar to the near-end portion 2616 of the diaphragm 2010 according to the fifth variation of the third embodiment.

(j) Sixth Variation

FIG. 49 shows a condenser microphone 2007 according to a sixth variation of the third embodiment. Constituent parts of the sensing portion of the condenser microphone 2007 are basically identical to those of the sensing portion of the condenser microphone 2001 except that a near-end portion 2716 of the diaphragm 2010 differs from the near-end portion 201.6.of the diaphragm 2010 included in the condenser microphone 2001.

Specifically, an opening 2716a is formed in the near-end portion 2716 of the diaphragm 2010, which is thus reduced in rigidity. Of course, it is possible to form a plurality of openings in the near-end portion 2716.

Incidentally, the aforementioned near-end portions of the diaphragms according to the first to fourth variations of the third embodiment can be modified in such a way that they each have at least one opening similar to the opening 2716a of the near-end portion 2716 of the diaphragm 2010 according to the sixth variation of the third embodiment.

### 4. Fourth Embodiment

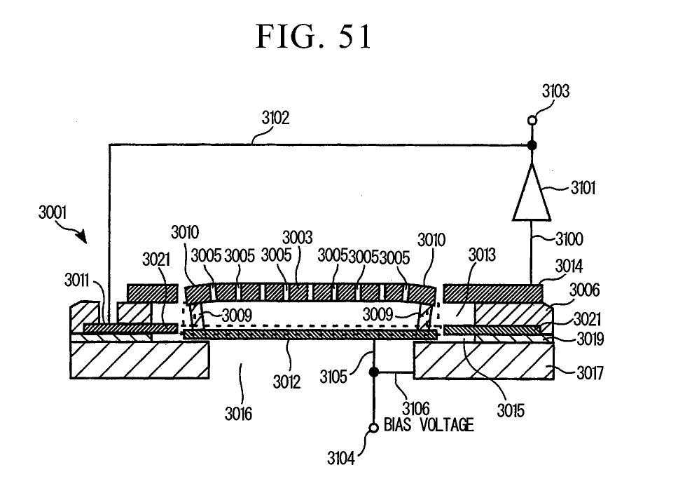

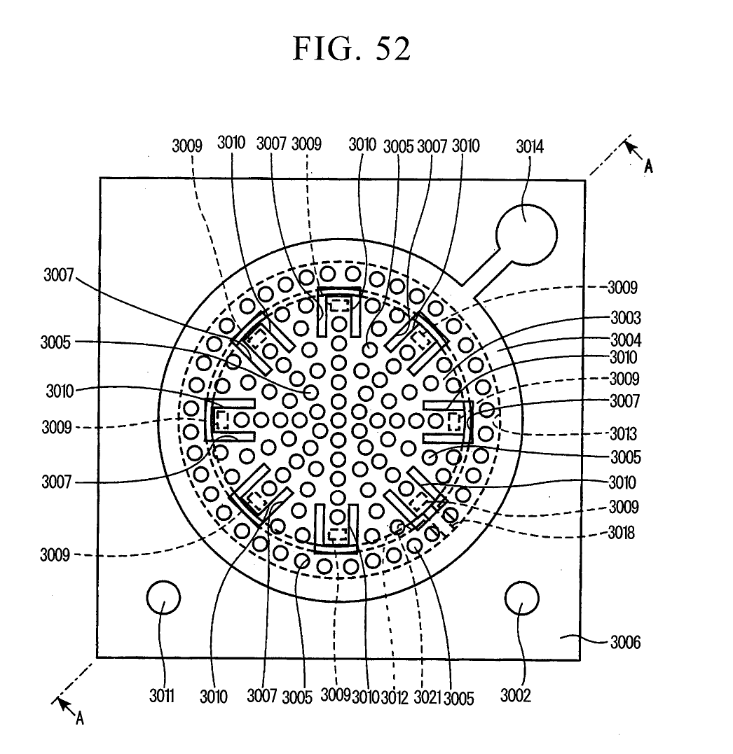

A fourth embodiment of the present invention will be described by way of a condenser microphone 3001 having a sensing portion and a detecting portion with reference to FIGS. 51 to 54, wherein FIG. 51 is a cross-sectional view taken along line A-A in FIG. 52, and FIG. 52 is a plan view showing the sensing portion of the condenser microphone 3001. The condenser microphone 3001 is a silicon capacitor microphone, which is manufactured by way of the semiconductor manufacturing process.

(a) Constitution of Sensing Portion

The sensing portion of the condense microphone 3001 is formed in a multilayered structure including a substrate 3017, a first film, a second film, a third film, and a fourth film. The substrate 3017 is composed of monocrystal silicon. A cavity 3016 is formed in the substrate 3017 so as to reduce sound pressure, which is applied to a diaphragm 3012 in a direction opposite to a propagation direction of sound.

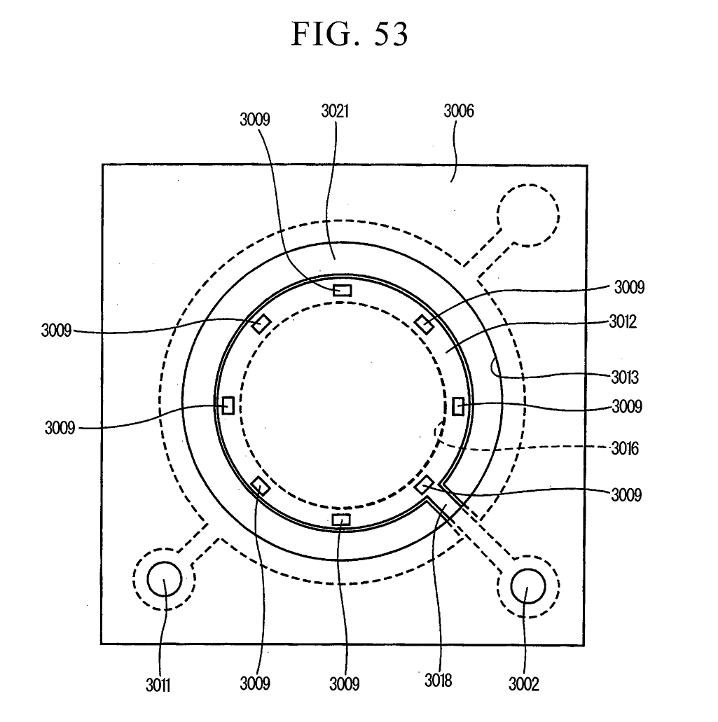

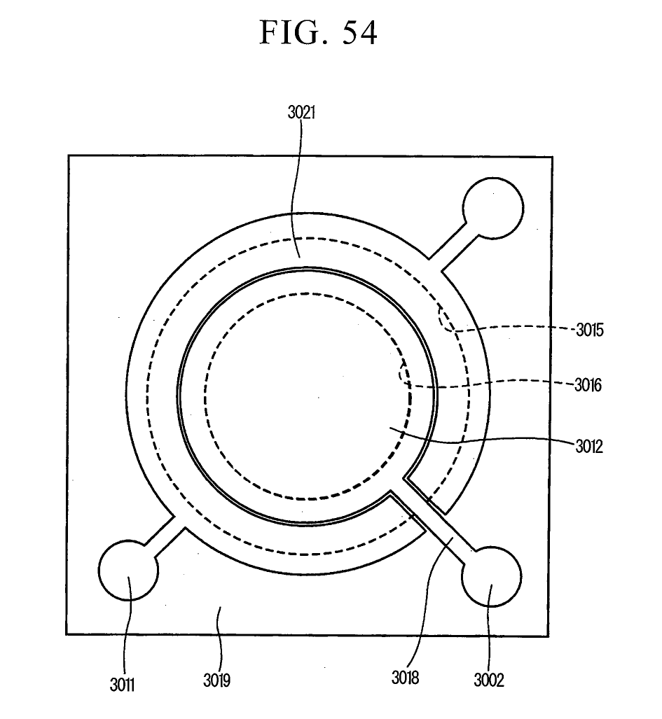

FIG. 53 is a plan view showing prescribed parts of the condenser microphone 3001 without illustrating the fourth film forming a plate 3003 in comparison with the illustration of FIG. 52. FIG. 54 is a plan view showing prescribed parts of the condenser microphone 3001 without illustrating the third film forming spacers 3009 in comparison with the illustration of FIG. 53.

The first film joining the substrate 3017 is a thin film having an insulating ability, which is composed of silicon dioxide. A first support 3019, which is formed using the first film, supports the second film above the substrate 3017 so as to form an air gap between the diaphragm 3012 and the substrate 3017. A circular opening 3015 is formed in the first film, the thickness of which is set to 2 μm, for example.

The second film joining the first film is a conductive thin film composed of polysilicon added with impurities of phosphorus (P). As shown in FIG. 54, the diaphragm 3012 and a guard electrode 3021, which are separated from each other, are formed using the second film. The diaphragm 3012 is positioned between an opening 3015 of the first film and an opening 3013 of the second film. Hence, the diaphragm 3012 does not join the first film and third film (except for the spacers 3009) and is separated from the guard electrode 3021. Thus, the diaphragm 3012 forms a moving electrode that vibrates due to sound waves. The diaphragm 3012 has a circular shape for entirely covering a cavity 3016. The shape of the diaphragm 3012 is not necessarily limited to a circular shape. Hence, the diaphragm 3012 can be formed in any shape such as a rectangular shape. A lead 3018, which is formed using the second film and which joins the first film and third film, is connected to the diaphragm 3012, wherein the side end portion of the lead 3018 positioned in proximity to the diaphragm 3012 is of a thin linear shape that does not join the first film and third film. Hence, the lead 3018 applies substantially no influence to the vibration of the diaphragm 3012. The thickness of the second film is set to 1 μm, for example.

Similar to the first film, the third film joining the first film and second film is a thin film having an insulating ability, which is composed of silicon dioxide, for example. A second support 3006 and the spacers 3009 are formed using the third film, by which the second film having a conductivity is insulated from the fourth film having a conductivity. The thickness of the third film is set to 4 μm, for example. The spacers 3009 and the second support 3006 are separated from each other via the circular opening 3013 formed in the third film. The lower surfaces of the spacers 3009 join the diaphragm 3012.

The fourth film joining the third film is a conductive thin film composed of polysilicon added with phosphorus impurities. As shown in FIG. 52, the plate 3003, bridges 3010, a plate joint portion 3004 (connected to the plate 3003), and a pad 3014 is formed using the fourth film. The plate joint portion 3004 and the pad 3014 join the third film. Since the plate 3003 is positioned just above the opening 3013, the plate 3003 does not join the third film (except for the spacers 3009); the plate joint portion 3004 interconnected with the outer periphery of the plate 3003 joins the third film; and the plate joint portion 3004 is fixed to the second support 3006. A plurality of holes 3005 are formed in the plate 3003. The outlines of the bridges 3010 are defined by U-shaped cutouts 3007, which are formed in the fourth film. Hence, the bridges 3010 are elongated in a radial direction from the center of the diaphragm 3012 and are thus connected to the plate 3003 in a cantilever manner. The tip ends of the bridges 3010 join the upper surfaces of the spacers 3009. That is, the diaphragm 3012, which vibrates independently of the first support 3019, the guard electrode 3021, and the second support 3006, is fixed to the tip ends of the bridges 3010 via the spacers 3009. The length of the bridge 3010, which is measured from the base portion to the tip end joining the upper surface of the spacer 3009, is approximately set to 70 μm, and the width of the bridge 3010 is approximately set to 100 μm. The thickness of the fourth film is approximately set to 1 μm. The overall periphery of the plate 3003 is fixed to the second support 3006, which is formed using the third film, via the plate joint portion 3004, and the sectional area of the plate joint portion 3004 is sufficiently larger than the sectional area of the bridge 3010. Hence, the displacement of the base portion of the bridge 3010 is negligible and smaller than the displacement of the tip end of the bridge 3010. This indicates that the base portion of the bridge 3010 substantially acts as a fixed end, which is precisely subjected to positioning on the basis of the first support 3019 and the second support 3006.

(b) Operation of Sensing Portion

Sound, which reaches the condenser microphone 3001, propagates into the opening 3013 via the holes 3005 of the plate 3003. Then, sound propagates into the gap between the diaphragm 3012 and the substrate 3017. Hence, compared with sound energy transmitted into the opening 3013 via the holes 3005, very small sound energy is transmitted into the cavity 3016. Hence, almost of the sound energy transmitted into the opening 3013 via the holes 3005 and 3008 are consumed by the diaphragm 3012 to vibrate. Because, in view of a sound propagation direction, the cavity 3016 is entirely covered with the diaphragm 3012, and a very small gap is formed between the prescribed portion of the diaphragm 3012 and the prescribed portion of the substrate 3017, which three-dimensionally overlap each other. The cavity 3016 is completely sealed in a packaging process. Hence, an air pressure vibration occurs inside of the cavity 3016 when the diaphragm 3012 vibrates. Such an air pressure vibration may suppress the vibration of the diaphragm 3012. As the volume of the cavity 3016 increases, the air pressure vibration of the cavity 3016 decreases.

(c) Constitution of Detecting Portion

In the detecting portion of the condenser microphone 3001 (see the circuitry shown in FIG. 51), the diaphragm 3012 is connected to a bias voltage circuit. Specifically, a lead 3105 connected to a terminal 3104 of the bias voltage circuit is connected to a pad 3002, which is connected to the diaphragm 3012 via a lead 3018 (see FIGS. 53 and 54). Since the terminal 3104 of the bias voltage circuit is connected to the substrate 3017 via a lead 3106, both of the diaphragm 3012 and the substrate 3017 are substantially placed at the same potential. That is, no capacity is formed between the diaphragm 3012 and the substrate 3017.

The periphery of the plate 3003, which is not positioned opposite to the diaphragm 3012; the plate joint portion 3004; and the pad 3014 are positioned opposite to the guard electrode 3021, which is arranged between the fourth film (forming the plate 3003, the plate joint portion 3004, and the pad 3014) and the substrate 3017 via the third film having an insulating ability. The guard electrode 3021 and the fourth film are connected together and are thus placed at substantially the same potential. Specifically, a lead 3100, which is connected to the pad 3014 coupled with the plate 3003, is connected to an input terminal of an operational amplifier 3101, which is provided to perform impedance conversion. A lead 3102, which is connected to the pad 3011 of the guard electrode 3021, is connected to the output terminal of the operational amplifier 3101. Since the operational amplifier 3101 has an amplification factor of “1”, both of the guard electrode 3021 and the plate 3003 are placed at substantially the same potential.

Due to the formation of the first film having an insulating ability between the guard electrode 3021 and the substrate 3017, a certain capacity is formed between the guard electrode 3021 and the substrate 3017. Such a capacity is intervened between the operational amplifier 3101 and the bias voltage circuit so as to cause substantially no influence to the sensitivity of the condenser microphone 3001.

(d) Operation of Detecting Portion

Since the operational amplifier 3101 having relatively high internal resistance is connected to the plate 3003, a very small amount of electric charge existing in the plate 3003 moves toward the operational amplifier 3101 irrespective of variations of electrostatic capacitance (formed between the diaphragm 3012 and the plate 3003) due to the vibration of the diaphragm 3012. That is, it is presumed that the amount of electric charge accumulated between the plate 3003 and the diaphragm 3012 does not substantially change. This makes it possible to extract variations of electrostatic capacitance between the plate 3003 and the diaphragm 3012 by way of potential variations of the plate 3003. Thus, the condenser microphone 3001 is capable of producing electric signals based on very small variations of electrostatic capacitance between the plate 3003 and the diaphragm 3012. That is, in the condenser microphone 3001, variations of sound pressure applied to the diaphragm 3012 are converted into variations of electrostatic capacitance, which are then converted into potential variations, based on which electric signals are produced in response to variations of sound pressure.

(e) Manufacturing Method

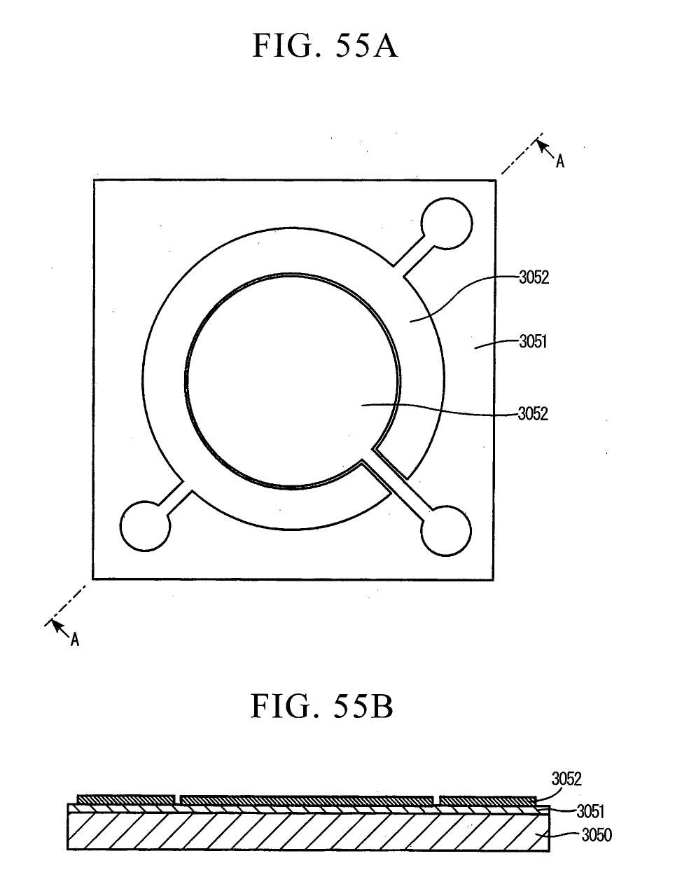

Next, a manufacturing method of the condenser microphone 3001 will be described with reference to FIGS. 55A, 55B, 56A, 56B, 57A, 57B, 58A, and 58B, wherein FIGS. 55B, 56B, 57B, and 58B are cross-sectional views taken along line A-A in FIGS. 55A, 56A, 57A, and 58A.

In a first step of the manufacturing method shown in FIGS. 55A and 55B, a first film 3051 having an insulating ability (which forms the first support 3019) and a second film 3052 having a conductivity are deposited on a wafer 3050 forming the substrate 3017. Then, the second film 3052 is subjected to patterning so as to form the diaphragm 3012 and the guard electrode 3021. Specifically, silicon dioxide is deposited entirely on the surface of the wafer 3050 by way of CVD (Chemical Vapor Deposition) so as to form the first film 3051 whose thickness is approximately 2 μm. Next, by way of decompression CVD, phosphorus-doped polysilicon is deposited on the first film 3051 so as to form the second film 3052 whose thickness is approximately 1 μm. Next, a photoresist film is entirely applied onto the surface of the second film 3052 and is then subjected to exposure and development using a prescribed resist mask by way of photolithography so as to form a resist pattern, wherein the second film 3052 is selectively removed by way of anisotropic etching such as RIE (Reactive Ion Etching). Thus, the diaphragm 3012 and the guard electrode 3021 are formed.

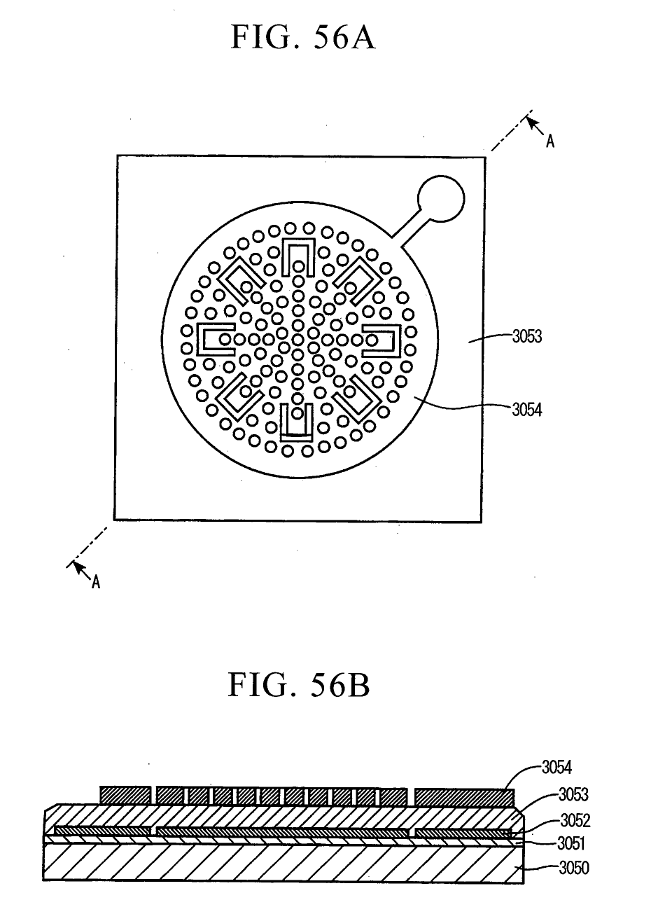

In a second step of the manufacturing method shown in FIGS. 56A and 56B, a third film 3053 having an insulating ability and a fourth film 3054 having a conductivity are sequentially formed on the second film 3052. Then, the fourth film 3054 is subjected to patterning so as to form the plate 3003 and the bridges 3010. Specifically, silicon dioxide is deposited entirely on the surface of the second film 3052 by way of plasma CVD so as to form the third film 3053 whose thickness is approximately 4 μm. Next, phosphorus-doped polysilicon is deposited on the third film 3053 by way of decompression CVD so as to form the fourth film 3054 whose thickness is approximately 1 μm. Next, a photoresist film is applied entirely onto the surface of the fourth film 3054 and is then subjected to exposure and development using a prescribed resist mask by way of photolithography. Then, the fourth film 3054 is selectively removed by way of anisotropic etching such as RIE, thus forming the plate 3003 and the bridges 3010.

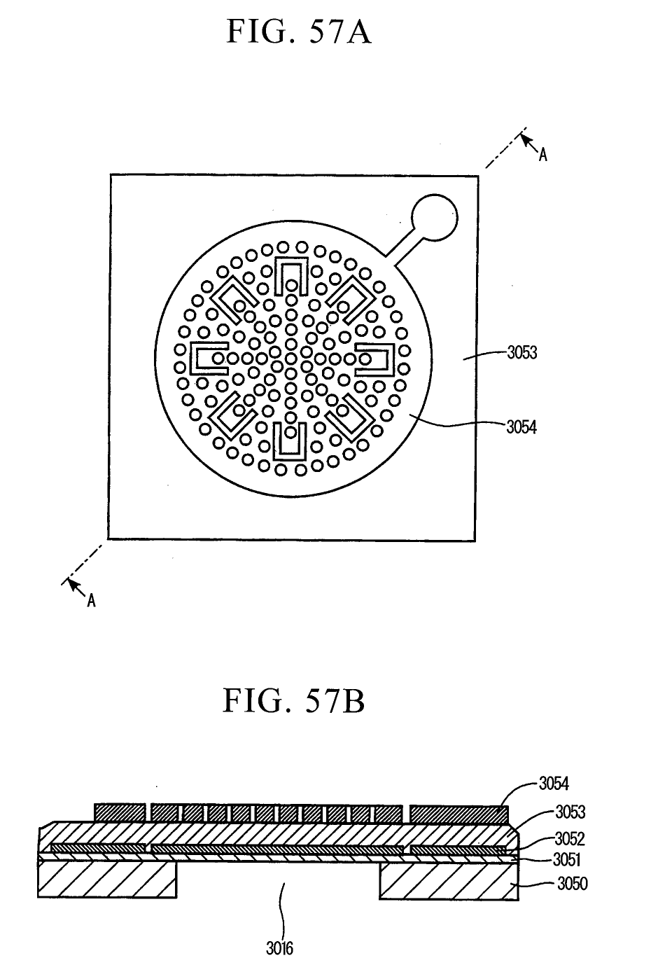

In a third step of the manufacturing method shown in FIGS. 57A and 57B, the cavity 3016 is formed in the wafer 3050. Specifically, a photoresist film is applied entirely onto the backside of the wafer 3050 and is then subjected to exposure and development using a prescribed resist mask by way of photolithography so as to form a resist pattern. Then, the wafer 3050 is selectively removed by way of anisotropic etching such as Deep RIE, thus forming the cavity 3016.

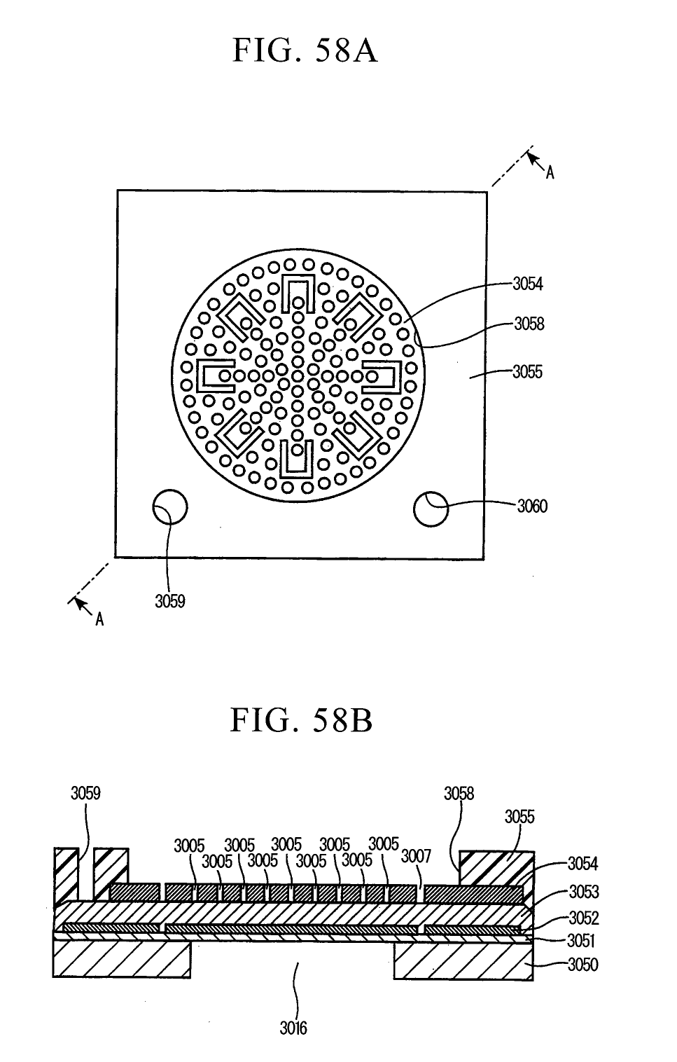

Next, the first film 3051 and the third film 3053 are selectively removed so as to form the openings 3013 and 3015. Specifically, a photoresist film is applied entirely onto the surface of the third film 3053 and the surface of the fourth film 3054. Then, as shown in FIGS. 58A and 58B, photolithography is performed using a resist mask so as to perform exposure and development, thus forming a resist pattern 3055. The resist pattern 3055 has an opening 3058 for exposing the holes 3005 as well as openings 3059 and 3060 for exposing the pads 3011 and 3002 in the third film 3053. Next, isotropic wet etching using buffered hydrofluoric acid (or buffered HF) or the combination of isotropic etching and anisotropic etching is performed so as to selectively remove the first film 3051 and the third film 3053, which are silicon oxide films. At this time, the third film 3053 and the first film 3051 are selectively removed from the prescribed areas corresponding to the holes 3005 of the fourth film 3054 and the gaps between the bridges 3010 and the plate 3003. They are also removed from the cavity 3016 of the wafer 3050. By appropriately designing the pattern of the fourth film 3054, the spacers 3009 (which is formed using the third film 3053) are left inside of the opening 3013 as shown in FIG. 51. Then, dicing and packaging processes are performed so as to complete the production of the condenser microphone 3001.

In the condition just after the formation of the diaphragm 3012, an intense tensile stress remains in the diaphragm 3012. When the diaphragm 3012 is contracted due to tensile stress after the formation of the openings 3013 and 3015, a certain force is exerted on the lower surfaces of the spacers 3009. Since the bridges 3010 are elongated externally from the center of the diaphragm 3012 in a cantilever manner such that they are elongated from the base portions, which substantially act as the fixed ends connected to the plate 3003, the bridges 3010 may be easily bent. A structure constituted of the bridges 3010, the spacers 3009, and the diaphragm 3012 is bent at a right angle with respect to both of the upper and lower surfaces of the spacers 3009, which lie in the thickness direction of the diaphragm 3012. Hence, the force exerted on the lower surfaces of the spacers 3009 due to the internal stress of the diaphragm 3012 is exerted in a direction crossing the lines, which are drawn from the base portions of the bridges 3010 (corresponding to the rotation centers of the spacers 3009) to the lower surfaces of the spacers 3009. That is, as shown in FIG. 51, the force exerted on the spacers 3009 due to the internal stress of the diaphragm 3012 makes the spacers 3009 rotate about the prescribed centers (corresponding to the base portions of the bridges 3010) such that the lower surfaces of the spacers 3009 move toward the center of the diaphragm 3012. In other words, it acts as the force for bending the bridges 3010 such that the bridges 3010 are slightly moved apart from the plate 3003.

The internal stress of the diaphragm 3012 is partially released due to the rotation of the spacers 3009 and due to the bending of the bridges 3010. Incidentally, FIG. 51 shows the previous positions of the bridges 3010 and the spacers 3009, which are established before the internal stress of the diaphragm 3012 is released, by use of dotted lines. When relatively high tensile stress remains in the diaphragm 3012, in other words, when the diaphragm 3012 is expanded with relatively high tension, it is presumed that the diaphragm 3012 may be hardly deflected irrespective of external force applied thereto. However, the condenser microphone 3001 has a special structure for releasing the internal stress of the diaphragm 3012. Hence, the diaphragm 3012 may be easily deflected due to external force. In other words, the condenser microphone 3001 is capable of increasing the amplitude of vibration of the diaphragm 3012. This noticeably improves the sensitivity of the condenser microphone 3001.

As described above, as shown in FIG. 51, the spacers 3009 rotate about the base portions of the bridges 3010 such that the lower surfaces thereof move toward the center of the diaphragm 3012, and the bridges 3010 are bent to be slightly apart from the plate 3003. This increases the distance between the plate 3003 and the diaphragm 3012 in comparison with the thickness of the third film 3053. Suppose that the tension of 70 MPa is applied to the diaphragm 3012 just after the formation thereof; the thickness of the third film 3053 composed of silicon dioxide is 4 μm; the thickness of the fourth film 3054 composed of polysilicon is 1 μm; the length of the bridge 3010 (measured from the base potion to the tip end) is 70 μm; and the width of the bridge 3010 is 10 μm. In this case, the distance between the plate 3003 and the diaphragm 3012 is increased by 1 μm to 2 μm compared with the distance just after the formation of the diaphragm 3012. The fourth embodiment is characterized in that a desired distance ranging from 125% to 150% of the thickness of the third film 3053 (which is used to form an air gap between the plate 3003 and the diaphragm 3012) can be realized between the plate 3003 and the diaphragm 3012 without introducing additional processes. That is, the condenser microphone 3001 is designed to easily increase the dynamic range thereof without complicating the manufacturing process thereof.

It is conventionally known that a bent portion is formed in a structure in which a diaphragm and another peripheral portion vibrate together, the internal stress of the diaphragm is released by way of the deformation of the bent portion. According to a conventionally-known method for forming the bent portion in the structure, irregularities are formed on the surfaces of the films forming the structure in advance, and the bent portion is formed along the irregularities. In such a conventionally-known method, when the precision of photolithography or the step coverage is degraded, it becomes difficult to control the pattern and film thickness. Hence, it is very difficult to form the “sharply” bent portion.

According to the manufacturing method of the condenser microphone 3001, it is possible to freely form the spacers 3009 having desired shapes dependent upon the design of a resist pattern 3055 of the third film 3053. For example, it is possible to form the spacer 3009 whose side surface is substantially perpendicular to the diaphragm 3012 or the spacer 3009 whose width in the radial direction of the diaphragm 3012 is small. That is, the present embodiment realizes the formation of a “sharp” bent portion in the structure that vibrates together with the diaphragm 3012. This noticeably reduces the internal stress of the diaphragm 3012 compared with the conventionally-known diaphragm. In addition, the present embodiment does not require additional processes in addition to the essential process for forming the diaphragm 3012 having a basic structure in order to form the structure constituted of the bridges 3010, the spacers 3009, and the diaphragm 3012.

The fourth embodiment can be further modified in a variety of ways, which will be described below.

(f) First Variation

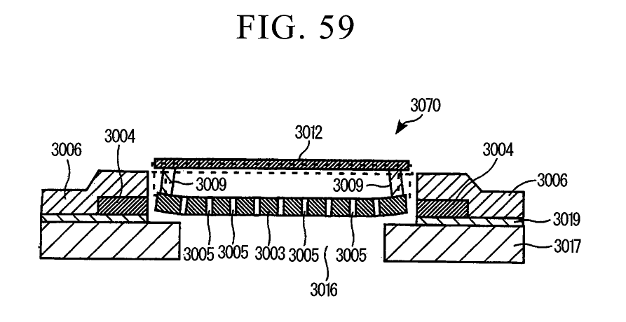

In the condenser microphone 3001, the diaphragm 3012 is formed using a thin film that is positioned close to the substrate 3017 compared with the plate 3003. The fourth embodiment can be applied to the structure in which, as shown in FIG. 59, the plate 3003 is formed using a thin film that is positioned close to the substrate 3017 compared with the diaphragm 3012. That is, a condenser microphone 3070 according to the first variation of the third embodiment is designed such that the “conductive” fourth film 3054 joins between the first film 3051 and the third film 3053, each having an insulating ability, so as to form the plate 3003 and the plate joint portion 3004. In addition, the “conductive” second film 3052 joins onto the third film 3053 having an insulating ability so as to form the diaphragm 3012.

(g) Second Variation

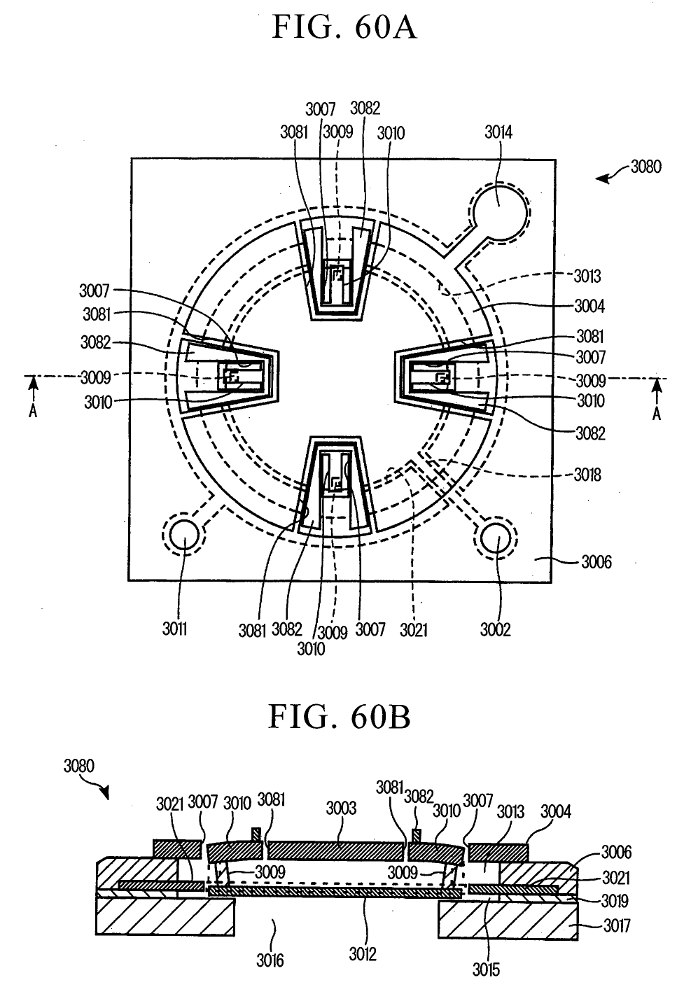

A condenser microphone 3080 according to a second variation of the fourth embodiment will be described with reference to FIGS. 60A and 60B, wherein FIG. 60A is a plan view, and FIG. 60B is a cross-sectional view taken along line A-A in FIG. 60A. Compared with the condenser microphone 3001, the condenser microphone 3080 is characterized in that a plurality of cutouts 3081 are formed in the foregoing fourth film, and a plurality of ribs 3082 are formed using a fifth film, which is formed on the fourth film. Incidentally, FIGS. 60A and 60B do not show holes of the plate 3003 for the sake of convenience.

Since the amplitude of vibration is reduced in the periphery of the diaphragm 3012 compared with the center portion, variations of capacity formed in the periphery of the diaphragm 3012 are reduced. In other words, the ratio of parasitic capacity compared with variations of capacity, based on which the condenser microphone 3080 produces signals, is increased with respect to the periphery of the diaphragm 3012 compared with the center portion of the diaphragm 3012. For this reason, it is preferable that the prescribed portion of the fourth film, which is positioned opposite to the periphery of the diaphragm 3012, be separated from the pad 3014 connected to the plate 3003.

In the condenser microphone 3080, the bridges 3010 and the peripheral portions of the bridges 3010, which are necessary for establishing prescribed positioning with the second support 3006, are separated from the plate 3003 by means of the cutouts 3081. This reduces the parasitic capacity of the condenser microphone 3080 compared with the condenser microphone 3001.

The ribs 3082 are elongated from the base portions of the bridges 3010 toward just above the second support 3006 in order that the tip ends of the bridges 3010 joining the spacers 3009 reliably move apart from the plate 3003 due to the tensile stress of the diaphragm 3012. The ribs 3082 are formed using the fifth film joined onto the fourth film. The fifth film has either a conductivity or an insulating ability. The tip ends of the bridges 3010 can be moved apart from the plate 3003 due to the tensile stress of the diaphragm 3012 as long as the base portions of the bridges 3010 are fixed and are positioned close to the center portion of the diaphragm 3012 in comparison with the tip ends of the bridges 3010. Herein, the movement of the tip ends of the bridges 3010, as to whether the tip ends of the bridges 3010 are moved apart from or close to the plate 3003 due to the tensile stress of the diaphragm 3012, depends upon the structure of the bridges 3010 fixed to the second support 3006. Hence, it is not necessary to fix the base portions of the bridges 3010 in position. When the structure of the bridges 3010 fixed to the second support 3006 makes the tip ends of the bridges 3010 reliably move apart from the plate 3003 due to the tensile stress of the diaphragm 3012, it is possible to omit the ribs 3082.

(h) Third Variation

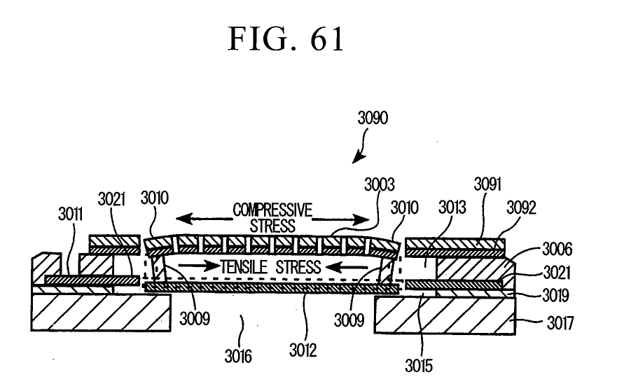

FIG. 61 is a cross-sectional view showing the sensing portion of a condenser microphone 3090 according to a third variation of the fourth embodiment The condenser microphone 3090 differs from the condenser microphone 3001 with respect to only the configuration of thin films forming the bridges 3010. In addition to the first to third films, the bridges 3010 are formed using a fourth film 3092 and a fifth film 3091 (joining the fourth film 3092). In addition to the bridges 3010, other parts (e.g., the plate 3003), which are formed using the foregoing fourth film, are formed using the fourth film 3092 and the fifth film 3091.

Relatively high tensile stress remains in the fourth film 3092, which is positioned close to the diaphragm 3012 in comparison with the fifth film 3091, when it is formed. The fourth film 3092 is composed of polysilicon doped with impurities such as phosphorus. Relatively high compressive stress remains in the fifth film 3091, which joins the fourth film 3092 and which is positioned opposite to the diaphragm 3012, when it is formed. Therefore, the bridges 3010 tend to be deflected in a direction toward the diaphragm 3012 due to the internal stress thereof. In comparison with the foregoing bridges each formed in a single-layered structure, the bridges 3010 are greatly deflected to be close to the diaphragm 3012 due to the internal stress of the bridges 3010 and due to the internal stress of the diaphragm 3012. As a result, it is possible to increase the distance between the plate 3003 and the diaphragm 3012 in the condenser microphone 3090 in comparison with the foregoing condenser microphone in which the bridges are each formed in a single-layered structure.

### 5. Fifth Embodiment

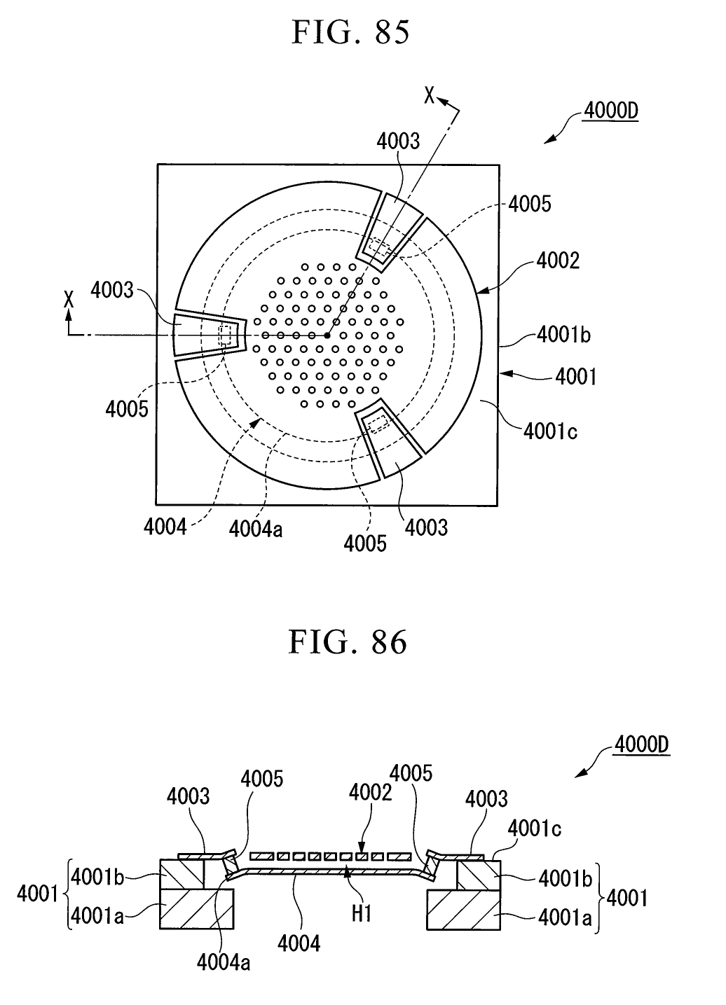

A fifth embodiment of the present invention is provided to solve the following drawback, which will be described with reference to FIGS. 85 and 86, which show a condenser microphone 4000D manufactured using the semiconductor manufacturing process. The condenser microphone 4000D is constituted of a support 4001 having a hole, which is formed by laminating a monocrystal silicon substrate 4001a and an oxide film 4001b, a back plate 4002 having a circular shape in plan view, which is supported on an upper end 4001c of the support 4001, a plurality of bridges 4003, which are positioned vertically relative to the back plate 4002 and are supported by the upper end 4001c of the support 4001, a diaphragm 4004 positioned inside of the hole of the support 4001, a plurality of pillar portions 4005 for supporting the diaphragm 4004, in which the upper ends of the pillar portions 4005 are fixed to the lower surfaces of the bridges 4003, and the lower ends of the pillar portions 4005 are fixed onto the upper surface of the diaphragm 4004.

Due to the tensile stress applied to the condenser microphone 4000D, the diaphragm 4004 is pulled inwardly in a radial direction thereof; and the pillar portions 4005 are inclined and deformed such that the pillar portions 4005 push the bridges 4003 upwardly, and an outer circumferential portion 4004a of the diaphragm 4004 is bent downwardly. Thus, the tensile stress remaining in the diaphragm 4004 is reduced. However, even when the tensile stress is reduced, a small amount of tensile stress still remains in the diaphragm 4004. Hence, the center portion of the diaphragm 4004, which lies inwardly of the pillar portions 4005, is maintained in a planar shape. This avoids unwanted variations of the distance between the back plate 4002 and the diaphragm 4004.

However, due to errors of the manufacturing process for the formation of the film configuration of the diaphragm 4004, the tensile stress is varied so as to cause variations of the deformation of the outer circumferential portion 4004a of the diaphragm 4004 and to cause variations of the inclination or deformation of the pillar portions 4005. This produces unwanted dispersions regarding the distance between the diaphragm 4004 and the back plate 4002 with respect to each one of the condenser microphones during the manufacturing. That is, condenser microphones are dispersed in sensitivity during the manufacturing. For example, in a sample of the condenser microphone 4000D in which the diaphragm 4004 is unexpectedly positioned very close to the back plate 4002, when the diaphragm 4004 vibrates with relatively large amplitude due to relatively high sound pressure applied thereto, the diaphragm 4004 may unexpectedly come in contact with the back plate 4002, which in turn causes an electrical short-circuit.

(a) Constitution of Condenser Microphone

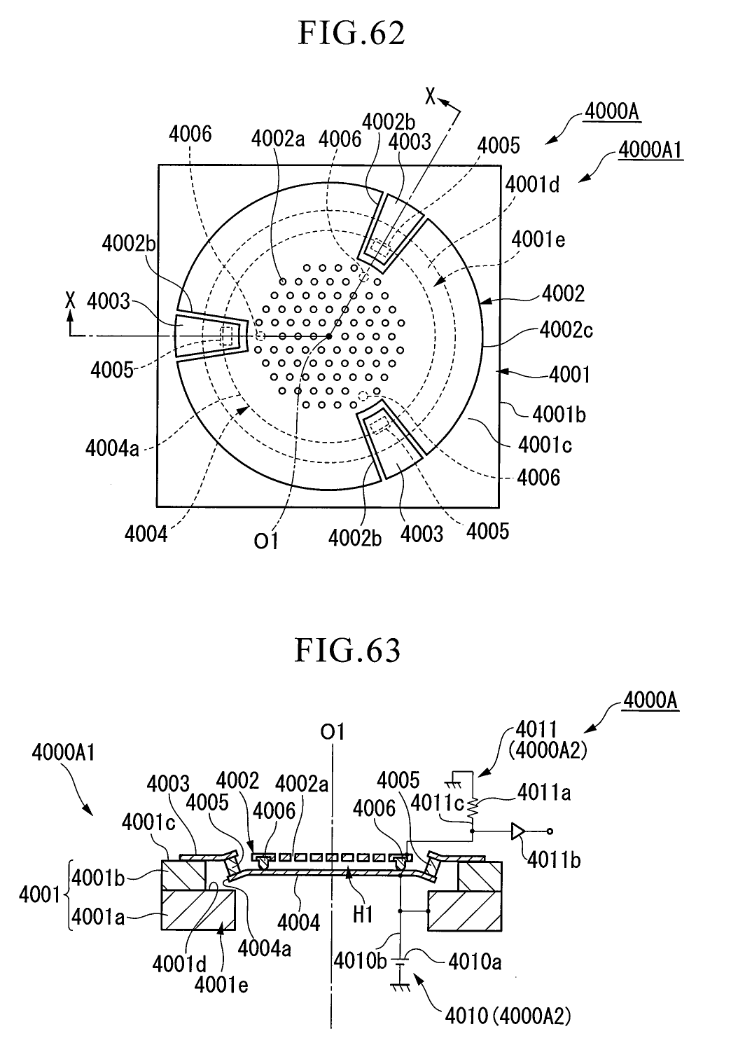

Next, the fifth embodiment and its variations will be described in detail. As shown in FIGS. 62 and 63, a condenser microphone 4000A according to the fifth embodiment is constituted of a sensing portion 4000A1 and a detecting portion 4000A2. The sensing portion 4000A1 of the condenser microphone 4000A is constituted of a ring-shaped support 4001 having a circular hole, which is formed by laminating a monocrystal silicon substrate 4001a and an oxide film 4001b, a back plate 4002 (having a fixed electrode) having a circular shape in plan view, which is supported on an upper end 4001c of the support 4001, a plurality of bridges 4003, which are positioned vertically relative to the back plate 4002 and are supported on the upper end 4001c of the support 4001, a diaphragm (or a vibration plate) 4004 arranged inside of the hole of the support 4001, a plurality of pillar portions 4005 in which the upper ends thereof are fixed to the lower surfaces of the bridges 4003 and the lower ends thereof are fixed onto the upper surface of the diaphragm 4004 so as to support the diaphragm 4004, and a plurality of stoppers 4006 for regulating a gap H1 between the back plate 4002 and the diaphragm 4004. The detecting portion 4000A2 of the condenser microphone 4000A is constituted of a bias voltage circuit 4010 and a resistor circuit 4011.

In the support 4001, the monocrystal silicon substrate 4001a and the oxide film 4001b composed of silicon dioxide (SiO₂) are laminated together along an axial line O1, which coaxially matches an axial line of the hole of the support 4001 and an axial line of the condenser microphone 4000A. In addition, the outer peripheral surface of the substrate 4001a matches the outer peripheral surface of the oxide film 4001b in a radial direction, wherein, as shown in FIG. 63, an interior wall of the oxide film 4001b is positioned externally of an interior wall of the substrate 4001a. That is, a projection 4001e whose upper surface 4001d is exposed is projected inwardly from the interior wall of the substrate 4001a. The fifth embodiment requires the ring-shaped support 4001 to have a hole vertically running therethrough. Hence, the ring-shaped support 4001 does not necessarily have a circular hole in plan view and a rectangular periphery. That is, the support 4001 can be modified such that the hole thereof has a rectangular shape in plan view, and the periphery thereof has a circular shape.

The back plate 4002 is a circular semiconductor film having a conductivity composed of polycrystal silicon (or polysilicon), wherein an outer circumference 4002c thereof is fixed to an upper surface 4001c of the support 4001, i.e., the upper surface of the oxide film 4001b in such a way that the axial line (or center line) thereof coaxially matches the axial line O1 of the support 4001. That is, the center portion of the back plate 4002 covers the hole of the support 4001 in plan view. A plurality of holes 4002a are formed in the center portion of the back plate 4002 and are uniformly distributed in position. A plurality of recesses 4002b, each of which has a U-shape in plan view and is elongated inwardly from the outer circumference 4002c in a radial direction, are formed in the back plate 4002. Specifically, three recesses 4002b are positioned with equal spacing therebetween, wherein each of them has a trapezoidal shape in plan view in which the width thereof becomes small inwardly from the outer circumference 4002c. Of course, the back plate 4002 is not necessarily limited in terms of the number of the recesses 4002b and the shape of the recesses 4002b.

The bridges 4003 are formed using a conductive semiconductor film composed of polysilicon and are each formed in a trapezoidal shape in plan view. That is, the bridges 4003 are arranged inside of the recesses 4002b but are not in contact with the back plate 4002. The outer ends of the bridges 4003 are fixed onto the upper surface 4001c of the support 4001, and the inner ends of the bridges 4003 are elongated inwardly in the radial direction. Hence, the bridges 4003 are each supported by the support 4001 in a cantilever manner. In addition, the upper surfaces and lower surfaces of the outer ends of the bridges 4003 are positioned substantially in the same planes with the upper surface and lower surface of the back plate 4002, while the inner ends of the bridges 4003 (or the free ends of the bridges 4003), which are fixed to the pillar portions 4005, can be elastically deformed upwards in accordance with the inclination (or rotation) of the pillar portion 4005.

The diaphragm 4004 is a circular conductive film composed of polysilicon, for example. The diaphragm 4004 is formed substantially at the center position between the upper surface 4001d of the projection 4001e of the substrate 4001a in such a way that the axial line (or center line) thereof coaxially matches the axial line O1 of the support 4001. In addition, the diaphragm 4004 is supported by means of the pillar portions 4005 (each having a rectangular pillar shape), in which the upper ends thereof are fixed to the lower surfaces of the inner ends of the bridges 4003, and the lower ends thereof are fixed onto the upper surface of the outer circumference 4004a of the diaphragm 4004. The outer circumference 4004a of the diaphragm 4004, which the lower ends of the pillar portions 4005 are fixed to, is slightly deformed and bent downward due to the rotation of the pillar portions 4005 in such a way that the amount of deformation thereof increases outwardly in a radial direction. In contrast, the center portion of the diaphragm 4004 is held horizontally in parallel with the back plate 4002 by means of the stoppers 4006. Thus, the gap H1 having prescribed dimensions is maintained between the back plate 4002 and the diaphragm 4004. That is, the center portion of the diaphragm 4004 is fixed in a position three-dimensionally relative to the back plate 4002 with the “fixed” gap H1 therebetween. Incidentally, the diaphragm 4004 serving as a moving electrode can be formed in a multilayered structure including an insulating film and a conductive film whose center portion functions as the moving electrode, for example.

The stoppers 4006 are each formed in a semispherical shape and are each composed of silicon nitride having an insulating ability and a resistance to hydrofluoric acid. The stoppers 4006 are fixed to the back plate 4002 at prescribed positions, which are slightly inwardly of the recesses 4002b, so that they project downwardly from the lower surface of the back plate 4002. The lower ends of the stoppers 4006 are positioned in contact with the upper surface of the diaphragm 4004 so as to maintain the “fixed” gap H1 between the back plate 4002 and the diaphragm 4004.

In the detecting portion 4000A2 of the condenser microphone 4000A, the bias voltage circuit 4010 includes a bias voltage source 4010a and a lead 4010b, and the resistor circuit 4011 includes a resistor 4011a, a pre-amplifier 4011b, and a lead 4011c. The lead 4010b is connected to the bias voltage source 4010a of the bias voltage circuit 4010 and is also connected to the diaphragm 4004 and the substrate 4001a, which are thus placed substantially at the same potential. In addition, the lead 4011c is grounded onto a board (not shown) for mounting the condenser microphone 4000A via the resistor 4011a. The lead 4011c, which is connected to the resistor 4011a of the resistor circuit 4011, is connected to the back plate 4002 and is also grounded onto the board via the resistor 4011a. Furthermore, the lead 4011c is connected to the input terminal of the pre-amplifier 4011b as well.

(b) Manufacturing Method

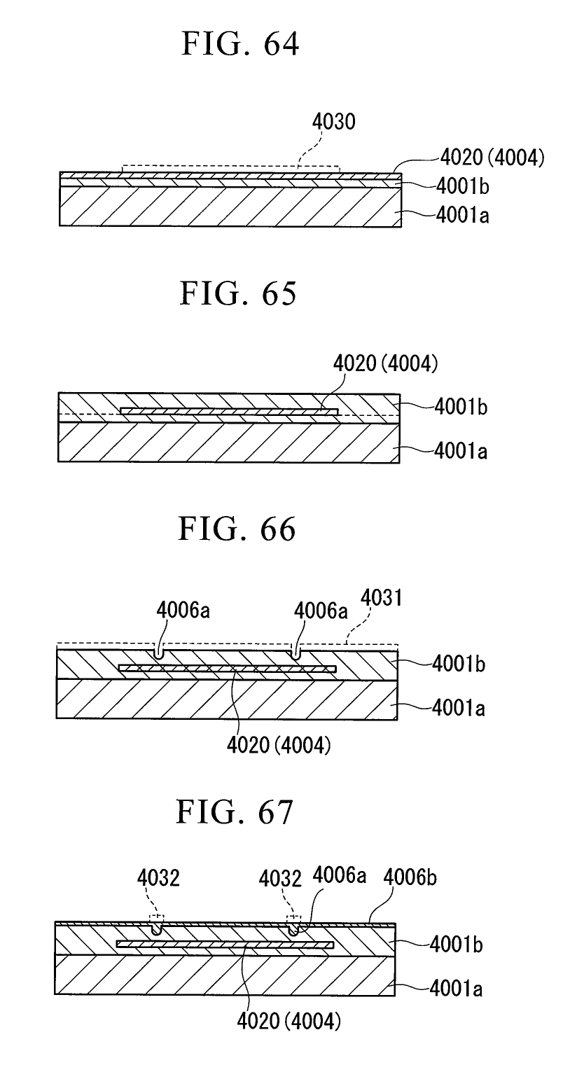

Next, a manufacturing method of condenser microphone 4000A will be described with reference to FIGS. 64 to 71.

In a first step of the manufacturing method (see FIG. 64), an insulating material such as SiO₂ is deposited on the surface of the monocrystal silicon substrate 4001a by way of CVD (Chemical Vapor Deposition) so as to form the oxide film 4001b on the substrate 4001a. Then, a conductive film 4020 composed of polysilicon, which is used for the formation of the diaphragm 4004, is formed on the oxide film 4001b by way of CVD. A resist is applied onto the conductive film 4020 so as to form a resist film 4030, which is then subjected to exposure and development so as to remove unnecessary portions of the resist film 4030 so that the shape of the resist film 4030 is substantially identical to the shape of the diaphragm 4004 in plan view.

After completion of the formation of the resist film 4030 whose shape matches the shape of the diaphragm 4004 in plan view on the conductive film 4020, the exposed portion of the conductive film 4020 is subjected to etching such as RIE (Reactive Ion Etching) so as to shape the conductive film 4020 suited the diaphragm 4004. In a second step of the manufacturing method (see FIG. 65), the resist film 4030 is removed by use of a resist peeling solution such as NMP, i.e., N-methyl-2-pyrrolidone. Then, the oxide film 4001b is additionally formed on the conductive film 4020 and the oxide film 4001b by way of CVD so that the conductive film 4020 is embedded inside of the oxide film 4001b.

In a third step of the manufacturing method (see FIG. 66), a resist film 4031 is formed on the oxide film 4001b. Then, the prescribed portion of the resist film 4031 whose shape substantially matches the shape of the stopper 4006 in plan view is removed by way of etching such as RIE; thus, a plurality of recesses 4006a having prescribed depths are formed in the oxide film 401b. In a fourth step of the manufacturing method (see FIG. 67), the resist film 4031 is removed from the oxide film 4001b. Then, a silicon nitride film 4006b is formed on the oxide film 4001b by way of CVD. At this time, the holes 4006a are filled with silicon nitride. After the formation of the silicon nitride film 4006b, a resist film 4032 is formed on the silicon nitride film 4006b. Then, the prescribed portions of the resist film 4032 are left just above the holes 4006a in such a way that the sizes thereof are slightly larger than the sizes of the holes 4006a in plan view, while other “unnecessary” portions of the resist film 4032 is removed.

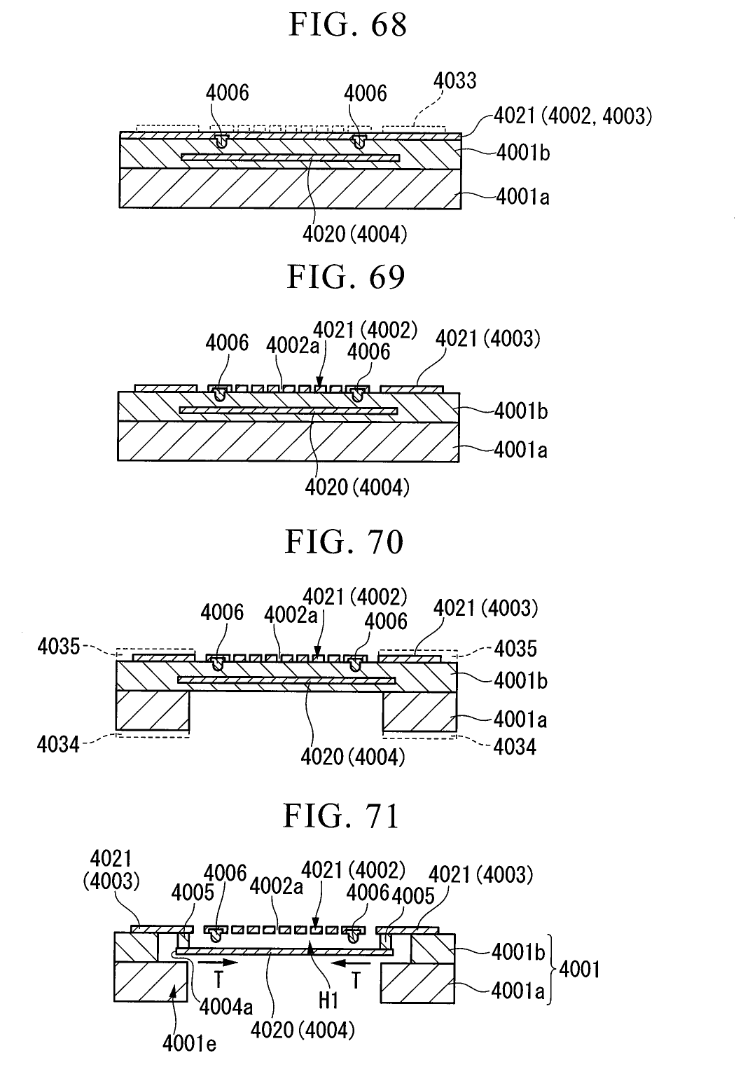

In a fifth step of the manufacturing method (see FIG. 68), the exposed portion of the silicon nitride film 4006b is removed by way of RIE so as to form the stoppers 4006. After completion of the removal of the resist film 4032, a conductive film 4021 (used for the formation of the back plate 4002 and the bridges 4003) is formed on the oxide film 4001b by way of CVD in such a way that the stoppers 4006 (corresponding to the prescribed portions of the silicon nitride film 4006b), which are partially exposed above the oxide film 4001b, are embedded in the conductive film 4021. A resist film 4033 is further formed on the conductive film 4021. Then, unnecessary portions of the resist film 4033 are removed while leaving the prescribed portions of the resist film 4033 whose shapes match the shapes of the back plate 4002 and the bridges 4003 in plan view.

In a sixth step of the manufacturing method (see FIG. 69), the exposed portion of the conductive film 4021 is subjected to etching such as RIE so as to make the conductive film 4021 have the prescribed shapes matching the shapes of the back plate 4002 and the bridges 4003. At this time, the holes 4002a and the recesses 4002b are formed in the prescribed portion of the conductive film 4021 used for the formation of the back plate 4002, wherein the prescribed portions of the conductive film 4021 corresponding to the bridges 4003 are separated from the other portions of the conductive film 4021 and are positioned inside of the recesses 4002b.

In a seventh step of the manufacturing method (see FIG. 70), a resist film 4034 is formed below the substrate 4001a; then, the prescribed portion of the resist film 4034 positionally matching the hole of the substrate 4001a (or the hole of the support 4001) is removed. Then, the exposed portion of the substrate 4001a, which is exposed from the resist film 4034, is subjected to etching such as Deep RIE such that etching progresses toward the lower surface of the oxide film 4001b formed on the substrate 4001a. Thus, it is possible to form the substrate 4001a having a disk-like shape and a hole. Next, a resist film 4035 is formed on the conductive film 4021 and the oxide film 4001b. Then, the prescribed portion of the resist film 4035 positioned just above the hole of the support 4001 is removed. That is, the resist film 4035 is formed and shaped such that the holes 4002a of the back plate 4002 are exposed. An etching solution composed of hydrofluoric acid is infiltrated into the holes 4002a of the back plate 4002 and the hole of the substrate 4001a so as to partially dissolve the oxide film 4001b. That is, the prescribed portion of the oxide film 4001b, which is positioned just below the center portion of the back plate 4002 having the holes 4002a, is dissolved so as to partially expose the upper surface of the conductive film 4020 (forming the diaphragm 4004), wherein the peripheral portion of the oxide film 4001b, which is positioned slightly externally of the “dissolved” prescribed portion of the oxide film 4001b, is dissolved as well.

Due to the etching solution infiltrated into the hole of the substrate 4001a, the oxide film 4001b is partially dissolved so that the lower surface of the conductive film 4020 is partially exposed. In addition, the etching solution is supplied around the outer circumference of the conductive film 4020 (corresponding to the outer circumference of the diaphragm 4004 while dissolving the oxide film 4001b, so that the prescribed range of the oxide film 4001b is dissolved so as to partially expose the lower surface of the conductive film 4021 above the conductive film 4020.

In an eighth step of the manufacturing method (see FIG. 71), the projection 4001e, which projects inwardly, is formed in the substrate 4001a; and the pillar portions 4005 (each having an insulating ability) are formed in such a way that the upper ends thereof are fixed to the lower, surfaces of the bridges 4003, and the lower ends thereof are fixed onto the upper surface of the outer circumference 4004a of the diaphragm 4004, whereby the diaphragm 4004 is supported with a prescribed gap with the back plate 4002 by means of the pillar portions 4005 interconnected to the bridges 4003. Lastly, the resist films 4034 and 4035 are removed so as to complete the formation of the sensing portion 4000A1 of the condenser microphone 4000A. Thereafter, the bias voltage circuit 4010 and the resistor circuit 4011 are formed so as to complete the production of the condenser microphone 4000A.

In the aforementioned manufacturing method, when the conductive film 4020 forming the diaphragm 4004 is formed on the oxide film 4001b in the manufacturing of the sensing portion 4000A1, polysilicon whose thermal expansion coefficient is higher than the thermal expansion coefficient of the silicon dioxide (used for the formation of the oxide film 4001b) is supplied at a high temperature. For this reason, when the conductive film 4020 is embedded in the oxide film 4001b and is reduced in temperature to room temperature, tensile stress T occurs in the diaphragm 4004. Hence, when the oxide film 4001b is dissolved so that the diaphragm 4004 is positioned in the hollow space, the diaphragm 4004 is deformed and contracted inwardly in a radial direction due to the tensile stress T.

It may be possible to avoid the occurrence of the contracted deformation of the diaphragm 4004 due to the tensile stress T by appropriately fixing the diaphragm 4004. In this case, however, the stiffness of the diaphragm 4004 increases. Hence, the diaphragm 4004 may not vibrate well in response to sound pressure applied thereto so that the vibration performance thereof is degraded. Thus, the sensitivity of the condenser microphone 4000A is reduced. This drawback is solved in the condenser microphone 4000D (see FIGS. 85 and 86) and the condenser microphone 4000A, in which elastically deformable bridges 4003 serving as cantilevers support the diaphragm 4004 in the hollow space. This reduces the tensile stress T, which makes the diaphragm 4004 contracted inwardly in a radial direction. Herein, the lower ends of the pillar portions 4005 are pulled inwardly in the radial direction while the free ends of the bridges 4003, which are fixed to the upper ends of the pillar portions 4005, are pushed upwardly and elastically deformed so that the pillar portions 4005 are inclined and deformed. Thus, it is possible to reduce the tensile stress T of the diaphragm 4005 supported by means of the pillar portions 4005, whereby the diaphragm 4004 is precisely installed in the condenser microphone 4000A with relatively low stiffness.

In general, it is difficult to normally maintain the same conditions for the manufacturing of condenser microphones (which are manufactured by way of semiconductor manufacturing processes). Hence, it is difficult to normally maintain the same tensile stress T remaining in the diaphragm 4004. The outer circumference 4004a of the diaphragm 4004 and the bridges 4003 are deformed so as to reduce the tensile stress T, whereas the amount of deformation of the outer circumference 4004a and the amount of deformation of the bridges 4003 depend upon the tensile stress T. That is, the distance between the back plate 4002 and the diaphragm 4004 is varied in response to the tensile stress T. Since it is difficult to precisely control the distance between the back plate 4002 and the diaphragm 4004, each one of the condenser microphones differs from each other in terms of the sensitivity (which is greatly affected by the distance between the back plate 4002 and the diaphragm 4004). Hence, there is a possibility that some condenser microphones have relatively low sensitivity.

To cope with the aforementioned problem, the condenser microphone 4000A is designed such that the stoppers 4006 project downwardly from the lower surface of the back plate 4002 with prescribed lengths. Due to the provision of the stoppers 4006, the bridges 4003 and the outer circumference of the diaphragm 4004 (which is supported in the hollow space) are appropriately deformed so as to reduce the tensile stress T, wherein the surface of the diaphragm 4004 comes in contact with the back plate 4002 by the intervention of the stoppers 4006. That is, the diaphragm 4004 cannot be further moved close to the back plate 4002 by way of the intervention of the spacers 4006. In other words, it is possible to prevent the diaphragm 4004 from being further deformed. Hence, it is possible to constantly maintain the distance H1 between the diaphragm 4004 and the back plate 4002.

In the aforementioned condenser microphone 4000A, sound pressure (radiated from an external sound source, not shown) is transmitted into the space corresponding to the distance H1 between the back plate 4002 and the diaphragm 4004 via the holes 4002a of the back plate 4002, so that the diaphragm 4004 vibrates due to the sound pressure applied thereto. According to the condenser microphone 4000A, the distance H1 is normally maintained between the back plate 4002 and the diaphragm 4004, and the diaphragm 4004 is reduced in the tensile stress T so that the stiffness thereof is reduced. Hence, the diaphragm 4004 vibrates well due to sound pressure applied thereto with a good response.

The electrostatic capacitance formed between the back plate 4002 and the diaphragm 4004 is precisely varied in response to sound pressure because the diaphragm 4004 vibrates to follow with variations of sound pressure. Since the resistor circuit 4011 is connected to the back plate 4002, electric charges accumulated between the back plate 4002 and the diaphragm 4004 do not substantially flow through the resistor 4011a even when the electrostatic capacitance is varied due to the vibration of the diaphragm 4004. That is, it is presumed that the amount of electric charge accumulated between the back plate 4002 and the diaphragm 4004 does not substantially change. Hence, it is possible to convert variations of electrostatic capacitance into potential variations of the back plate 4002 based on the ground level. Thus, it is possible to produce electric signals based on very small variations of electrostatic capacitance. In other words, variations of sound pressure applied to the diaphragm 4004 are converted into variations of electrostatic capacitance, which are then converted into potential variations of the back plate 4002, by which electric signals are produced based on variations of sound pressure.

In the condenser microphone 4000A, the tensile stress T occurring in the diaphragm 4004 causes the deformation of the pillar portions 4005 so that the tensile stress T is reduced, wherein the diaphragm 4004 is partially deformed and lifted upwards so as to come in contact with the stoppers 4006 projected downwardly from the lower surface of the back plate 4002. Thus, it is possible to normally maintain the distance H1 between the back plate 4002 and the diaphragm 4004. This guarantees a desired sensitivity for the condenser microphone 4000A.

The fifth embodiment is not necessarily limited to the condenser microphone 4000A having the aforementioned constitution, which can be modified in a variety of ways. For example, the condenser microphone 4000A has the three stoppers 4006 attached to the back plate 4002 at the prescribed positions, which are slightly inside of the three bridges 4003 in a radial direction. Herein, it is necessary that at least two bridges 4003 are arranged with a prescribed distance therebetween in a circumferential direction of the back plate 4002. Hence, the number of the stoppers 4006 is not limited to three and is determined in correspondence with the bridges 4003.

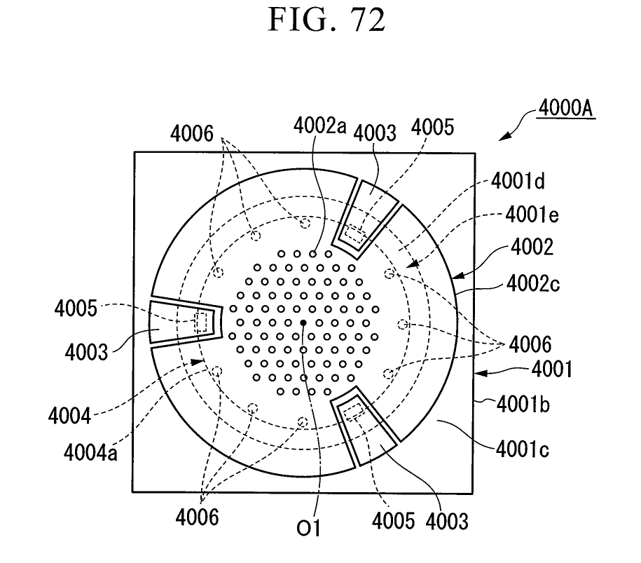

Alternatively, as shown in FIG. 72, it is possible to provide a plurality of stoppers 4006, which are attached to the back plate 4002 and are arranged between the bridges 4003 in a circumferential direction. In this case, when the pillar portions 4005 are inclined and deformed so as to reduce the tensile stress T remaining in the diaphragm 4004, the prescribed areas of the diaphragm 4004, at which the pillar portions 4005 are fixed, are depressed and deformed in a direction departing from the back plate 4002, while the other areas of the diaphragm 4004, which lie between the pillar portions 4005 and bridges 4003 aligned in a circumferential direction, are pressed upwardly and deformed in a direction approaching the back plate 4002. The stoppers 4006 are arranged between the back plate 4002 and the prescribed areas of the diaphragm 4004 so as to regulate the further movement of the diaphragm 4004. This prevents the center portion of the diaphragm 4004 from being further deflected, thus normally maintaining the distance H1 between the back plate 4002 and the center portion of the diaphragm 4004.

The stoppers 4006 are not necessarily aligned in a circumferential direction of the back plate 4002. Hence, they can be aligned inwardly in a radial direction of the back plate 4002. That is, the stoppers 4006 can be aligned in the circumferential direction with equal spacing therebetween, or they can be aligned in a ring shape lying in the circumferential direction. The stoppers 4006 are not necessarily attached to the back plate 4002 such that they project downwardly from the lower surface of the back plate 4002. That is, they can be attached to the diaphragm 4004 such that they project upwardly from the upper surface of the diaphragm 4004. Each of the stoppers 4006 is not necessarily formed in a semispherical shape and can be redesigned in any shape as long as the stoppers 4006 normally maintain the distance H1 between the back plate 4002 and the diaphragm 4004.

(c) First Variation

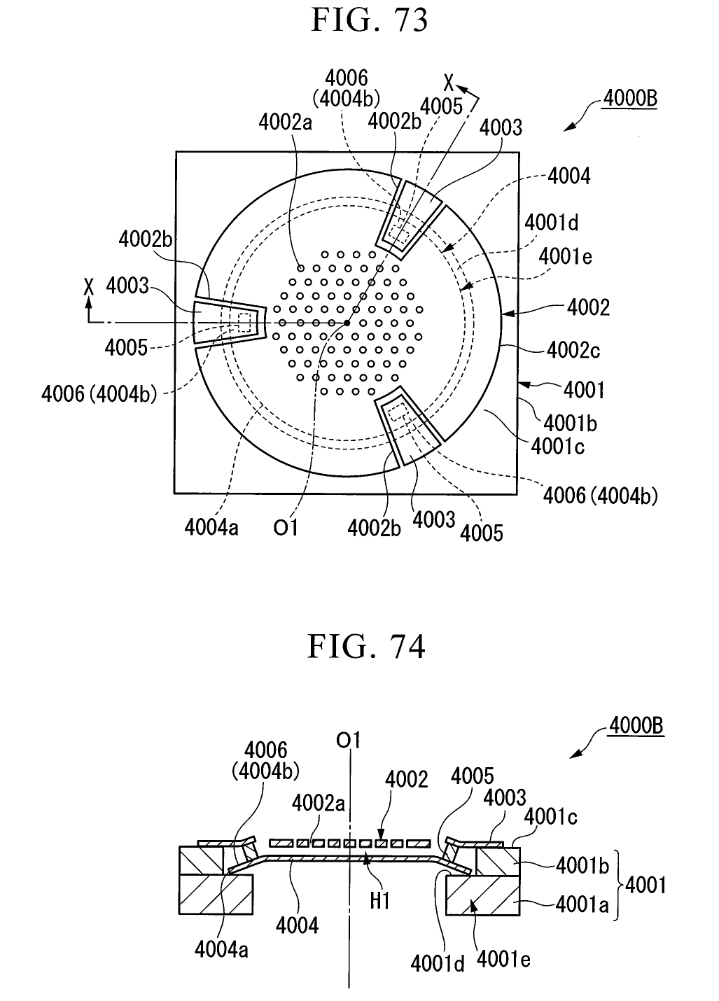

A condenser microphone 4000B according to a first variation of the fifth embodiment will be described with reference to FIGS. 73 to 78, wherein parts identical to those of the condenser microphone 4000A are designated by the same reference numerals. Hence, the detailed description thereof will be omitted as necessary.

The constitution of the condenser microphone 4000B is basically identical to the constitution of the condenser microphone 4000A except for the outer circumference 4004a of the diaphragm 4004 and the stoppers 4006. Compared with the condenser microphone 4000A, the condenser microphone 4000B is characterized in that, as shown in FIGS. 73 and 74, the outer circumference 4004a of the diaphragm 4004 is further extended externally of the pillar portions 4005 in a radial direction so that the extended portion of the outer circumference 4004a forms the stoppers 4006.

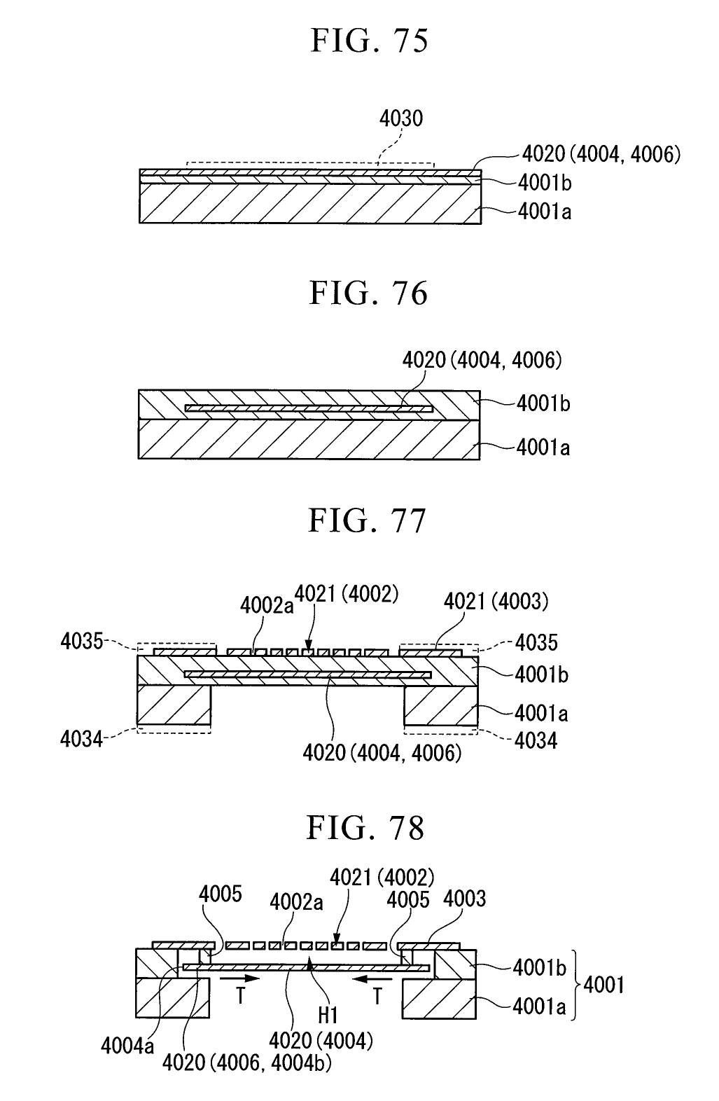

Next, the manufacturing method of the condenser microphone 4000B will be described with reference to FIGS. 75 to 78.

In a first step of the manufacturing method (see FIG. 75), the conductive film 4020 composed of polysilicon is formed on the oxide film 4001b, wherein the conductive film 4020 (forming the diaphragm 4004) whose diameter is increased to be larger than the diameter of the foregoing conductive film 4020 used in the condenser microphone 4000A, by use of the resist film 4030, whose diameter is increased to be larger than the diameter of the foregoing resist film 4030 used in the condenser microphone 4000A and which is formed on the conductive film 4020.

In a second step of the manufacturing method (see FIG. 76), the oxide film 4001b is further formed on the oxide film 4001b and the conductive film 4020 by way of CVD so that the conductive film 4020 used for the formation of the diaphragm 4004 and the stoppers 4006 is embedded in the oxide film 4001b. In a third step of the manufacturing method (see FIG. 77) of the condenser microphone 4000B compared with the manufacturing method of the condenser microphone 4000A, the foregoing holes 4006a are not formed so that the conductive film 4021 used for the formation of the back plate 4002 and the bridges 4003 is directly formed by way of CVD. Next, similar to the manufacturing method of the condenser microphone 4000A, etching such as RIE is performed so as to form the hole of the substrate 4001a. Then, an etching solution composed of hydrofluoric acid is supplied via the holes 4002a of the back plate 4002 and the hole of the substrate 4001a so as to dissolve the oxide film 4001b. In a fourth step of the manufacturing method (see FIG. 78), the etching solution supplied into the hole of the substrate 4001a dissolves the prescribed portion of the oxide film 4001b positioned below the conductive film 4020 so as to reach the lower surface of the conductive film 4020, while the etching solution is also supplied via spaces externally of the outer ends of the conductive film 4020, which is further extended in a radial direction in comparison with the foregoing conductive film 4020 used in the condenser microphone 4000A, i.e., via spaces externally of the outer circumference 4004a of the outer periphery 4004b (forming the stoppers 4006) so as to dissolve the prescribed portion of the oxide film 4001b lying between the outer periphery 4004b, the back plate 4002, the bridges 4003, and the projection 4001e of the substrate 40011a. This allows the diaphragm 4004 to be supported in a hollow space by means of the pillar portions 4005.

In the condenser microphone 4000B, the oxide film 4001b is removed so that the diaphragm 4004 is supported in the hollow space, wherein the outer circumference 4004a of the diaphragm 4004 (i.e., the outer periphery 4004b and the stoppers 4006) and the bridges 4003 are deformed so as to reduce the tensile stress T of the diaphragm 4004 such that the pillar portions 4005 are inclined and moved. At this time, the diaphragm 4004 is deformed and is partially moved close to the back plate 4002, and the ends of the stoppers 4006 (i.e., the outer circumference 4004a) come in contact with the upper surface 4001d of the projection 4001e of the substrate 4001a, so that the diaphragm 4004 is regulated in further movement and is not further moved close to the back plate 4002. By appropriately setting the lengths of the stoppers 4006 in a radial direction, it is possible to normally maintain the distance H1 between the back plate 4002 and the diaphragm 4004 by means of the stoppers 4006, which regulate the further deformation of the diaphragm 4004 even when the diaphragm 4004 is deformed to reduce the tensile stress T thereof. This completes the production of the condenser microphone 4000B.

The condenser microphone 4000B has the stoppers 4006, which are connected to the diaphragm 4004 and are further extended externally of the pillar portions 4005, wherein when the pillar portions 4005 rotate so as to reduce the tensile stress T of the diaphragm 4004, the outer circumference 4004a corresponding to the ends of the stoppers 4006 reliably comes in contact with the upper surface 4001d of the projection 4001e of the substrate 4001a. That is, the distance H1 can be normally maintained between the back plate 4002 and the diaphragm 4004. Thus, it is possible to guarantee a desired sensitivity for the condenser microphone 4000B.

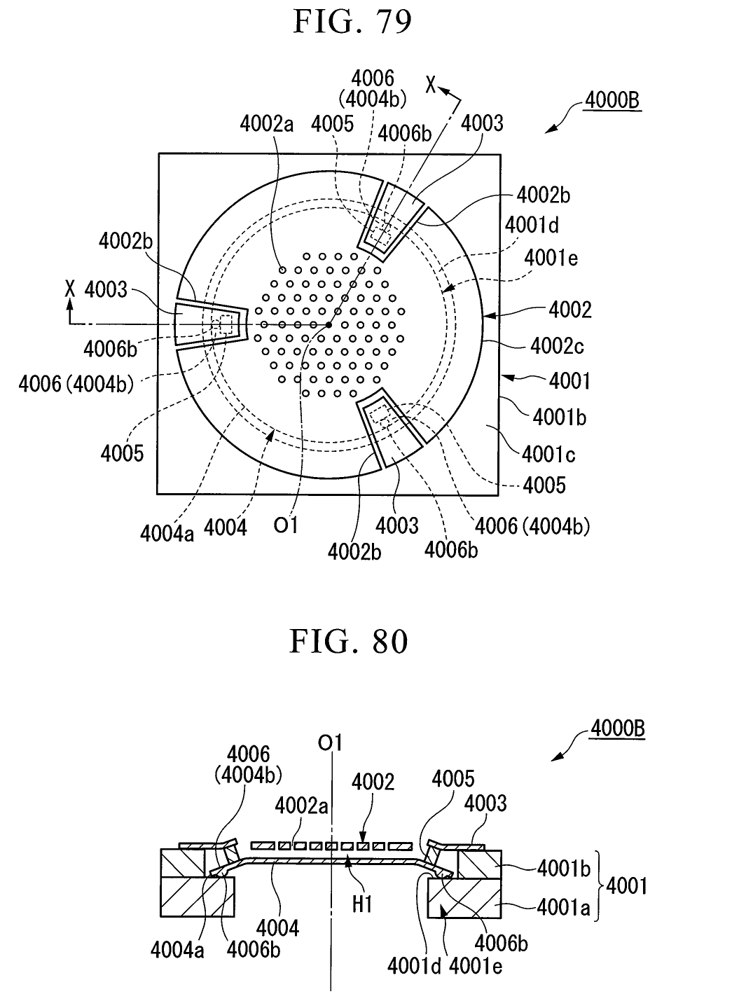

Incidentally, the first variation of the fifth embodiment can be further modified within the scope of the invention. For example, the condenser microphone 4000B, in which the ends of the stoppers 4006 (corresponding to the outer circumference 4004a of the outer periphery 4004b of the diaphragm 4004) come into contact with the substrate 4001a so as to normally maintain the distance H1 between the back plate 4002 and the diaphragm 4004, can be redesigned as shown in FIGS. 79 and 80 such that contact portions 4006b each having a semispherical shape are formed so as to project downwardly from the lower portions of the stoppers 4006, wherein the contact portions 4006b of the stoppers 4006 come in contact with the upper surface 4001d of the projection 4001e of the substrate 4001a so as to normally maintain the distance H1 between the back plate 4002 and the diaphragm 4004. The contact portions 4006b are not necessarily formed in the semispherical shape but can be formed in any shape.

(d) Second Variation

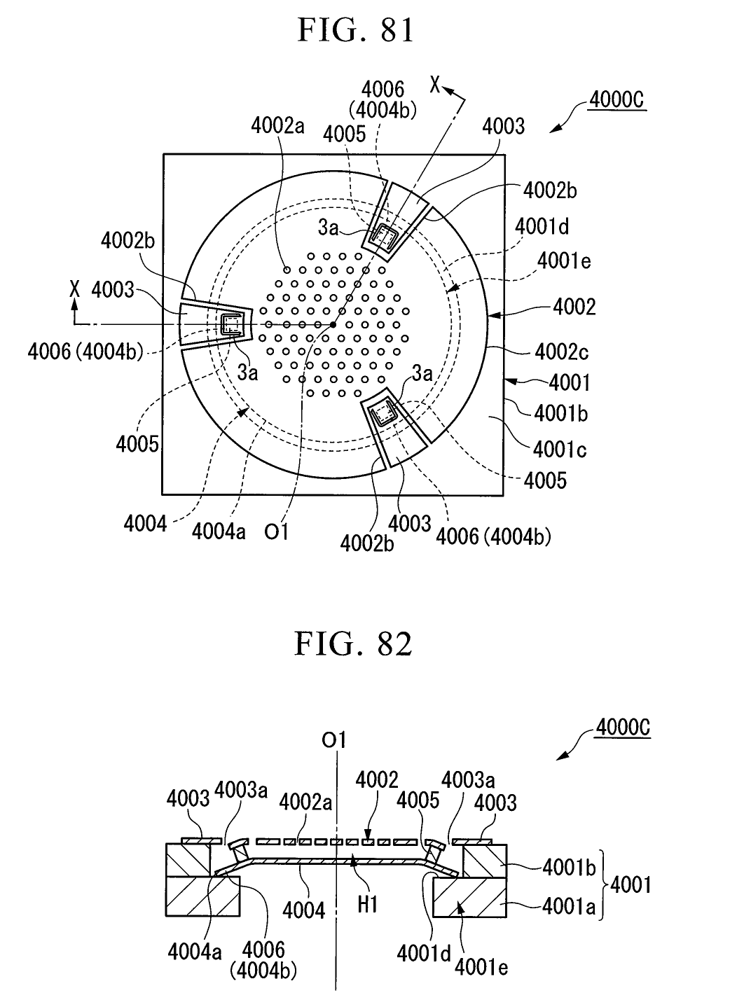

Next, a condenser microphone 4000C according to a second variation of the fifth embodiment will be described with reference to FIGS. 81 and 82, wherein parts identical to those of the condenser microphones 4000A and 4000B are designated by the same reference numerals. Hence, the detailed description thereof will be omitted as necessary.

The condenser microphone 4000C is characterized in that U-shaped cutouts 4003a are formed in the bridges 4003 so as to surround the pillar portions 4005. When the lower ends of the pillar portions 4005 are inwardly displaced in a radial direction of the diaphragm 4004 due to tensile stress T, the prescribed portions of the pillar portions 4005 surrounded by the cutouts 4003a are elastically deformed downwardly. Similar to the condenser microphone 4000B, the condenser microphone 4000C has the stoppers 4006, which are extended from the outer periphery 4004b of the diaphragm 4004 and are positioned externally of the pillar portions 4005.

The manufacturing method of the condenser microphone 4000C is basically similar to the manufacturing method of the condenser microphone 4000B except that after the formation of the conductive film 4021 composed of polysilicon on the oxide film 4001b, a resist film 4035 is formed on the conductive film 4021 so as to form the cutouts 4003a of the bridges 4003 by way of etching.

In the condenser microphone 4000C, when the oxide film 4001b is removed so that the diaphragm 4004 is supported ip a hollow space by means of the pillar portions 4005, the stoppers 4006 (corresponding to the outer circumference 4004a of the diaphragm 4004) are simultaneously deformed downwardly so as to reduce the tensile stress T. Due to the formation of the cutouts 4003a of the bridges 4003, the prescribed portions surrounded by the cutouts 4003a are pulled and are thus deformed downwardly by the pillar portions 4005. This is an outstanding technical feature of the condenser microphone 4000C compared with the condenser microphones 4000A and 4000B. The diaphragm 4004 is partially deformed and is slightly distanced from the back plate 4002, while the stoppers 4006 come in contact with the substrate 4001a so as to regulate further movement of the diaphragm 4004 being further distanced from the back plate 4002. Thus, it is possible to normally maintain the distance H1 between the back plate 4002 and the diaphragm 4004.

In the condenser microphone 4000C, the cutouts 4003a are formed in the bridges 4003; the stoppers 4006 connected to the diaphragm 4004 are extended externally of the pillar portions 4005 in a radial direction; the prescribed portions surrounded by the cutouts 4003a of the bridges 4003 are deformed downwardly due to the tensile stress T of the diaphragm 4004 so as to reduce the tensile stress T; and the stoppers 4006 come in contact with the substrate 4001a so as to normally maintain the distance H1 between the back plate 4002 and the diaphragm 4004. Thus, it is possible to guarantee a desired sensitivity for the condenser microphone 4000C.

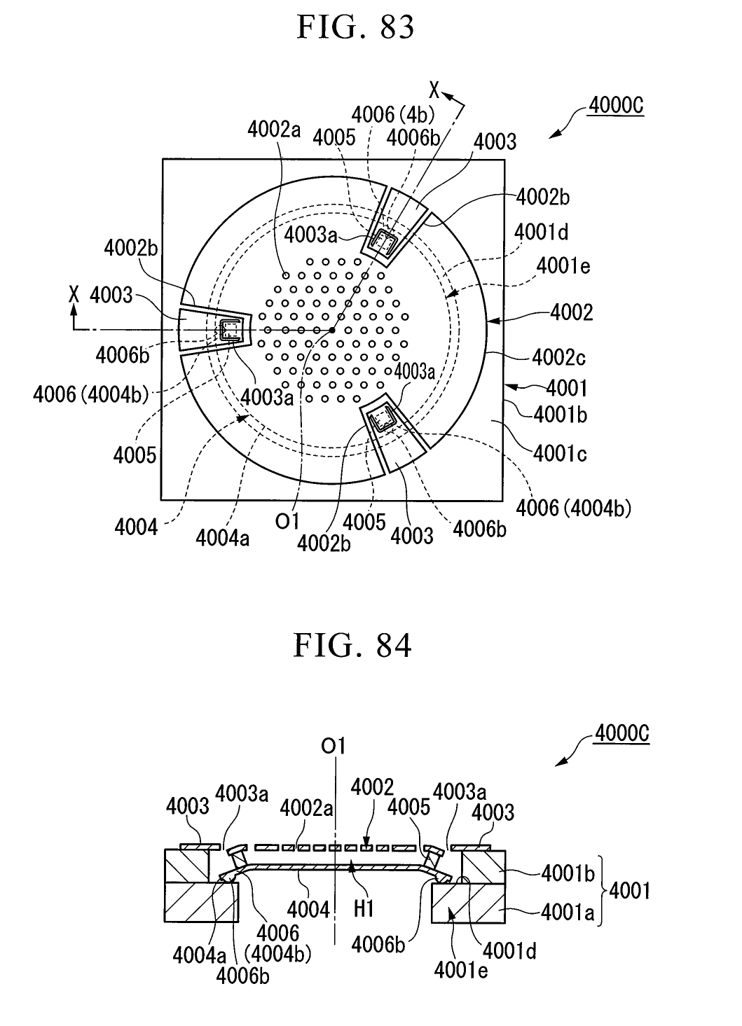

The second variation of the fifth embodiment can be further modified within the scope of the invention. For example, the condenser microphone 4000C, in which the stoppers 4006 come in contact with the substrate 4001a so as to normally maintain the distance H1 between the back plate 4002 and the diaphragm 4004, can be further modified similar to the further modification of the condenser microphone 4000B shown in FIGS. 79 and 80 in such a way that, as shown in FIGS. 83 and 84, contact portions 4006b each having a semispherical shape are formed and project downwardly from the lower portions of the stoppers 4006, wherein the contact portions 4006b of the stoppers 4006 come in contact with the upper surface 4001d of the projection 4001e of the substrate 4001a so as to normally maintain the distance H1 between the back plate 4002 and the diaphragm 4004.

Finally, the present invention is not necessarily limited to the aforementioned embodiments and variations, which are illustrative and not restrictive. Hence, further variations and modifications can be realized within the scope of the invention defined by the appended claims.

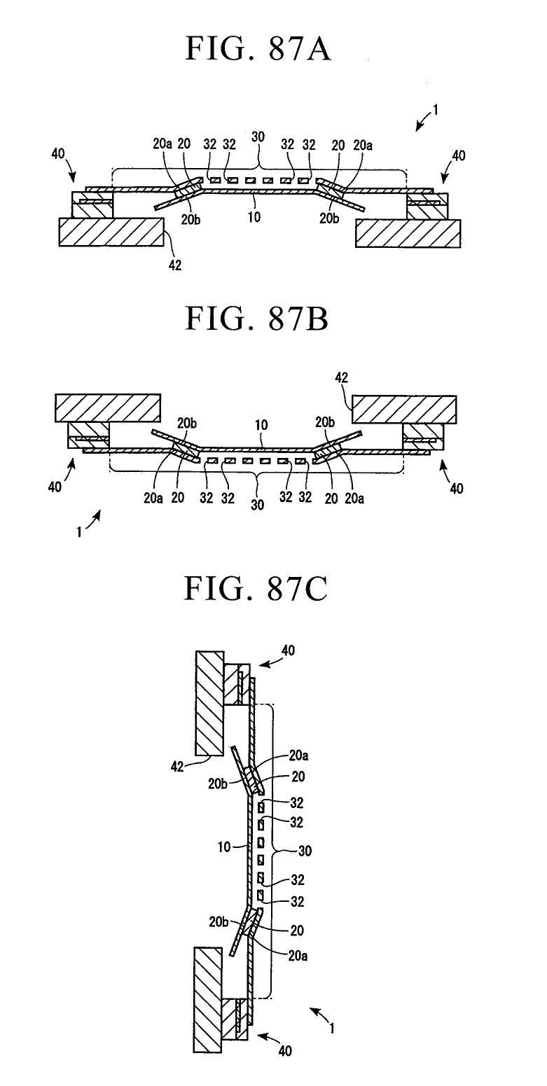

For example, the aforementioned condenser microphone 1 (see FIG. 1) can be mounted on a board in different positions. In the normal position (see FIG. 87A), the condenser microphone 1 is positioned in such a way that the substrate thereof is directed downwardly. In the reverse position (see FIG. 87B), the condenser microphone 1 is positioned in such a way that the substrate thereof is directed upwardly. In the vertical position (see FIG. 87C), the condenser microphone 1 is positioned in such a way that the substrate thereof is vertically arranged.

### INDUSTRIAL APPLICABILITY

The present invention is applicable to condenser microphones adapted to any type of electronic device such as communication devices, information terminals, cellular phones, and personal computers as well as audio devices.

1. A condenser microphone comprising:
a support;
a plate having a fixed electrode, which is bridged across the support;
a diaphragm, which has a moving electrode at a center portion thereof and which vibrates due to sound waves applied thereto; and
a spacer, in which a first end is fixed to the plate, and a second end is fixed to a near-end portion of the diaphragm so as to surround the center portion of the diaphragm, thus forming an air gap between the plate and the diaphragm.

2. A condenser microphone according to claim 1, wherein the second end of the spacer is moved close to the center portion of the diaphragm due to the tensile stress of the diaphragm in comparison with the first end of the spacer, thus reducing the tensile stress of the diaphragm.

3. A condenser microphone comprising:
a support:
a plate having a fixed electrode, which is supported by the support;
a diaphragm, which has a moving electrode at a center portion and which vibrates due to sound waves applied thereto; and
a plurality of bridges including beam portions extended inwardly from the support and interconnecting portions, wherein first ends of the interconnecting portions are fixed to the beam portions, and second ends of the interconnecting portions are fixed to a near-end portion of the diaphragm so as to surround the center portion of the diaphragm, and wherein the diaphragm is bridged under tension across the support in such a way that an air gap is formed between the diaphragm and the plate.

4. A condenser microphone according to claim 3, wherein the second ends of the interconnecting portions included in the bridges are moved close to the center portion of the diaphragm due to the tensile stress of the diaphragm in comparison with the first ends of the interconnecting portions, thus reducing the tensile stress of the diaphragm.

5. A condenser microphone comprising:
a plate having a fixed electrode;
a diaphragm having a moving electrode, which vibrates due to sound waves applied thereto;
a spacer in which a first end thereof is fixed to the plate, and a second end thereof is fixed to a near-end portion of the diaphragm, thus forming an air gap between the plate and the diaphragm;
a support that is positioned in a periphery of the plate and in a periphery of the diaphragm; and
a plurality of bridges, each of which is extended from a prescribed end of the plate or a prescribed end of the diaphragm toward the support and by which a structure constituted of the plate, the diaphragm, and the spacer is bridged across the support, thus absorbing residual stress of the diaphragm by way of deformation thereof.

6. A condenser microphone according to claim 5, wherein both of the plate and the diaphragm are formed using the same material.

7. A condenser microphone comprising:
a first plate;
a diaphragm having a moving electrode, which vibrates due to sound waves applied thereto;
a spacer in which a first end thereof is fixed to the first plate, and a second end thereof is fixed to a near-end portion of the diaphragm, thus forming an air gap between the first plate and the diaphragm;
a support that is formed in a periphery of the plate and in a periphery of the diaphragm;
a plurality of bridges, each of which is extended from a prescribed end of the plate or a prescribed end of the diaphragm toward the support and by which a structure constituted of the first plate, the diaphragm, and the spacer is bridged across the support, thus absorbing the residual stress of the diaphragm by way of deformation thereof; and
a second plate having a fixed electrode, which is positioned opposite to the first plate with respect to the diaphragm and which is supported by the support.

8. A condenser microphone comprising:
a support;
a plate having a fixed electrode, which is supported by the support;
a diaphragm having a moving electrode, which vibrates due to sound waves applied thereto; and
a spacer in which a first end thereof is fixed to the plate, and a second end thereof is fixed to a near-end portion of the diaphragm, thus forming an air gap between the plate and the diaphragm,
wherein the spacer absorbs the residual stress of the diaphragm by way of shearing deformation thereof.

9. A condenser microphone comprising:
a plate having a fixed electrode and a plurality of holes;
a support that is positioned in a periphery of the plate so as to support the plate; and
a diaphragm having a center portion having a moving electrode, an intermediate portion, which is formed externally of the center portion and whose rigidity is higher than a rigidity of the center portion, and a near-end portion, which is elongated from the intermediate portion to support and whose rigidity is lower than the rigidity of the intermediate portion,
wherein the diaphragm is bridged across the support so as to form an air gap with the plate, so that the diaphragm vibrates due to sound waves applied thereto.

10. A condenser microphone according to claim 9, wherein the intermediate portion is larger than the center portion and the near-end portion in thickness.

11. A condenser microphone according to claim 9, wherein the near-end portion is partially bent and expanded from the intermediate portion to the supports, so that the near-end portion is reduced in rigidity.

12. A condenser microphone comprising:
a support;
a plate having a fixed electrode whose periphery is fixed to the support;
a diaphragm having a moving electrode, which is positioned opposite to the fixed electrode;
a spacer, which is formed between the diaphragm and the plate, which is distanced from the support, and which joins the diaphragm; and
a plurality of bridges, in which tip ends thereof join the spacer, and base portions thereof are fixed with prescribed positioning with the plate and are positioned close to the center of the diaphragm,
wherein the bridges are deflected due to the tensile stress of the diaphragm in such a way that the tip ends thereof are moved apart from the plate.

13. A condenser microphone according to claim 12, wherein the plate and the bridges are formed using the same thin film having a plurality of cutouts, which form outlines of the bridges.

14. A condenser microphone according to claim 12, wherein the bridges are formed using a first film joining the spacer and a second film joining the spacer opposite to the first film, and wherein the tip ends of the bridges are deflected to be apart from the plate due to the tensile stress of the diaphragm as well as due to the tensile stress of the first film and the compressive stress of the second film.

15. A condenser microphone comprising:
a ring-shaped support:
a diaphragm positioned inside of a hole of the ring-shaped support;
a back plate that is supported by the ring-shaped support and is positioned in parallel with the diaphragm;
a plurality of bridges that are supported by the ring-shaped support in a cantilever manner;
a plurality of pillar portions that are inserted between the diaphragm and the back plate and are positioned in proximity to the ring-shaped support, wherein the pillar portions are inclined and moved when the bridges are deformed due to tensile stress of the diaphragm, thus reducing the tensile stress of the diaphragm; and
a stopper for regulating a distance between the diaphragm and the back plate.

16. A condense microphone according to claim 15, wherein the stopper has a projecting shape arranged between the diaphragm and the back plate.

17. A condenser microphone according to claim 15, wherein the hole of the ring-shaped support has a circular shape in plan view so that the bridges and the pillar portions are arranged in a circumferential direction about an axial line of the hole of the ring-shaped support with prescribed distances therebetween, and wherein the stopper is arranged inwardly of the bridges in a radial direction.

18. A condenser microphone according to claim 15, wherein the hole of the ring-shaped support has a circular shape in a plan view so that the bridges and the pillar portions are arranged in a circumferential direction about an axial line of the hole of the ring-shaped support with prescribed distances therebetween, and wherein a plurality of stoppers are arranged in the circumferential direction and are positioned between the bridges.

19. A condenser microphone according to claim 15, wherein the ring-shaped support has a projection projecting inwardly of the hole, wherein the diaphragm has an outer periphery, which is extended externally of the pillar portions and which is deformed and moved toward the projection when the pillar portions are inclined and moved due to the tensile stress of the diaphragm, and wherein the outer periphery of the diaphragm comes in contact with the projection so as to serve as the stopper for regulating the distance between the diaphragm and the back plate.

20. A condenser microphone according to claim 15, wherein the ring-shaped support has a projection projecting inwardly of the hole, wherein the diaphragm has an outer periphery, which is extended externally of the pillar portions and which has a plurality of contact portions, and wherein when the pillar portions are inclined and moved due to the tensile stress of the diaphragm, the outer periphery of the diaphragm is deformed toward the projection so that the contact portions come in contact with the projection so as to serve as the stopper for regulating the distance between the diaphragm and the back plate.

21. A condenser microphone according to claim 15, wherein the ring-shaped support has a projection projecting inwardly of the hole, wherein the diaphragm has an outer periphery, which is extended externally of the pillar portions and which is deformed and moved toward the projection when the pillar portions are inclined and moved due to the tensile stress of the diaphragm, wherein the outer periphery of the diaphragm comes in contact with the projection so as to serve as the stopper for regulating the distance between the diaphragm and the back plate, and wherein the bridges have cutouts partially surrounding the pillar portions in plan view.

22. A condenser microphone according to claim 15, wherein the ring-shaped support has a projection projecting inwardly of the hole, wherein the diaphragm has an outer periphery, which is extended externally of the pillar portions and which has a plurality of contact portions, wherein when the pillar portions are inclined and moved due to the tensile stress of the diaphragm, the outer periphery of the diaphragm is deformed toward the projection so that the contact portions come in contact with the projection so as to serve as the stopper for regulating the distance between the diaphragm and the back plate, and wherein the bridges have cutouts partially surrounding the pillar portions in plan view.
